(19) United States
(12) Patent Application Publication
(10) Pub. No.: US 2005/0084031 A1
(43) Pub. Date: Apr. 21, 2005

(54) Holographic communications using multiple code stages

(76) Inventors: Lowell Rosen, La Jolla, CA (US); Robert F. Gazdzinski, San Diego, CA (US)

Correspondence Address: Robert F. Gazdzinski, Esq.;Gazdzinski & Associates, Suite 375, 11440 West Bernardo Court, San Diego, CA, 92127, US

(21) Appl. No.: 10/868,316

(22) Filed: Jun. 14, 2004

Related U.S. Application Data
(60) Provisional application No. 60/529,152, filed on Dec. 11, 2003.
(60) Provisional application No. 60/492,628, filed on Aug. 4, 2003.

(51) Int. Cl. H04L 27/04

(52) U.S. Cl. 375/295

(57) ABSTRACT

Improved apparatus and methods for utilizing holographic waveforms for a variety of purposes including communication. In one exemplary embodiment, the holographic waveforms are wideband in nature and transmitted over an RF bearer medium to provide, inter alia, highly covert and robust communications. A multi-stage (e.g., dual) phase-coding approach is used in conjunction with a mathematical transform to further enhance robustness and security of the radiated waveforms.

### PRIORITY AND RELATED APPLICATIONS

This application claims priority to co-owned U.S. Provisional Patent Application Ser. No. 60/492,628 filed Aug. 4, 2003 entitled “ENHANCED HOLOGRAPHIC COMMUNICATIONS APPARATUS AND METHOD” and 60/529,152 filed Dec. 11, 2003 and entitled “WIDEBAND HOLOGRAPHIC COMMUNICATIONS APPARATUS AND METHODS”, and is related to co-owned U.S. patent application Ser. No. 10/763,113 filed Jan. 21, 2004 entitled “HOLOGRAPHIC NETWORK APPARATUS AND METHODS”, and co-owned U.S. patent application Ser. Nos. 10/______ entitled “WIDEBAND HOLOGRAPHIC COMMUNICATIONS APPARATUS AND METHODS” (Atty. Docket HOLOWAVE.004A), 10/______ entitled “SCALABLE TRANSFORM WIDEBAND HOLOGRAPHIC COMMUNICATIONS APPARATUS AND METHODS” (Atty. Docket HOLOWAVE.004DV1), 10/______ entitled “ADAPTIVE HOLOGRAPHIC WIDEBAND COMMUNICATIONS APPARATUS AND METHODS” (Atty. Docket HOLOWAVE.004DV2), 10/______ entitled “DIRECT CONVERSION HOLOGRAPHIC COMMUNICATIONS APPARATUS AND METHODS” (Atty. Docket HOLOWAVE.004DV3), 10/______ entitled “SOFTWARE-DEFINED WIDEBAND HOLOGRAPHIC COMMUNICATIONS APPARATUS AND METHODS” (Atty. Docket HOLOWAVE.004DV4) and 10/______ entitled “ERROR-CORRECTED WIDEBAND HOLOGRAPHIC COMMUNICATIONS APPARATUS AND METHODS” (Atty. Docket HOLOWAVE.004DV5) all filed contemporaneously herewith, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Field of the Invention

This invention relates generally to the field of communications signals, and more specifically to, inter alia, wide-band communications systems.

2. Description of Related Technology

Numerous types of radio frequency communications systems exist. These systems can be broadly categorized into narrowband or broadband systems. As the names imply, narrowband systems utilize one or more comparatively narrow portions of the RF spectrum, while broadband systems utilize one or more broad swaths of the spectrum.

Ultra-Wideband

So-called “wideband” or “ultra-wideband” (UWB) systems are a subset of broadband systems, using often vary large ranges of the frequency spectrum often spanning several hundred MHz or even several GHz. Inherent benefits of such wideband systems include their low energy per MHz, simplicity (often completely lacking much of the complexity associated with a carrier or heterodyne-based approach), and high data rates. These benefits stem largely from the spreading of the radiated signal across the broader frequency bandwidth.

However, with such high bandwidth (and higher frequencies characteristic of UWB systems) typically comes reduced range for a given radiated power level. Wideband systems are sometimes also classified as being “spread spectrum”, but many wideband systems in practice utilize a much greater frequency bandwidth than conventional spread spectrum systems.

Various air interfaces and spectral access techniques are used in wideband and spread spectrum systems including, for example frequency hopping spread spectrum (FHSS) and direct sequence (DS). More recently, various types of UWB systems have been developed in an attempt to develop a practical high data rate RF system that can be used over short ranges, such as in personal area networks (PANs), IEEE-Std. 802.15 applications, and the like. These UWB systems generally fall into one of three categories: (i) direct sequence (DS); (ii) orthogonal frequency division multiplexing (OFDM), or (iii) time-modulated (TM-UWB).

The following references, incorporated herein by reference in their entirety, are generally representative of the state of the art in UWB technology.

U.S. Pat. No. 4,689,627 to Lee, et al. issued Aug. 25, 1987 entitled “Dual band phased antenna array using wideband element with diplexer” discloses a dual band, phased array antenna especially adaptable for tactical radar capable of performing search, track and identification in a hostile jamming environment. The dual band array antenna is essentially two antennas sharing a common antenna aperture. The two antennas possess separate feed system and beam steering control. Thus, the beams for each frequency band can be steered independently and simultaneously. This design utilizes an ultra-wide band radiating element which can operate over approximately an octave bandwidth encompassing two adjacent microwave bands.

U.S. Pat. No. 5,162,754 to Soares, et al. issued Nov. 10, 1992 entitled “Ultra-wideband dc-microwave amplifier device notably in integrated circuit form” discloses an amplification device relating to the field of the amplification of ultra-wideband electrical signals from the dc to the microwave range, and more precisely from dc to microwaves of over 6 GHz, notably for the amplification of signals transmitted at very high bit rates on optic fibers, of the type including at least one amplification stage, the active amplification element of which is a field-effect transistor mounted as a common source, each of the amplification stages including means for the simultaneous maintaining of a positive dc voltage bias on the drain of the amplification transistor and a negative or zero dc bias on the gate of the transistor. This device may be made in monolithic integrated circuit form.

U.S. Pat. No. 5,345,471 to McEwan issued Sep. 6, 1994 entitled “Ultra-wideband receiver” discloses an ultra-wideband (UWB) receiver utilizing a strobed input line with a sampler connected to an amplifier. In a differential configuration, ±UWB inputs are connected to separate antennas or to two halves of a dipole antenna. The two input lines include samplers which are commonly strobed by a gating pulse with a very low duty cycle. In a single ended configuration, only a single strobed input line and sampler is utilized. The samplers integrate, or average, up to 10,000 pulses to achieve high sensitivity and good rejection of uncorrelated signals.

U.S. Pat. No. 5,379,006 to McCorkle issued Jan. 3, 1995 entitled “Wideband (DC to GHz) balun” discloses an ultra wide band DC to GHz balun consisting of transmission lines, a small inverting junction, and an RC network connecting the shields of the balanced load transmission lines such that an unbalanced source sees a matched load from DC to GHz.

U.S. Pat. No. 5,523,728 to McCorkle issued Jun. 4, 1996 entitled “Microstrip DC-to-GHZ field stacking balun” discloses a wideband (DC to GHz) PC-board Balun. The balun maintains low insertion loss and good balance for ultra wide band (UWB) applications such as impulse radar. The balun structure is formed by microstrip transmission lines on a dielectric substrate, having at least one inverting and one non-inverting transmission lines. The transmission lines are connected to form balanced transmission lines stacked about a ground plane. N transmission lines can be connected to form a N²:1 impedance ratio balun. Ferrite cores placed about the transmission lines and resistor-capacitor circuits improve the low frequency operation of the balun.

U.S. Pat. No. 5,610,907 to Barrett issued Mar. 11, 1997 entitled “Ultrafast time hopping CDMA-RF communications: code-as-carrier, multichannel operation, high data rate operation and data rate on demand” discloses an ultrashort pulse time hopping code-division-multiple-access (CDMA) RF communications system in the time-frequency domain comprising a transmitter including a short duration pulse generator for generating a short duration pulse in the picosecond to nanosecond range and a controller for controlling the generator, code means connected to the controller for varying the time position of each short pulse in frames of pulses in orthogonal superframes of ultrafast time hopping code division multiple access format, precise oscillator-clock for controlling such timing, encoding modems for transforming intelligence into pulse position modulation form, antenna/amplifier system. A homodyne receiver is provided for receiving and decoding the coded broadcast signal, and one or more utilization devices are connected to the homodyne receiver. Preferably, the codes are orthogonal codes with the temporal coding of the sequence of ultrafast, ultrawideband pulses constituting the carrier for transmission by the antenna system.

U.S. Pat. No. 5,764,696 to Barnes, et al. issued Jun. 9, 1998 entitled “Chiral and dual polarization techniques for an ultra-wide band communication system” discloses chiral and dual polarization techniques for an ultra-wide band communication system that provide an ultra-wide band signal having signal components in two dimensions. The polarization techniques utilize two signal paths to excite a pair of linear, orthogonal antennas. The pulses transmitted along one signal path are delayed with respect to the pulses transmitted along the second signal path such that one antenna is excited with a pulse that is out of phase with respect to the pulse that is exciting the other antenna. With chiral polarization, one signal is delayed in time by an amount such that it reaches a maximum when the other signal is at an adjacent minimum. With dual polarization, one signal is delayed by more than a pulse width. Because the signal is split and transmitted using two orthogonal, linear antennas, the transmitted signal has an electric field component in two dimensions.

U.S. Pat. No. 5,889,497 Brooker, et al. issued Mar. 30, 1999 entitled “Ultrawideband transverse electromagnetic mode horn transmitter and antenna” discloses an ultrawideband transverse electromagnetic mode horn antenna for use at high voltages, comprising a pulse generator and two transmission horns containing different dielectric media. The interface between the dielectric media is configured so that a signal from the generator is incident on the interface at an angle substantially equal to the Brewster angle, thereby maintaining a good impedance match across the interface. A further advantage of the arrangement is that the TEM wavefront is preserved through the antenna section allowing operation at fast pulse risetime (less than 200 ps) for short duration (several ns) at high voltage.

U.S. Pat. No. 5,973,653 to Kragalott, et al. issued Oct. 26, 1999 entitled “Inline coaxial balun-fed ultrawideband cornu flared horn antenna” discloses an inline coaxial balun fed cornu flared horn antenna formed by transitioning a coaxial transmission line to a parallel-plate transmission line with a Klopfenstein impedance profile and terminating with a flared horn antenna based on a scaled cornu spiral. The cornu spiral is a mathematical plane curve formed by parametrically plotting the scaled cosine Fresnel integral versus the scaled sine Fresnel integral. The antenna has the property that the curvature of the flare increases linearly in proportion to the arc length of the flare. The Klopfenstein impedance profile of the inline balun ensures a low voltage reflection across a wide bandwidth with a minimum transition length and together with the cornu flare satisfies the requirements for a wideband design. The design efficiently radiates and receives a high power pulse of ultrawideband electromagnetic waves over a preferred range of angles in space and transmits a field that is nearly the scaled temporal derivative of the input voltage signal and receives a voltage that is nearly the scaled replica of the incident field.

U.S. Pat. No. 6,026,125 to Larrick, Jr., et al. issued Feb. 15, 2000 entitled “Waveform adaptive ultra-wideband transmitter” discloses a waveform adaptive transmitter that conditions and/or modulates the phase, frequency, bandwidth, amplitude and/or attenuation of ultra-wideband (UWB) pulses. The transmitter confines or band-limits UWB signals within spectral limits for use in communication, positioning, and/or radar applications. One embodiment comprises a low-level UWB source (e.g., an impulse generator or time-gated oscillator (fixed or voltage-controlled)), a waveform adapter (e.g., digital or analog filter, pulse shaper, and/or voltage variable attenuator), a power amplifier, and an antenna to radiate a band-limited and/or modulated UWB or wideband signals.

U.S. Pat. No. 6,091,374 to Barnes issued Jul. 18, 2000 entitled “Ultra-wideband magnetic antenna” discloses an ultra-wideband magnetic antenna including a planar conductor having a first and a second slot about an axis. The slots are substantially leaf-shaped having a varying width along the axis. The slots are interconnected along the axis. A cross polarized antenna system is comprised of an ultra-wideband magnetic antenna and an ultra-wideband dipole antenna. The magnetic antenna and the dipole antenna are positioned substantially close to each other and they create a cross polarized field pattern. The invention provides isolation between a transmitter and a receiver in an ultra-wideband system. Additionally, the invention allows isolation among radiating elements in an array antenna system.

U.S. Pat. No. 6,362,617 to Hubbell issued Mar. 26, 2002 entitled “Wideband, high dynamic range antenna” discloses a magnetic field sensor which can be used as an active antenna is disclosed that is capable of small size, ultrawideband operation, and high efficiency. The sensor includes a multiplicity of magnetic field transducers, e.g., superconducting quantum interference devices (SQUIDs) or Mach-Zehnder modulators, that are electrically coupled in a serial array. Dummy SQUIDs may be used about the perimeter of the SQUID array, and electrically coupled to the active SQUIDs for eliminating edge effects that otherwise would occur because of the currents that flow within the SQUIDs. Either a magnetic flux transformer which collects the magnetic flux and distributes the flux to the transducers or a feedback assembly (bias circuit) or both may be used for increasing the sensitivity and linear dynamic range of the antenna.

U.S. Pat. No. 6,384,773 to Martin, et al. issued May 7, 2002 entitled “Adaptive fragmentation and frequency translation of continuous spectrum waveform to make use of discontinuous unoccupied segments of communication bandwidth” discloses identity transform filters, such as sin(x)/x filters, used to coherently fragment the frequency continuum of a wideband waveform, such as an ultra wideband radar signal, into a plurality of spectral segments that are capable of fitting into unoccupied spectral regions of a partially occupied electromagnetic spectrum. The wideband waveform has a bandwidth that falls within the partially occupied portion of the electromagnetic spectrum, and exceeds that of any unoccupied spectral region. The total useable bandwidth of the unoccupied regions is at least equal to that of the wideband waveform.

U.S. Pat. No. 6,456,221 to Low, et al. issued Sep. 24, 2002 entitled “Method and apparatus for signal detection in ultra wide-band communications” discloses methods and apparatus for detecting ultra wide-band signals using circuitry having nonlinear dynamics characteristics. The receiver circuit can be implemented using a simple tunnel diode or using an op-amp to provide dynamic characteristics. The detector can be used in a variety of modulation schemes, including but not limited to an ON-OFF keying scheme, an M-ary pulse position modulation scheme, and a pulse width modulation scheme. The approach requires only a single frame to detect the signal.

U.S. Pat. No. 6,492,925 to Drentea issued Dec. 10, 2002 entitled “Ultra-wide band (20 MHz to 5 GHz) analog to digital signal processor” discloses an ultra-wide band general purpose analog to digital signal processor covering the radio frequency range from 20 MHz to 5 GHz. The processor includes a first circuit for shifting a frequency of an input signal, a second circuit for processing the input signal, and a third circuit for selectively bypassing the first circuit whereby the input signal is provided directly to the second circuit in a first mode of operation and to the second circuit via the first circuit in a second mode of operation. In the illustrative embodiment, the first circuit is a mixer with a normalized mixing ratio of 0.8 to 0.9. The second circuit is a sigma-delta analog-to-digital converter. The third circuit is a switch for passing the input signal directly to the second circuit if the input is 20 MHz to 2 GHz, or for passing the input signal to the first-circuit if the input is 2 GHz to 5 GHz. The switch, the mixer, and the sigma-delta converter are disposed on a single application specific integrated circuit (ASIC) substrate.

U.S. Pat. No. 6,668,008 to Panasik issued Dec. 23, 2003 entitled “Ultra-wide band communication system and method” discloses a system and method for generating an ultra-wide band communication signal having data occurring a specific frequencies precisely excised at baseband. The data to be transmitted is transformed into a function of time where the data to be excised can be removed in the time domain. After the data has been successfully removed in the time domain, the data is then transmitted in the frequency domain in which no data is transmitted at the frequencies where the data was precisely excised.

U.S. Pat. No. 6,690,741 to Larrick, Jr., et al. issued Feb. 10, 2004 entitled “Ultra wideband data transmission system and method” discloses a data-modulated ultra wideband transmitter that modulates the phase, frequency, bandwidth, amplitude and/or attenuation of ultra-wideband (UWB) pulses. The transmitter confines or band-limits UWB signals within spectral limits for use in communication, positioning, and/or radar applications. One embodiment comprises a low-level UWB source, a waveform adapter, a power amplifier, and an antenna to radiate a band-limited and/or modulated UWB or wideband signals. In a special case where the oscillator has zero frequency and outputs a DC bias, a low-level impulse generator impulse-excites a bandpass filter to produce an UWB signal having an adjustable center frequency and desired bandwidth based on a characteristic of the filter.

U.S. patent application Publication No. 20030011433 to Richley published Jan. 16, 2003 entitled “Ultra wideband transmitter with gated push-pull RF amplifier” discloses a method and an apparatus that reduce power consumption in an ultra wideband (UWB) transmitter that includes a push-pull RF amplifier and a switch that powers up or powers down the amplifier between UWB pulses. The gated push-pull amplifier amplifies the UWB pulses, including spurious signal energy appearing at the detector input, by splitting the signal with a 180-degree phase splitter, amplifying the split signals with substantially identical amplifiers, and combining the amplifier outputs with a 180-degree combiner. The 180-degree combiner essentially cancels common-mode spurious signals typically generated by the UWB amplifier during power-down and power-up.

U.S. patent application Publication No. 20030011525 to Sanad published Jan. 16, 2003 entitled “Ultra-wideband monopole large-current radiator” discloses an ultra-wideband, large-current radiator consisting of a ground plane and two electric monopoles: a wide radiating monopole orthogonal to the ground plane, and a thin monopole orthogonal to the ground plane and normally displaced from the wide monopole. The frequency-independent low impedance of the antenna allows a small voltage to generate a large current. The wide radiating monopole may be a flat sheet, or a sheet of parallel bars. Shielding by the wide monopole suppresses radiation from the thin monopole into a sector of space into which the monopole radiation characteristic of a well-formed impulse in response to a voltage step is desired.

U.S. patent application Publication No. 20030032422 to Wynbeek published Feb. 13, 2003 entitled “Asymmetric wireless communication system using two different radio technologies” discloses a wireless communication system and method where a base station communication device includes a carrier wave-based transmitter and an ultrawideband receiver. A mobile communication device includes a carrier wave-based receiver and an ultrawideband transmitter. Carrier wave communications are carried out in a forward channel from the base station communication device to the mobile communication device, and ultrawideband communications are carried out in a reverse channel from the mobile communication device to the base station communication device. As a result, the power requirements of the mobile communication device are reduced.

U.S. patent application Publication No. 20030048171 to Kormanyos published Mar. 13, 2003 entitled “Ultra wideband frequency dependent attenuator with constant group delay” discloses an ultra wideband, frequency dependent attenuator apparatus for providing a loss which can be matched with a physically longer, given delay line, but yet which provides a much shorter time delay than the physically longer, given delay line with constant group delay. The apparatus is formed by an ordinary microstrip transmission line placed in series with an engineered lossy microstrip transmission line, with both transmission lines being placed on a substrate to effectively form a hybrid microstrip transmission line. The lossy transmission line includes resistive material placed along the opposing longitudinal edges thereof.

U.S. patent application Publication No. 20030054764 to McCorkle, et al. published Mar. 20, 2003 entitled “Carrierless ultra wideband wireless signals for conveying application data” discloses a method for conveying application data via carrierless ultra wideband wireless signals, and signals embodied in a carrierless ultra wideband waveform. Application data is encoded into wavelets that are transmitted as a carrierless ultra wideband waveform. The carrierless ultra wideband waveform is received by an antenna, and the application data is decoded from the wavelets included in the waveform. The waveforms of the signals include wavelets that have a predetermined shape that is used to modulate the data.

U.S. patent application Publication No. 20030058963 to Cattaneo, et al. published Mar. 27, 2003 entitled “Method and device for decoding an incident pulse signal of the ultra wideband type, in particular for a wireless communication system” an incident pulse signal of the ultra wideband type conveys digital information that is coded using pulses having a known theoretical shape. A decoding device includes an input for receiving the incident signal, and for delivering a base signal. A comparator receives the base signal and delivers an intermediate signal representative of the sign of the base signal with respect to a reference. A sampling circuit samples the intermediate signal for delivering a digital signal. A digital processing circuit correlates the digital signal with a reference correlation signal corresponding to a theoretical base signal arising from the reception of a theoretical pulse having the known theoretical shape.

U.S. patent application Publication No. 20030063025 to Low, et al. published Apr. 3, 2003 entitled “Method and apparatus for ultra wide-band communication system using multiple detectors” discloses a method and apparatus for detecting ultra wide-band (UWB) signals using multiple detectors having dynamic transfer characteristics. A receiver circuit is implemented using devices such as op-amps to provide the required dynamic characteristics. Detectors used in the UWB communication systems of the present invention utilize direct sequence spread spectrum (DSSS) technology for multiple access reception.

U.S. patent application Publication No. 20030063597 to Suzuki, published Apr. 3, 2003 entitled “Wireless transmission system, wireless transmission method, wireless reception method, transmitting apparatus and receiving apparatus” discloses a wireless transmission system in a place where two or more wireless networks uncoordinated to each other are located and are subjected to receive mutual interference. This system can transmit data correctly with no limitation of the use of communication apparatus even if the transmission is subjected to the interference from the other network. Namely in an ultra wide band wireless transmission system, orders of the slots of a frame are replaced randomly by a predetermined slot permutation pattern, and then the replaced slots are transmitted. The orders of received slots are restored to the original order by the predetermined slot permutation pattern. Thereby, a diversity effect to interference can be obtained.

U.S. patent application Publication No. 20030069025 to Hoctor, et al. published Apr. 10, 2003 entitled “Transmitter location for ultra-wideband, transmitted-reference CDMA communication system” discloses a system and method involve tracking the location of objects within an area of interest using transmitted-reference ultra-wideband (TR-UWB) signals. The system includes at least three base stations communicating with a central processor, at least one mobile device and at least one fixed beacon transmitter of known location. The mobile device is equipped with a transmitter for transmitting a TR-UWB signal to a base station, which then determines a location of the mobile device based on time difference of arrival information between the beacon transmitters and mobile devices measured at all the base stations. Preferably, the area of interest includes a plurality of mobile devices each transmitting a delay-hopped TR-UWB signal according to a code-division multiple access scheme.

U.S. patent application Publication No. 20030069026 to Hoctor, et al. published Apr. 10, 2003 entitled “ULTRA-WIDEBAND COMMUNICATIONS SYSTEM AND METHOD USING A DELAY HOPPED, CONTINUOUS NOISE TRANSMITTED REFERENCE“discloses an ultra-wideband (UWB) communications system combines the techniques of a transmitted reference (TR) and a multiple access scheme called delay hopping (DH). Combining these two techniques using UWB signaling using a continuous noise transmitted waveform avoids the synchronization difficulties associated with conventional approaches. This TR technique is combined with the DH multiple access technique to create a UWB communications scheme that has a greater multiple access capacity than does the UWB TR technique by itself.

U.S. patent application Publication No. 20030076136 to McCorkle, et al. published Apr. 24, 2003 entitled “Monocycle generator” discloses a monocycle forming network including a monocycle generator, up and down pulse generators, data modulators and clock generation circuits. The network may generate monocycle pulses having very narrow pulse widths, approximately 80 picoseconds peak to peak. The monocycles may be modulated to carry data in ultra-wideband communication systems.

U.S. patent application Publication No. 20030090435 to Santhoff, et al. published May 15, 2003 entitled “Ultra-wideband antenna array” discloses an ultra-wideband (UWB) antenna array. One embodiment of the invention employs a multi-element antenna for UWB beam forming and also for time-of-arrival vector processing to resolve multi-path problems in an UWB communication system. Another embodiment of the invention recovers the energy contained in the multi-path reflections to increase signal-to-noise ratios of received UWB pulses.

U.S. patent application Publication No. 20030146800 to Dvorak published Aug. 7, 2003 entitled “Ultra-wideband impulse generation and modulation circuit” discloses a modulated ultra wideband pulse generation system The system comprises a pulse waveform generator circuit operable to generate an on-off pulse waveform, and a modulating circuit operable to receive a modulating signal and to modulate the on-off pulse waveform in response to the modulating signal. Further embodiments of the invention comprise a variable bandwidth circuit operable to alter the bandwidth of the pulses comprising the on-off pulse waveform. Various embodiments of the invention comprise on-off keying modulation, pulse position modulation, and pulse phase modulation.

U.S. patent application Publication No. 20030194979 to Richards, et al. published Oct. 16, 2003 entitled “Method and apparatus for power control in an ultra wideband impulse radio system” discloses a method for power control in an ultra wideband impulse radio system including: (a) transmitting an impulse radio signal from a first transceiver; (b) receiving the impulse radio signal at a second transceiver; (c) determining at least one performance measurement of the received impulse radio signal; and (d) controlling output power of at least one of the first transceiver and the second transceiver in accordance with the at least one performance measurement.

U.S. patent application Publication No. 20030198212 to Hoctor, et al. published Oct. 23, 2003 entitled “Method and apparatus for synchronizing a radio telemetry system by way of transmitted-reference, delay-hopped ultra-wideband pilot signal” discloses a time-division-multiplexed radio communication system and method using transmitted-reference, delay-hopped (TR/DH) ultra-wideband (UWB) broadcast signal to provide a pilot signal to all mobile devices in a coverage area from which time synchronization is derived. Using this TR/DH UWB pulse pilot signal and low-complexity demodulation in the mobile devices, the mobile devices utilize a simple signal detection algorithm to acquire synchronization with the pilot signal. As a result, all devices in a local area network become synchronized to the system's bit clock. This reduces the search space required for signal acquisition, receiver signal processing complexity, and length of message preambles required to synchronize the base station receiver to a transmission from any of the mobile devices.

U.S. patent application Publication No. 20030198308 to Hoctor, et al. published Oct. 23, 2003 entitled “Synchronization of ultra-wideband communications using a transmitted-reference preamble” discloses a method and apparatus of initial synchronization, or acquisition, of time modulated ultra-wideband (UWB) communications uses a transmitted-reference preamble. The method and apparatus require that the transmitter first send a time-reference, delay-hopped (TR/DH) burst; such a burst is easily detected and can be processed to provide a time mark accurate to within a few nanoseconds. Following the transmission of the TRIDH burst, the transmitter waits a fixed period of time, the duration of which is known to the receiver, and then the transmitter sends a burst of pulse position modulation, time hopped (PPM/TH) or other time modulated UWB. After the reception of the first burst, the receiver can estimate the time of reception of the second burst to the accuracy of the time mark.

U.S. patent application Publication No. 20030227572 to Rowser, et al. published Dec. 11, 2003 entitled “Miniature ultra-wideband active receiving antenna” discloses a devices and methods for enabling receiving antennas to accommodate a wide operational bandwidth and high gain and sensitivity requirements despite a compact form-factor. A compact, broadband active receiving antenna uses one or more high transconductance transistors such as Field Effect Transistor(s) each paired with another Transistor, each pair arranged in a Cascode amplifier configuration. Some aspects of the invention involve a single high transconductance transistor arranged with a high efficiency transformer in a nondissipative feedback loop. This couples the signal energy from the drain or collector of the transistor to the transistor's source or emitter to improve linearity and dynamic range. This architecture has a high input resistance, low input capacitance, low noise and a very high second and third order Intercept Point. Since the gain is primarily a function of the amplifying electronics, it is not necessary to increase the directivity of the antenna to achieve higher gain.

U.S. patent application Publication No. 20030227980 to Batra, et al. published Dec. 11, 2003 entitled “Ultra wideband (UWB) transmitter architecture” discloses a system and method for analog signal generation and manipulation in an ultra-wideband (UWB) transmitter. One embodiment comprises a digital portion of an UWB transmitter, which is responsible for encoding a data stream to be transmitted, and an analog portion. The analog portion creates a stream of short duration pulses from the encoded data stream and then filters the stream of short duration pulses. To simplify the generation of the short duration pulses, a quantized representation of the short duration pulse is used. The quantized representation is created via the use of control signals that by coupling differential amplifiers together (such as an amplifier), generate a voltage drop across a resistor (such as a resistor) and hence, a current.

U.S. patent application Publication No. 20030235235 to Santhoff, published Dec. 25, 2003 entitled “Ultra-wideband communication through a wired network” discloses a method to increase the available bandwidth across a wired network. The method includes transmitting an ultra-wideband signal across the wired network. One embodiment of the present invention may transmit a multiplicity of ultra-wideband signals through a community access television network. The present invention may transmit an ultra-wideband signal across an optical network, a cable television network, a community antenna television network, a community access television network, a hybrid fiber-coax network, an Internet service provider network, and a PSTN network.

U.S. patent application Publication No. 20040005013 to Nunally, et al. published Jan. 8, 2004 entitled “Ultra-wideband pulse generation system and method” discloses a system and method to generate an ultra-wideband pulse. One method of the invention includes generating an ultra-wideband pulse that includes a first section representing a first data symbol, and a second section representing a second data symbol. A second method includes generating an ultra-wideband that comprises a plurality of time bins, with each time bin comprising a data symbol that represents a multiplicity of binary digits. Another method includes generating an ultra-wideband pulse that comprises a plurality of time bins, with each time bin representing a first data symbol. The same ultra-wideband pulse also includes an amplitude that represents a second data symbol.

U.S. patent application Publication No. 20040005016 to Tewfik, et al. published Jan. 8, 2004 discloses “High bit rate ultra-wideband OFDM” discloses a high-bit rate communication system for short range networking in high performance computing clusters. The system uses a hybrid ultra-wideband orthogonal frequency division-multiplexing scheme. The transmitted signals are sparse pulse trains modulated by a frequency selected from a properly designed set of frequencies. The train itself consists of frequency modulated ultra-wide pulses. The system achieves good detection by integrating several pulses, and high throughput by transmitting frequencies in parallel. Unlike traditional orthogonal frequency division-multiplexing systems, a given tone is transmitted only during parts of the transmission interval.

U.S. patent application Publication No. 20040008617 to Dabak, et al. published Jan. 15, 2004 entitled “Multi-carrier transmitter for ultra-wideband (UWB) systems” discloses a system and method for a multi-carrier ultra-wideband (UWB) transmitter. An embodiment comprises an UWB transmitter taking advantage of both code division multiple access (CDMA) and orthogonal frequency division multiplexing (OFDM) techniques to create a multi-carrier UWB transmitter. The multi-carrier UWB is capable of avoiding interferers by eliminating signal transmissions in the frequency bands occupied by the interferers. An alternate embodiment using intermediate frequencies and mixers is also presented.

U.S. patent application Publication No. 20040022304 to Santhoff, et al. published Feb. 5, 2004 entitled “Ultra-wideband communication though local power lines” discloses a method and apparatus structured to transmit a plurality of ultra-wideband pulses through an electric power medium. One embodiment of the method comprises an ultra-wideband transmitter structured to transmit the plurality of ultra-wideband pulses through the electric power medium and an ultra-wideband receiver structured to receive the plurality of ultra-wideband pulses from the electric power medium.

U.S. patent application Publication No. 20040032354 to Knobel, et al. published Feb. 19, 2004 entitled “Multi-band ultra-wide band communication method and system” discloses an ultra-wide band communication system and methods, including multi-band ultra-wide band communication systems and methods. Frequency sub-bands of an ultra-wide band spectrum are allocated for signal transmission. An ultra-wide band transmission including the information is sent, including sending a signal over each of the plurality of sub-bands. A first data signal containing information is converted into an encoded signal using an Inverse Fast Fourier Transform. The encoded signal is converted into an encoded ultra-wide band signal that can be pulsed or transmitted using burst symbol cycles. The encoded pulsed ultra-wide band signal is decoded using a Fast Fourier Transform to obtain the information.

U.S. patent application Publication No. 20040042561 to Ho, et al. published Mar. 4, 2004 entitled “Method and apparatus for receiving differential ultra wideband signals” discloses methods and apparatus for ultra-wideband, spread-spectrum, or ultra-wideband, spread-spectrum differential pulse communications.

U.S. patent application Publication No. 20040047313 to Rumpf, et al. published Mar. 11, 2004 entitled “Communication system providing hybrid optical/wireless communications and related methods” discloses a communication system includes at least one optical-wireless device coupled to a longitudinal side of an optical fiber. The optical-wireless device may include an optical fiber power unit for converting optical power into electrical power, and a wireless communication unit electrically powered by the optical fiber power unit. The optical-wireless device may include a substrate mounting the optical fiber power unit and the wireless communication unit to the longitudinal side of the optical fiber. The wireless communication unit may include a radio frequency transmitter, and a signal optical grating coupling the transmitter to the longitudinal side of the optical fiber. The radio frequency transmitter in some embodiments may include an ultra-wideband transmitter.

U.S. patent application Publication No. 20040057500 to Balachandran, et al. published Mar. 25, 2004 entitled “Variable spacing pulse position modulation for ultra-wideband communication links” discloses methods and systems for generating a variable spacing pulse position modulated (VSPPM) signal for transmission across an ultra-wideband communications channel. The variable pulse position modulated spread spectrum signal is created by encoding every M input data bits from an input data stream into a symbol consisting of N_{c} chips. Each chip is divided into 2^{M} sub-chips and each sub-chip is further divided into Nₚ time slots. A pulse is transmitted for each chip in the symbol. During each chip period, the pulse is placed in the sub-chip corresponding to the binary M-tuple (or symbol) value. A time hopping code sequence consisting of N_{c} elements with a one-to-one chip association is then applied to each symbol so that the position of each pulse is shifted to the appropriate time slot that corresponds to the time hopping code value.

U.S. patent application Publication No. 20040077306 to Shor, et al. published Apr. 22, 2004 entitled “Scalable ultra-wide band communication system” discloses multi-band ultra-wide band (UWB) communication methods and systems capable of adaptively and scalably supporting different applications with different requirements, as well as different desired properties relating to the communications. A method is provided for transmitting information using multi-band ultra-wide band transmission, including transmitting a signal over each of multiple frequency sub-bands, and allowing variation of at least one transmission parameter to facilitate trade-off between at least two of power consumption, energy collection, bit rate, performance, range, resistance to multiple access interference, and resistance to multipath interference and spectral flatness.

U.S. patent application Publication No. 20040087291 to Wada published May 6, 2004 entitled “Ultra-wideband transmitted and receiver, and ultra-wideband wireless communication method” discloses an ultra-wideband transmitter and receiver, and a ultra-wideband wireless communication method, which perform ultra-wideband wireless communication by a low-speed digital circuit having a low power consumption and controlling the effect of a multi-pass. In the ultra-wideband transmitter, a delay time controller generates and inputs a periodic pulse to a first matched filter, outputs the periodic pulse to a second matched filter when data to be transmitted are at a first level of a binary logic level, and outputs the periodic pulse to a third matched filter when the data to be transmitted are at a second level of the binary logic level. The first matched filter receives the periodic pulse from the delay time controller and outputs a reference signal for data determination the second matched filter receives the periodic pulse from the delay time controller and outputs a first data signal earlier than the reference signal by a predetermined time. The third matched filter receives the periodic pulse from the delay time controller and for outputs a second data signal later than the reference signal by a predetermined time. An adder adds outputs of the first, second, and third matched filters to each other and outputs an added signal, and an antenna section receives the added signal from the adder and radiates the received added signal into the air.

U.S. patent application Publication No. 20040090353 to Moore, published May 13, 2004 entitled “Ultra-wideband pulse modulation system and method” discloses an ultra-wideband pulse modulation apparatus, system and method that ostensibly increases the available bandwidth in an ultra-wideband, or impulse radio communications system. One embodiment comprises a pulsed modulation system and method that employs a set of different pulse transmission, or emission rates to represent different groups of binary digits. The modulation and pulse transmission enables the simultaneous coexistence of the ultra-wideband pulses with conventional carrier-wave signals. The invention may be used in wireless and wired communication networks such as CATV networks.

U.S. patent application Publication No. 20040105515 to Mo, et al. published Jun. 3, 2004 entitled “Selective data inversion in ultra-wide-band communications to eliminate line frequencies” discloses a method for generating an ultra-wide-band (UWB) having a reduced discrete frequency component defines frame synchronization signal and an inverted frame synchronization signal. As each frame is generated, the method randomly selects the frame synchronization signal or the inverted frame synchronization signal to be included with the frame. The frame synchronization signal is detected by a correlator and the magnitude of the correlation is used to indicate the detection of the frame synchronization signal.

U.S. patent application Publication No. 20040109506 to Hinton, et al. published Jun. 10, 2004 entitled “Method for transmit pulse design for ultra-wideband communications” discloses a method for designing transmission pulses for ultra-wideband communications systems. One embodiment comprises specifying a spectral description for the pulse. After a spectral description is created, then an approximation of the pulse can be created and well known optimization techniques, such as the least squares technique, can be used to minimize the difference between the approximation and the pulse. If the communications system is operating in the presence of interferers, then the spectral mask can be modified to ensure that the approximation carries no signal information in frequencies corresponding to the interferers.

Disabilities of Prior Art UWB

Each of the foregoing UWB approaches has certain advantages and disadvantages depending on the application, but notably all suffer from several common disabilities including: 1) lack of covertness in the time and/or frequency domains; 2) lack of inherent robustness in the time and/or frequency domains; and 3) lack of inherent security. As used in this context, the term “inherent” means without other (e.g., higher layer) techniques such as encryption, forward error correction (FEC) or the like.

For example, in terms of covertness, transmitters of time modulated systems use a series of pulses emitted at substantially regular intervals (albeit slightly modulated), and OFDM system transmitters have easily detected “stripes” in the frequency domain corresponding to the output of the FFT⁻¹ process, and timing features in the time domain. DS/CDMA systems typically have a pilot channel or other identifiable artifacts within their radiated signal. FHSS systems hop at very precise intervals over a predictable band and a prescribed number of discrete channels, thereby making them non-covert. The Gaussian monopulses of the TM-UWB system are also readily detected, even at low levels of transmission.

In terms of security, a DSSS system such as CDMA uses a spreading code (including XOR mask) that is readily discoverable without higher layer encryption. Similarly, the hop sequence of an FHSS system can be determined, since most of these systems use a seeded pseudo-random sequence generator algorithm. OFDM and TM-UWB also require higher layer encryption protocols for any significant level of security.

Furthermore, none of the aforementioned prior art techniques have inherent robustness or redundancy in both the time and frequency domains. Rather, each encounters significant problems when a portion of the signal in the time or frequency domain is lost (such as due to a narrowband or broadband jammer, Rayleigh fading, dropouts, interference, etc.). Again, error correction protocols such as well known Reed-Solomon or Turbo coding are needed to make these devices more operationally robust in the time and/or frequency domains.

Various other approaches to covert and/or secure communications systems are also evidenced in the prior art, each of the following patents incorporated herein by reference in its entirety. For example, U.S. Pat. No. 3,959,592 to Ehrat issued May 25, 1976 entitled “Method and apparatus for transmitting and receiving electrical speech signals transmitted in ciphered or coded form” discloses a method of, and apparatus for, transmitting and receiving electrical speech signals transmitted in ciphered form, wherein at the transmitter end there are formed in sections or intervals from the speech signals to be transmitted, by frequency analysis, signal components or parameter signals containing frequency spectrum-, voiced/voiceless information- and fundamental sound pitch coefficients, these signal components are ciphered, the ciphered signal components or parameter signals are transformed into a transmission signal and this transmission signal is transmitted over a transmission channel, and at the receiver end there is reobtained from the transmission signal the ciphered signal components or parameter signals and deciphered, and from the thus-obtained deciphered signal components or parameter signals there is generated by synthesis a speech signal which is similar to the original speech signal.

U.S. Pat. No. 4,052,565 to Baxter, et al. issued Oct. 4, 1977 and entitled “Walsh function signal scrambler” discloses a digital speech scrambler system allowing for the transmission of scrambled speech over a narrow bandwidth by sequency limiting the analog speech in a low-pass sequency filter and thereafter multiplying the sequency limited speech with periodically cycling sets of Walsh functions at the transmitter. At the receiver, the Walsh scrambled speech is unscrambled by multiplying it with the same Walsh functions previously used to scramble the speech. The unscrambling Walsh functions are synchronized to the received scrambled signal so that, at the receiver multiplier, the unscrambling Walsh signal is the same as and in phase with the Walsh function which multiplied the speech signal at the transmitter multiplier. Synchronization may be accomplished by time division multiplexing sync signals with the Walsh scrambled speech. The addition of the sync signals in this manner further masks the transmitted speech and thus helps to prevent unauthorized deciphering of the transmitted speech.

U.S. Pat. No. 4,694,467 to Mui issued Sep. 15, 1987 entitled “Modem for use in multipath communication systems” discloses a modem in which the transmitter uses spectrum spreading techniques applied to sequentially supplied input bits, a first group thereof having one spread spectrum sequence characteristic and a second group thereof having a different spread spectrum sequence characteristic, the spread spectrum bits being modulated and transmitted. The receiver generates complex samples of the received modulated signal at a baseband frequency and uses a detector for providing signal samples of the complex samples which are time delayed relative to each other. A selected number of the time delayed samples are de-spread and demodulated and the de-spread and demodulated samples are then combined to form a demodulated receiver output signal.

U.S. Pat. No. 4,817,141 to Taguchi issued Mar. 28, 1989 entitled “Confidential communication system” discloses apparatus where respective feature parameters extracted from a speech signal are converted into the corresponding line spectrum data in a first frequency band obtained by dividing the speech signal frequency band. Each of the line spectrum data is allocated previously to each one of the feature parameters. The extracted feature parameters are further converted into the corresponding line spectrum data in the other divided frequency bands other than the first frequency band. The converted line spectrum data are multiplexed for transmission. The corresponding line spectrum data in the divided frequency bands allocated to the same feature parameter are logically added to restore the feature parameters.

U.S. Pat. No. 4,852,166 to Masson issued Jul. 25, 1989 entitled “Analogue scrambling system with dynamic band permutation” discloses an analogue scrambling system with dynamic band permutation in which the speech signal is filtered, sampled at the rate fₑ, digitized, transformed by means of an analysis filter bank into N sub-band signals sampled at fₑ/N and transferred in a permuted order to a synthesis filter bank accomplishing the calculations of the scrambled signal sampled at the rate fₑ. A set of permutations is protected in a memory and a scrambling with dynamic permutation in time is obtained by changing the read addresses of the memory. The scrambled signal reconverted into an analogue signal is transmitted through an analogue channel to an unscrambler where it is preprocessed so that the synchronizing and equalizing functions are accomplished and where the accomplished processes are identical with those accomplished in the scrambler, the difference being that the permuted order of the N sub-band signals is restored.

U.S. Pat. No. 5,265,226 to Ueda issued Nov. 23, 1993 entitled “Memory access methods and apparatus” discloses a method of regenerating data convolutes plural data using maximal-sequence codes phase shifted by individual quantities and writes the convoluted data into a cyclic memory. A data regeneration apparatus reads out a desired data from the cyclic memory using a corresponding maximal-sequence code. Another method of regenerating data convolutes plural data using sequence codes for which are obtained weighting factors and maximal-sequence codes phase shifted by individual quantities and writes the convoluted data into a cyclic memory. Another data regeneration apparatus reads out a desired data from the cyclic memory using a corresponding maximal-sequence code. Still another method of regenerating data method convolutes plural data using maximal-sequence codes phase shifted by individual quantities and writes the convoluted data into a cyclic memory. Still another data regeneration apparatus reads out desired data from the cyclic memory using sequence codes which are obtained by weighting factors and maximal-sequence codes phase shifted quantities by individual.

U.S. Pat. No. 6,718,038 to Cusmario issued Apr. 6, 2004 entitled “Cryptographic method using modified fractional fourier transform kernel” discloses a cryptographic method that uses at least one component of a modified fractional Fourier transform kernel a user-definable number of times. For encryption, a signal is received; at least one encryption key is established, where each encryption key includes at least four user-definable variables that represent an angle of rotation, a time exponent, a phase, and a sampling rate; at least one component of a modified fractional Fourier transform kernel is selected, where each component is defined by one of the encryption keys; and the signal is multiplied by the at least one component of a modified fractional Fourier transform kernel selected. For decryption, a signal to be decrypted is received; at least one decryption key is established, where each decryption key corresponds with, and is identical to, an encryption key used to encrypt the signal; at least one component of a modified fractional Fourier transform kernel is selected, where each component corresponds with, and is identical to, a component of a modified fractional Fourier transform kernel used to encrypt the signal; and dividing the signal by the at least one component of a modified fractional Fourier transform kernel selected.

U.S. Pat. No. 6,728,306 to Shi issued Apr. 27, 2004 entitled “Method and apparatus for synchronizing a DS-CDMA receiver” discloses a system for synchronizing a DS-CDMA receiver to a received signal using actual data as opposed to a special training sequence. A chip by chip multiplication is applied to a sequence of received chip complex values in order to eliminate most traces of bit sign information from the received signal. The foregoing allows multiple bit length sequences of chips extracted from actual data to be combined, e.g., averaged, in order to reduce random noise. A low noise vector which has been derived from actual data can then be used to synchronize the receiver to a desired degree of precision.

Holography

Holography is a well-understood science wherein both intensity and phase information are captured within a medium, such where reference and object laser beams are used to capture the substantially randomized scattering of light from a three-dimensional object. Holography has been applied to a number of different applications such as radar and encryption, as evidenced by the following patents and publications, each of which are incorporated herein by reference in their entirety. For example, U.S. Pat. No. 4,924,235 to Fujisaka, et al. issued May 8, 1990 entitled “Holographic radar” discloses a holographic radar having receivers for amplifying, detecting, and A/D-converting the RF signals in all range bins received by antenna elements and a digital beamformer for performing digital operations on the outputs of these receivers to generate a number of beams equal to the number of antenna elements. Three or four antenna arrays (D0 to D3), each array being formed of a plurality of antenna elements, are oriented in different directions to provide 360-degree coverage and switches are provided to switch the connection between the antenna elements and the receivers according to pulse hit numbers and range bin numbers. Thus 360-degreecoverage can be attained with a small, inexpensive apparatus requiring as many receivers, memory elements and a digital beam former as needed for a single antenna array. The number of receivers can be further reduced by assigning one receiver per group of K array elements, providing memory elements, in number corresponding to the number of antenna elements, and operating further switches in synchronization with the transmit pulses and storing the video signals in the respective memory elements.

U.S. Pat. No. 5,734,347 to McEligot issued Mar. 31, 1998 entitled “Digital holographic radar” discloses apparatus producing a radar analog of the optical hologram by recording a radar image in the range/doppler plane, the range/azimuth plane, and/or the range/elevation plane according to the type and application of the radar. The invention embodies a means of modifying the range doppler data matrix by scaling, weighing, filtering, rotating, tilting, or otherwise modifying the matrix to produce some desired result. Specific examples are, removal of known components of clutter in the doppler frequency spectrum by filtering, and rotating/tilting the reconstructed image to provide a view not otherwise available. In the first instance, a reconstructed image formed after filtering the Fourier spectrum would then show a clutter free replication of the original range/PRI object space. The noise floor can also be modified such that only signals in the object space that produce a return signal above the ‘floor’ will be displayed in the reconstructed image.

U.S. Pat. No. 5,793,871 to Jackson issued Aug. 11, 1998 entitled “Optical encryption interface” discloses an analog optical encryption system based on phase scrambling of two-dimensional optical images and holographic transformation for achieving large encryption keys and high encryption speed. An enciphering interface uses a spatial light modulator for converting a digital data stream into a two dimensional optical image. The optical image is further transformed into a hologram with a random phase distribution. The hologram is converted into digital form for transmission over a shared information channel. A respective deciphering interface at a receiver reverses the encrypting process by using a phase conjugate reconstruction of the phase scrambled hologram.

U.S. Pat. No. 5,940,514 to Heanue, et al. issued Aug. 17, 1999 entitled “Encrypted holographic data storage based on orthogonal phase code multiplexing” discloses an encryption method and apparatus for holographic data storage. In a system using orthogonal phase-code multiplexing, data is encrypted by modulating the reference beam using an encryption key K represented by a unitary operator. In practice, the encryption key K corresponds to a diffuser or other phase-modulating element placed in the reference beam path, or to shuffling the correspondence between the codes of an orthogonal phase function and the corresponding pixels of a phase spatial light modulator. Because of the lack of Bragg selectivity in the vertical direction, the phase functions used for phase-code multiplexing are preferably one dimensional. Such phase functions can be one-dimensional Walsh functions. The encryption method preserves the orthogonality of reference beams, and thus does not lead to a degradation in crosstalk performance.

U.S. Pat. No. 6,288,672 to Asano, et al. issued Sep. 11, 2001 and entitled “Holographic radar” discloses apparatus wherein high-frequency signals from an oscillator are transmitted, through a power divider and a switch, from transmission antennas (T1, T2, T3). Reflection waves reflected by targets are received by reception antennas (R1, R2) to thereafter be fed via a switch to a mixer. The mixer is supplied with transmission high-frequency signals from the power divider to retrieve beat-signal components therefrom, which in turn are converted into digital signals for the processing in a signal processing circuit. The transmission antennas (T1 to T3) and the reception antennas (R1, R2) are switched in sequence whereby it is possible to acquire signals equivalent to ones obtained in radars having a single transmission antenna and six reception antennas.

U.S. Pat. No. 6,452,532 to Grisham issued Sep. 17, 2002 entitled “Apparatus and method for microwave interferometry radiating incrementally accumulating holography” discloses a satellite architecture and method for microwave interferometry radiating incrementally accumulating holography, used to create a high-gain, narrow-bandwidth actively-illuminated interferometric bistatic SAR whose VLBI has a baseline between its two bistatic apertures, each on a different satellite, that is considerably longer than the FOV, in contrast to prior art bistatic SAR where the interferometer baseline is shorter than the FOV. Three, six, and twelve satellite configurations are formed of VLA satellite VLBI triads, each satellite of the triad being in its own nominally circular orbit in an orbital plane mutually orthogonal to the others of the triad. VLBI pairs are formed by pairwise groupings of satellites in each VLA triad, with the third satellite being used as a control satellite to receive both Michelson interferometric data for phase closure and Fizeau interferometric imaging data that is recorded on a holographic disc, preserving phase.

U.S. Pat. No. 6,469,672 to Marti-Canales, et al. issued Oct. 22, 2002 entitled “Method and system for time domain antenna holography” discloses a method which permits determination of the electrical features of an antenna. The antenna is excited with an ultra-short voltage pulse and the far field radiation pattern of the antenna is measured. The resulting time-varying field distribution across the antenna aperture is then reconstructed using time domain holography. A direct analysis of the holographic plot permits the determination a wide range of electrical properties of the antenna.

U.S. Pat. No. 6,608,708 to Amadon, et al. issued Aug. 19, 2003 entitled “System and method for using a holographic optical element in a wireless telecommunication system receiver” discloses a holographic optical element (HOE) device mounted in a receiver unit, such as a wireless optical telecommunication system receiver. The HOE device includes a developed emulsion material having an interference pattern recorded thereon, sandwiched between a pair of elements, such as a pair of clear glass plates. In operation, the HOE device uses the recorded interference pattern to diffract incident light rays towards an optical processing unit of the system receiver. The optical processing unit includes a photodetector that detects the diffracted light rays. The system receiver can include various other components and/or can have various configurations. In one configuration, a plurality of mirrors is used to control the direction of the light rays coming from the HOE device, and a collimating optical assembly collimates these light rays. A beam splitting optical assembly can be used to split the light rays into a tracking channel and a communication channel.

U.S. patent application Publication No. 20030179150 to Adair, et al. published Sep. 25, 2003 entitled “HOLOGRAPHIC LABEL WITH A RADIO FREQUENCY TRANSPONDER” discloses a label for identifying an object includes a radio frequency transponder and a hologram. The radio frequency transponder has an antenna and a transponder circuit sandwiched between two layers of material which form exterior surfaces of the transponder. The hologram comprises a first layer of non-metallic material applied to one of the exterior surfaces and forming a non-metallic reflector of light. A generally transparent second layer contains a holographic image and extends across the first layer. Because the reflective first layer is made of a non-metallic material, its close proximity to the radio frequency transponder does not detune the transponder as may occur when metallic holograms are placed in close proximity to the transponder. Thus the hologram provides a deterrent to unauthorized use of the label without affecting the operation of the radio frequency transponder.

U.S. patent application Publication No. 20030184467 to Collins published Oct. 2, 2003 entitled “APPARATUS AND METHOD FOR HOLOGRAPHIC DETECTION AND IMAGING OF A FOREIGN BODY IN A RELATIVELY UNIFORM MASS” discloses an apparatus and method for displaying a foreign body in a relatively uniform mass having similar electromagnetic impedance as the foreign body comprising of at least two ultra wide band holographic radar units adapted to generate, transmit and receive a plurality of 12-20 GHz frequency signals in a dual linear antenna with slant-angle illumination. The invention may be utilized to obtain qualitative and quantitative data regarding the composition of the object under investigation.

Despite the foregoing variety of approaches to wideband radio frequency communications, no practical system having (i) covertness in both the time and frequency domains, (ii) inherent redundancy in the time and frequency domains, and (iii) inherent security, has been developed.

Hence, there is a salient need for an improved wideband communications system that provides each of the foregoing features and benefits. Such improved apparatus and methods would also ideally allow for multiple access as well as high data rates over the air interface, all without significant higher layer protocol support, and would be readily implemented in existing hardware.

### SUMMARY OF THE INVENTION

The present invention satisfies the foregoing needs by providing improved wideband communications apparatus and method which utilizes holographic signal processing.

In a first aspect of the invention, radio frequency communications apparatus adapted to transmit holographically encoded signals is disclosed. In one embodiment, the holographically encoded signals are phase-coded at least twice.

In a second aspect of the invention, radio frequency communications apparatus adapted to receive and decode holographically encoded signals is disclosed. In one embodiment, the holographically encoded signals are phase-decoded at least twice.

In a third aspect of the invention, improved wideband communications apparatus is disclosed. In one embodiment, the apparatus comprises: a processor adapted to process baseband data; data conversion apparatus operatively coupled to the processor; and an antenna operatively coupled to the conversion apparatus and adapted to radiate signals; wherein the signal processor is configured to, prior to transmission over the antenna: phase-code the baseband data according to a first phase code; transform the phase-coded data to produce transformed phase-coded data; and phase-code the transformed phase-coded data according to a second phase code.

### BRIEF DESCRIPTION OF THE DRAWINGS

The features, objectives, and advantages of the invention will become more apparent from the detailed description set forth below when taken in conjunction with the drawings, wherein:

FIG. 1 is a functional block diagram of a first exemplary embodiment of a UWB transmitter apparatus according to the invention.

FIGS. 1a-i and 1a-2 are functional block diagrams of second exemplary embodiments of a UWB transmitter apparatus according to the invention, wherein each digital bit stream, such as from the input vocoder, is mirrored to both FFT and DHT baseband devices.

FIG. 1b is schematic of an exemplary DAC driver network for use with an exemplary Virtex FPGA baseband device.

FIG. 1c is a top plan view of an exemplary SoC device having reduced parasitics and adapted for holographic UWB processing according to the present invention.

FIG. 1d is a functional block diagram of a third exemplary embodiment of a UWB transmitter apparatus according to the invention, including an impedance matching device, power amplifier, and band pass filter disposed between the converter and the antenna.

FIG. 1e is a functional block diagram of a fourth exemplary embodiment of a UWB transmitter apparatus according to the invention, including a plurality of baseband processors disposed in substantial parallel configuration.

FIG. 1f is a functional block diagram of a fifth exemplary embodiment of a UWB transmitter apparatus according to the invention, including a high speed FIFO buffer and associated clocking.

FIG. 1g is a graphical representation of a first exemplary embodiment of a packet protocol useful with the UWB system of the invention.

FIG. 1h is a logical block diagram of an exemplary cable system multimedia packetizer and transport stream multiplexer architecture useful with the UWB system of the present invention.

FIGS. 2a-2c are graphical and tabular representations of FCC indoor and outdoor UWB spectral masks in exemplary region(s) of interest.

FIG. 3 is a graphical representation of BER versus E_{b}/N₀ for a variety of different modulations schemes, including AWGN.

FIG. 4a is a graphical representation of bit per second per Hz versus E_{b}/N₀ (for a BER of 10⁻⁵) for various types of modulations, including Shannon's limit, for non-UWB systems.

FIG. 4b is a graphical representation of limiting bit per second per Hz values versus E_{b}/N₀ (Shannon's limit) for UWB systems.

FIG. 5 is a graphical representation of an exemplary data throughput of a typical UWB system (versus other non-UWB technologies) as a function of range.

FIG. 6 is a functional block diagram of an exemplary MIMO antenna and signal processing architecture according to the invention.

FIGS. 7a-7x are logical block diagrams of various exemplary configurations of the UWB transmitter system according to the invention, generated during simulation of the device using LabView software.

FIGS. 8a and 8b are functional block diagrams of exemplary adaptive holographic UWB (AHUWB) systems according to the invention.

FIGS. 9a-9d are functional block diagrams of exemplary direct conversion transmitter systems according to the invention.

FIGS. 10a and 10b are functional block diagrams of exemplary embodiments of a UWB software-directed radio (SDR) according to the invention.

FIG. 11 is a functional block diagram of an exemplary super-orthogonal turbo coder useful with the invention.

FIG. 12 is a functional block diagram of an exemplary super-orthogonal convolutional coder useful with the invention.

FIG. 13 is a functional block diagram of an exemplary multi-stage phase coder embodiment according to the invention, having first and second phase code stages.

### DETAILED DESCRIPTION OF THE PREFERRED EMBODIMENT

Reference is now made to the drawings wherein like numerals refer to like parts throughout.

As used herein, the terms “hologram” and “holographic” refer to any waveform or set of waveforms, regardless of physical medium (e.g., electromagnetic, acoustic/sub-acoustical or ultrasonic, matter wave, gravity wave, etc) and dimensionality, which has holographic properties.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), Reconfigurable Compute Fabrics (RCFs), and application-specific integrated circuits (ASICs). Such digital processors may be contained on a single unitary IC die, or distributed across multiple components.

As used herein, the term “integrated circuit (IC)” refers to any type of device having any level of integration (including without limitation ULSI, VLSI, and LSI) and irrespective of process or base materials (including, without limitation Si, SiGe, CMOS and GAs). ICs may include, for example, memory devices (e.g., DRAM, SRAM, DDRAM, EEPROM/Flash, ROM), digital processors, SoC devices, FPGAs, ASICs, ADCs, DACs, transceivers, and other devices, as well as any combinations thereof.

As used herein, the term “display” means any type of device adapted to display information, including without limitation CRTs, LCDs, TFTs, plasma displays, LEDs, and fluorescent devices.

As used herein, the term “base band” refers to the band of frequencies representing or related to an original signal to be communicated.

As used herein, the term “carrier wave” refers to the electromagnetic or other wave on which the original signal is carried. This wave has a frequency or band of frequencies (as in spread spectrum) selected from an appropriate band for communications transmission or other functions (such as detection, ranging, etc.).

As used herein, the term “ultra wideband (UWB)” refers to any system with significantly broad bandwidth including, for example and in no way limited to, those whose bandwidth is on the order of 25% or more of its center frequency. Such bandwidth maybe unitary or a compilation of one or more sub-bands, whether contiguous or otherwise.

Overview

Co-owned U.S. Pat. No. 4,972,480, issued Nov. 20, 1990 and entitled “Holographic Communications Device and Method” (hereinafter “the '480 patent”), which is incorporated herein by reference in its entirety, discloses a disruptive secure and covert modulated radio frequency communications system of a holographic nature. This system was designed to produce transmissions having the characteristics of random noise in both the time and frequency domains, and a high degree of information redundancy characteristic of diffuse image holograms. In effect, it produces a signal appearing as noise in both the time and frequency domains. Desirable characteristics of the basic holographic technology include: (i) a high degree of covertness; (ii) a lack of data frame registration (i.e., the inverse Fourier Transform of F(t) is f(w), therefore the inverse transform of F(t-T) is f(w)e^{iwT}, where F(t-T) is the delayed hologram frame, and f(w)e^{iwT} is the registered base band frame which is frequency shifted); (iii) rapid receiver acquisition and de-spreading (due to aforementioned lack of registration); (iv) great channel robustness (i.e., hologram RF signals can survive very high percentage losses through inherent redundancy afforded by convolution of code and base band spectrums); and (v) the ability to receive and decode parts of multiple holograms (i.e., hologram received in receiver time window t is F′₁(t-T₁)+F′₂(t-T₂), with base band of f₁(w)^{eiwT}₁+f₂(w)^{eiwT}₂ ; multiplication by e^{-1code1} de-spreads frame 1, while frame 2 appears as wideband noise, and a narrowband filter can be used to recover frame 1).

While the technology of the '480 patent is clearly useful and provides many intrinsic benefits as described, further improvements are possible (especially with respect to certain types of wideband applications), and the technology can be expanded in terms of the scope and types of applications with which it may be used.

U.S. Provisional Patent Application Ser. No. 60/492,628 filed Aug. 4, 2003 and entitled “ENHANCED HOLOGRAPHIC COMMUNICATIONS APPARATUS AND METHOD” previously incorporated herein by reference in its entirety discloses several enhancements and improvements to the basic technology disclosed in the '480 patent, as well a variety of new applications therefor. Such enhancements include, inter alia, the use of spectrum spreading techniques (e.g., frequency hopping spread spectrum, or FHSS), and use of multiple base band modulations including, e.g., frequency modulation, amplitude modulation, various types of pulse modulation, etc., for the purpose of adding a multitude of simultaneous users and a multitude of simultaneous “pages” of information all within a single covert and noise-like transmission.

Furthermore, improved techniques by which more information can be carried on the waveform through assignment of the dc base band channel (described in the '480 patent) to an information-modulated waveform are also provided in this prior disclosure. Yet further enhancements include the use of random time-dithered waveforms, to foil eavesdroppers using correlation-based intercept receivers.

New uses of the holographic technology include the application to other information carrying sources of energy such as coherent and incoherent light sources, x-rays, and even gamma rays, mechanical sources of energy (such as acoustical and other sonic waves outside the range of human hearing), and finally to matter waves such as subatomic particle beams. This broad range of media allows the technology to be applied to any number of e.g., communications, radar, and sonar-based devices.

The present disclosure provides yet further enhancements to the technology, including an improved ultra-wideband (UWB) architecture which is greatly simplified and which provides a number of inherent benefits. Such UWB systems and techniques can be used to, inter alia, further enhance covertness, increase signal robustness and error correction, increase data throughput, simplify hardware requirements, reduce radiated power and attendant inter-signal interference throughout the frequency spectrum. UWB techniques can be used, for example, for wireless LAN (“WiFi” or IEEE 802.15 PAN or 802.16 “WiMax”) type applications, satellite uplink/downlink communications, high speed data transfer between devices within a computer architecture (such as two busses in a computer system), biomedical applications (UWB signals typically have excellent penetration capability), video (e.g., MPEG2 or MPEG4 streaming), covert military or security communications, radars (including, e.g., SAR or phased array), and a plethora of other applications where any of the aforementioned features would be useful.

Exemplary UWB Transmitter Architectures

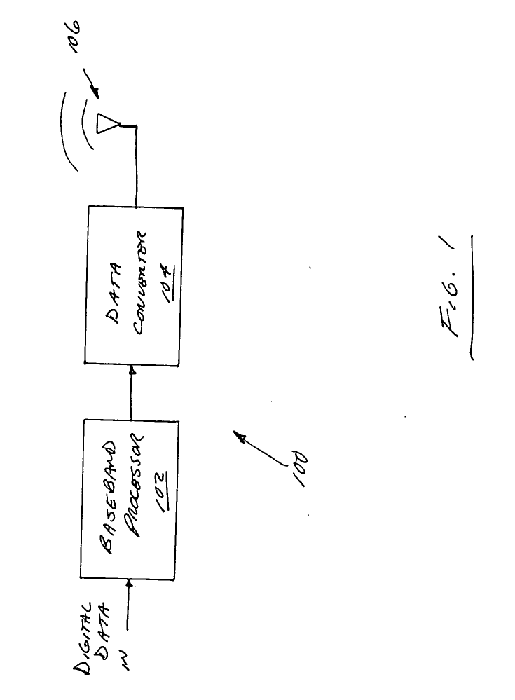

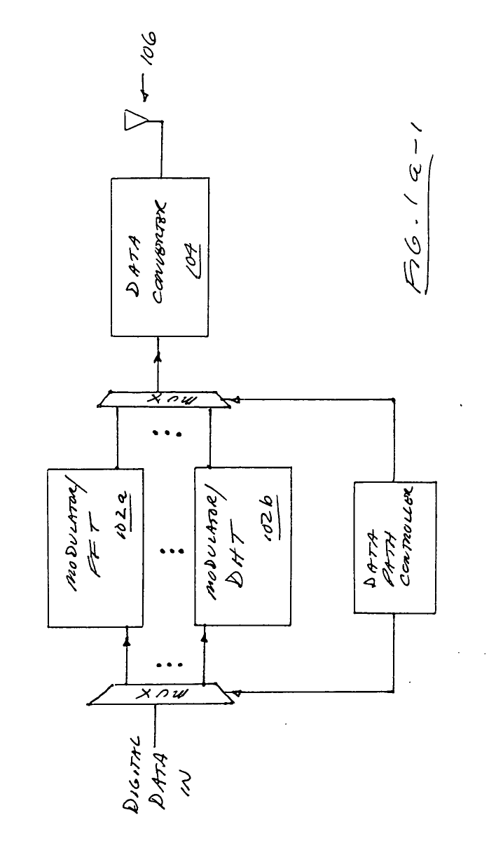

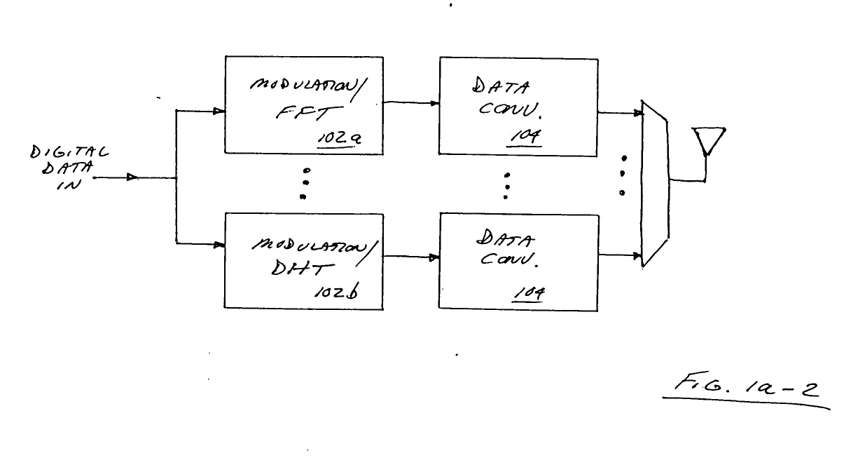

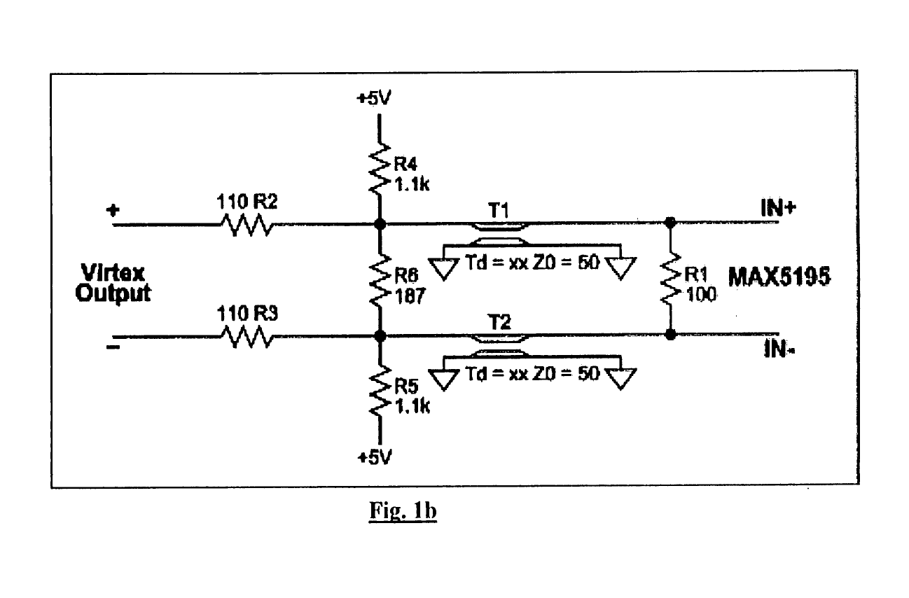

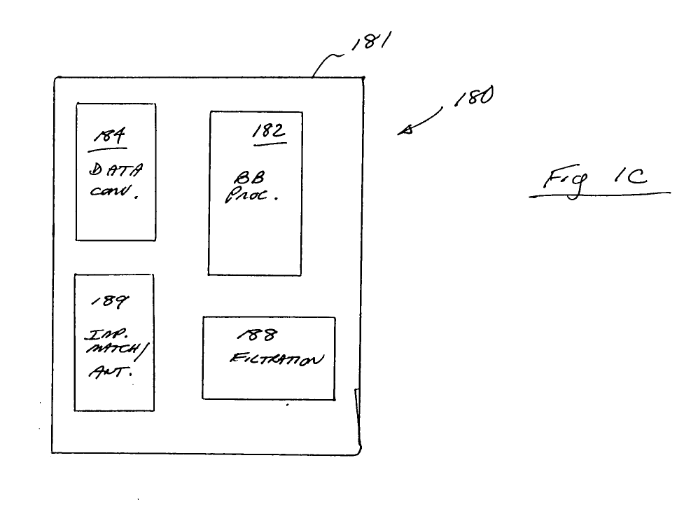

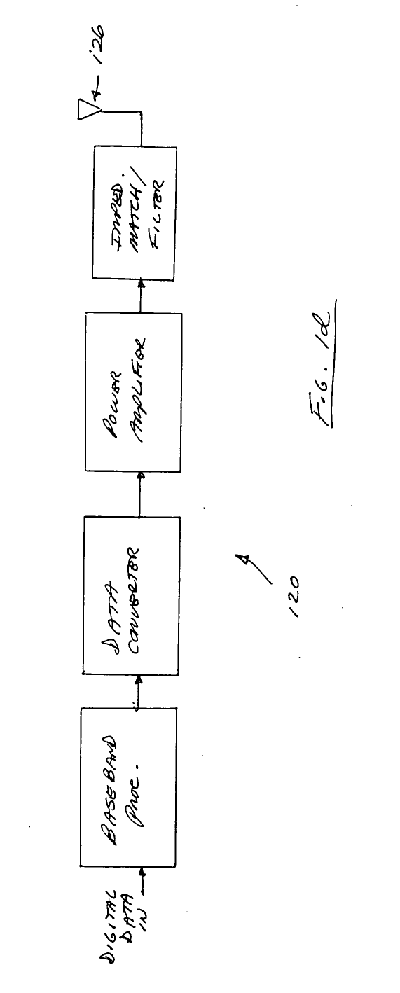

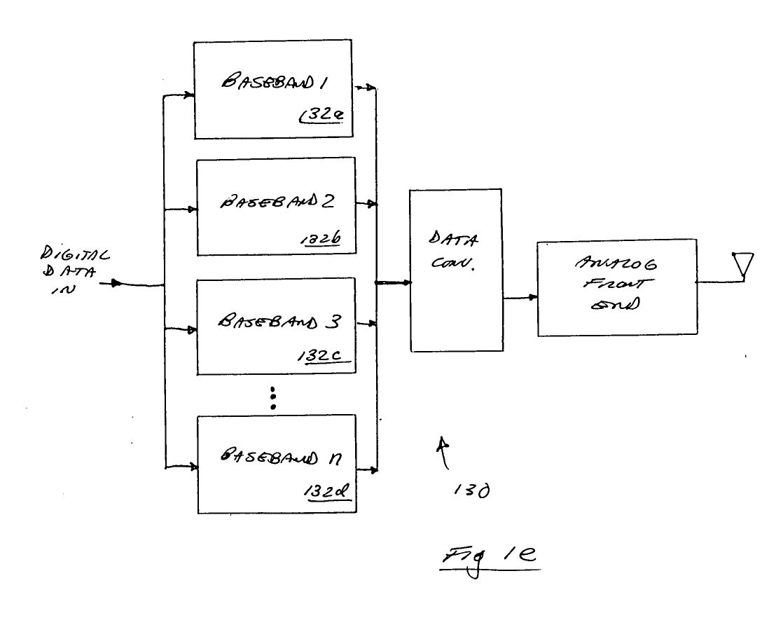

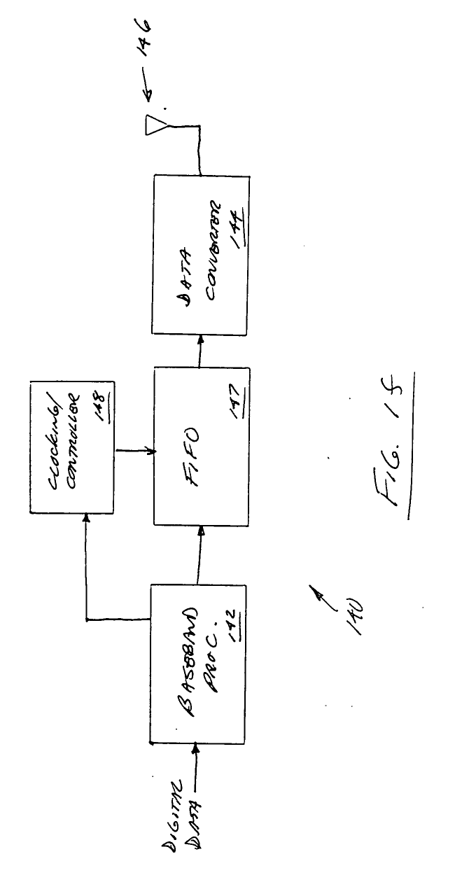

Referring now to FIG. 1, an exemplary transmitter apparatus according to the invention is described in detail.

It is noted that while portions of the following description are cast in terms of RF (wireless) voice and data communications applications, the present invention may be used in conjunction with any number of different bearer mediums, functions, and topologies (as described in greater detail subsequently herein).

Furthermore, while the following discussion is cast primarily in terms of a number of discrete components or device, it will be recognized that many or even all of the components utilized in the various embodiments may be rendered as a single integrated circuit (IC) device, such as an SoC or comparable aggregation of components on a single die, or alternatively a chipset of the type well known in the art. For example, in one variant, a holographic UWB transceiver device rendered in Silicon Germanium (SiGe) is contemplated. Myriad other configurations and processes are possible.

Also, while discussed primarily in terms of wideband or UWB variants, certain of the improvements described herein may readily be applied to a carrier based or heterodyne architecture as will be appreciated by those of ordinary skill.

Accordingly, the following discussion is merely exemplary of the broader concepts of the invention.

As shown in FIG. 1, a first embodiment of the exemplary transmitter apparatus generally comprises a baseband processor 102, a data converter 104, and a wideband antenna 106. This configuration has the advantage of simplicity, in that no power amplifier (PA) is required (at least in certain configurations) due to the extremely low radiated power levels utilized by the architecture as a result of its great frequency bandwidth, and the low voltage swings required at the antenna due to the selected time-bandwidth product (i.e., the absence of short duration chirps or pulses which increase per-bit energy densities). As will be discussed in greater detail below, the data coding rate can also be adjusted to achieve desired bandwidth, radiated power, and data rate targets as desired. Furthermore, no reference oscillator, phase-lock loop (PLL) synthesizer, VCO, or mixer (characteristic of heterodyne or carrier-based systems) is required in the illustrated architecture.

In the exemplary configuration, the antenna 106 is adapted to radiate across a bandwidth of several GHz; e.g., approximately 4-6 Ghz as measured at the −10 dB downpoints, although the apparatus of the present invention may readily be adapted for other frequency bands, including very high frequency millimeter bands (e.g., on the order of 20 Ghz or higher) and may be of literally any width(s) consistent with the data rate requirements of the system. The exemplary 4-6 GHz band is chosen, inter alia, to avoid GPS bands (typically between 1.6 and 1.9 GHz), as well as the heavily utilized 2.4 GHz and other regions (such as 900 MHz and 1.8 Ghz). While the newly adopted FCC bands at 5.250-5.350 GHz and 5.470-5.725 GHz are within the 4-6 GHz of the exemplary embodiment, these new bands are comparatively narrow in nature (100 MHZ and 255 MHz, respectively), and hence constitute only about 5 and 13%, respectively, of the frequency bandwidth allocated herein. As will be described in detail below, however, adaptive or suppressive techniques may also be utilized by the present invention if desired to mitigate any interference from these bands.

Additionally, a 2GHz band (or other frequency band) may be selected at, for example, 3.0-5.0 GHz, thereby avoiding the 2.4 GHz range as well as the GPS band and the two new FCC bands above 5GHz. This selection also inherently improves the range of the system for a given BER, since the propagation loss PL is less than for the higher frequencies.

Due to the great frequency bandwidth, the radiated power levels from the system 100 are so low as to be well below the ambient noise “floor”. As is known, the emitted power from a radiator is generally given by the following relationship:
P=E₀²4πR²/η (1)
where E₀ represents the electric field strength expressed in terms of V/m, R is the radius of a conceptual sphere at which the field strength is determined, and η is the characteristic impedance under vacuum where η=377 ohms. As an example of the foregoing, the FCC Part 15.209 rules limit the emissions for intentional radiators to 500 uV/m measured at a distance of three (3) meters in a 1 MHz bandwidth at frequencies greater than 960 MHz. This corresponds to an emitted power density of approximately −41 dBm/MHz (75 nW/Mhz). As can be seen, by spreading the same energy over a bandwidth of, say 2 GHz, the emitted spectral power density (in dBm) is dramatically lowered. Herein lies a significant advantage of the present invention, i.e., “peaceful” and non-interfering co-existence with other more narrow-banded systems such as Bluetooth, 802.11/802.16, CDMA, GSM, 3GPP/3GPP2, etc., FDMA systems, and even other UWB systems including impulse-based or time modulated variants, even when the frequency bands overlap.

In the present embodiment, noise is assumed to be primarily additive white Gaussian noise (AWGN), although multi-path components may also exist (addressed subsequently herein with respect to optional diversity and MIMO antenna systems). A maximum bit error rate (BER) of 10⁻³ uncoded is used as the basis for channel calculations, which, if coded (e.g. convolutional or “turbo”) as described subsequently herein, would be reduced to at least one or two orders of magnitude. Such coding will also reduce overall channel throughput, however, and hence is not desired or utilized in all applications.

As is well known, free space propagation (i.e., path loss) is proportional to the square of the propagation distance, which results in a path loss given by L(d)=20 log(4π/λ)+20 log(d), where λ is the “carrier” wavelength. However, such path loss models must be carefully applied to UWB system since, inter alia, UWB signals span a very large bandwidth such that change in received power over the bandwidth cannot be ignored as in narrowband systems. However, the received power in a UWB system that uses one constant gain and one constant aperture antenna will generally be somewhat frequency independent. For a constant aperture transmit/constant gain receive configuration:

$${P}_{r} = {P}_{t} {A}_{et} {G}_{r} \frac{1}{4 π {d}^{2}}$$

For a constant aperture transmit/constant aperture receive configuration:

$${P}_{r} = {P}_{t} {A}_{et} {A}_{er} \frac{1}{{( λ d )}^{2}}$$

In order to estimate the bit error rate performance of the system at practical distances, a “link budget” or margin is determined for the proposed system. The average energy per information bit before filtering is defined as E_{b}. The ratio of E_{b} to N is commonly used as a metric of channel efficiency:
E_{b}/Nₜₒₜ=(PₜGₜ)(1/Lₚᵣₒₚ4πR²)(Gᵣλ²/4π)η_{rec}/(N₀+I)R_{b}
The average received E_{b}/N₀ (Energy per Bit (E_{b}) to Spectral Noise Density (N₀) ratio) can be obtained with the following relationship:

$$\frac{{\overline{E}}_{b}}{{N}_{0}} = {P}_{l} + {G}_{l} + {G}_{r} - {L}_{1} - {L}_{d} - 10 {log}_{10} ( {R}_{b} ) - ( - 173.83 + F ) - I$$

where Pₜ is transmitted power, Gₜ and Gᵣ denote transmitter and receiver antenna gain, L₁=free space loss at one meter, with L₁=20 log₁₀(4πf_{c}/c), where f_{c}=(fₘᵢₙ×fₘₐₓ)^{1/2} with fₘᵢₙ and fₘₐₓ measured at the −10 dB downpoints. The path loss between 1 and d meters is L_{d}=20 log ₁₀(d) dB. The transmission rate for the selected modulation is R_{b}=1/T_{b}, and the spectral density of the receiver noise is estimated at −173.83 dBm/Hz+F dB, where −173.83 is the thermal noise level for a temperature of 300K and F is the noise figure for the receiver, the latter assumed to be roughly 10 dB. I comprises the implementation loss, assumed to be on the order of 1 dB. See, e.g., “Performance of Coherent UWB Rake Receivers with Channel Estimators” B. Mielczarek, et al., 2003, incorporated herein by reference in its entirety.

For the present embodiment (4-6 GHz at −10 dB downpoints), F_{c}=4.899 GHz. Hence, L₁=46.24 dB, and Ld at 100 m=40.0 dB for that frequency.

One useful strategy for approximately determining the required or desired transmit power to: (i) determine E_{b}/N₀ for the desired BER (here, 10⁻³); (ii) convert E_{b}/N₀ to a “carrier” to noise ratio (C/N) at the receiver using the bit rate; and (iii) add the path loss and fading margins. For the holographic phase code modulation, a BER as a function of E_{b}/N₀ is first assumed to be comparable to other UWB systems (e.g., TH or DS), with E_{b}/N₀ on the order of 10 for a BER of 10⁻³.This assumption is used as somewhat of a “middle of the road” criterion, since it is expected that the E_{b}/N₀ of the present holographic system is significantly lower at a given BER than conventional systems, due in part to the phase-code modulation and transform of the data stream before transmission over the air interface, yet it is entirely possible that higher E_{b}/N₀ values will exist at BER=10⁻³ (and other values) due to physical and practical limitations of implementation.

Converting E_{b}/N₀ to the carrier to noise ratio (C/N) is accomplished using the equation:
C/N=(E_{b}/N₀)×(f_{b}/B_{w})
Where:
f_{b} is the bit rate, and
B_{w} is the receiver noise bandwidth.
   Hence, at a bit rate of 100 Mbps and B_{w} of 2 GHz (assumed to coincide with the frequency bandwidth), the exemplary C/N is 10 dB+10 log(1×10⁸/2×10⁹)=10 dB-13 dB=−3 dB.

Receiver noise power may be computed using Boltzmann's equation:
N=kTB
Where:
k is Boltzmann's constant=1.380650×10−23 J/K;
T is the effective temperature in Kelvin, and
B is the receiver bandwidth.
   Therefore, in the present example, N=(1.380650×10⁻²³J/K)*(300K)*(2 GHz)=8.28×10⁻¹²W=8.28×10⁻⁹ mW=10 log(8.28E−9)=−80.8 dBm.

The receiver has some inherent noise in the amplification and processing of the signal. This is referred to as the receiver noise figure. For this example, the receiver is assumed to have a 6 dB noise figure, so the receiver noise level will be N=−74.8 dBm.

Now, carrier power is determined as C=C/N*N, or in dB, C=C/N+N. Hence:
C=−3 dB+−74.8 dBm=−77.8 dBm
This is in effect how much power the receiver must have at its input. To determine the required transmitter power, the path loss and any fading margin associated with the system must be accounted for. The path loss in dB for an open air site is:
P_{L}=22 dB+20 log(d/λ)
Where:
P_{L} is the path loss in dB;
d is the distance between the transmitter and receiver; and
λ is the wavelength of the RF “carrier” (=c/frequency)
   This assumes an antenna with no gain is being used. Hence, for the exemplary embodiment, P_{LL}=22 dB+20 log(100/0.075)=22+62.5=84.5 dB at 4 GHz and 100 meters. Also, P_{LH}=22 dB+20 log(100/0.05)=22+66=88 dB at 6 GHz and 100 meters.

Finally, adding the assumed 5 dB fading margin will give the required transmitter power:
P_{L}=−77.8+84.5+5=11.7 dBm=14.8 mW at 4 GHz
P_{H}=−77.8+88+5=15.2 dBm=33.1 mW at 6 GHz
The result, roughly 15-33 mW, is well within a reasonable power level for spread spectrum interfaces in the 4-6 GHz band. Note also that these numbers are based on an assumed 100 meter range, which is considerably larger than many UWB applications require.

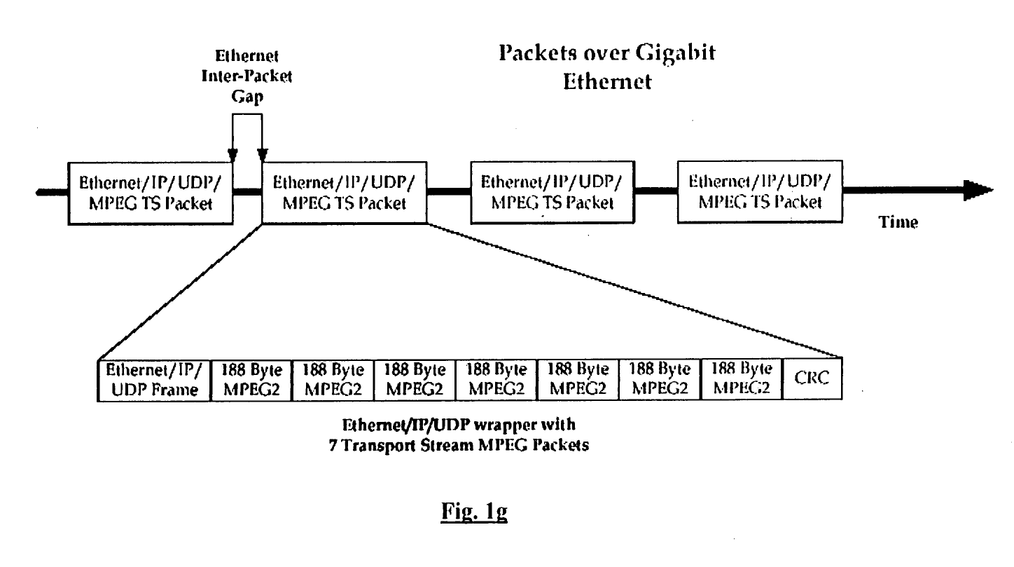

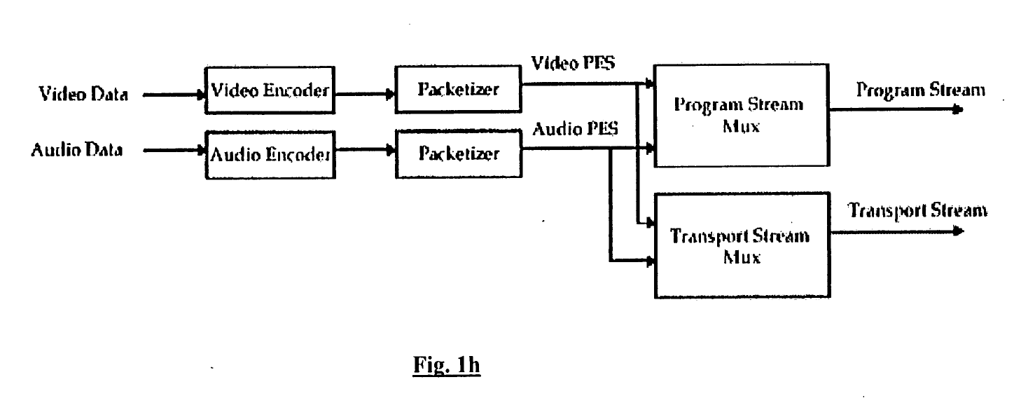

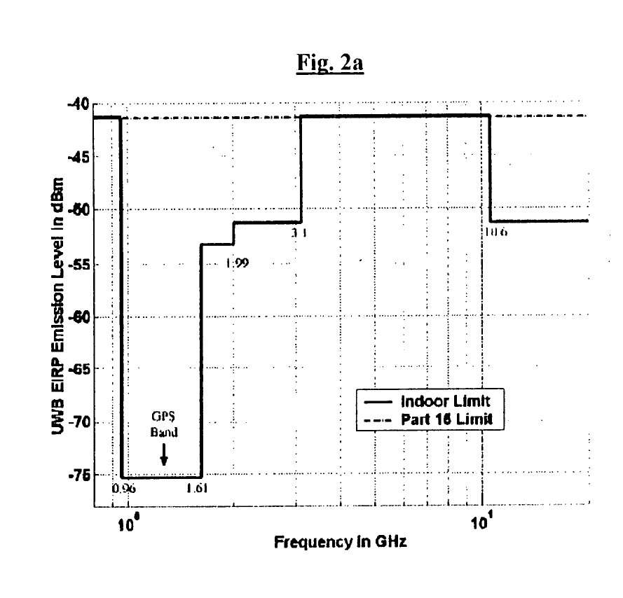

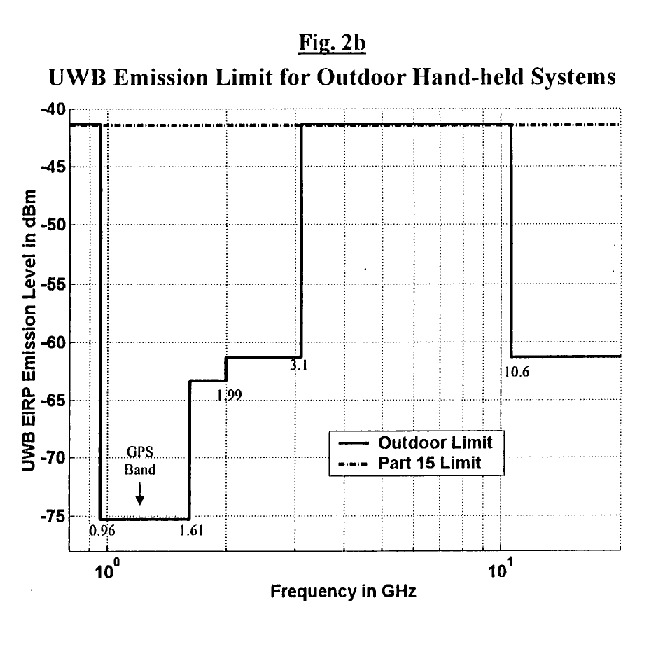

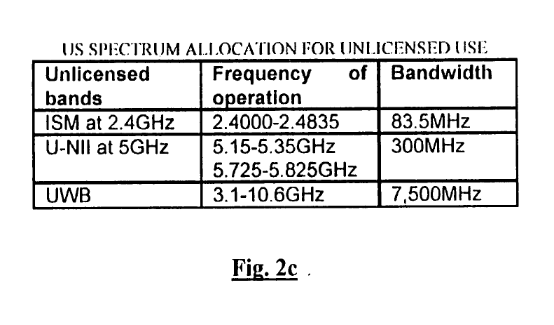

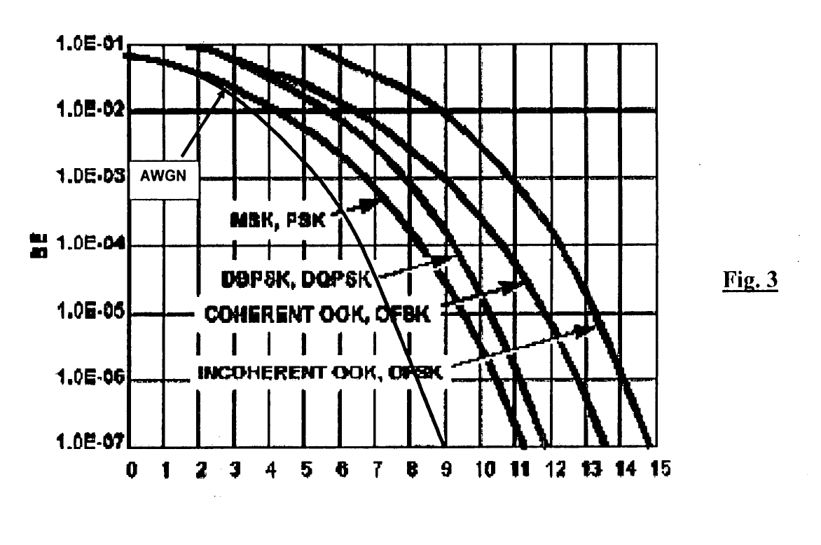

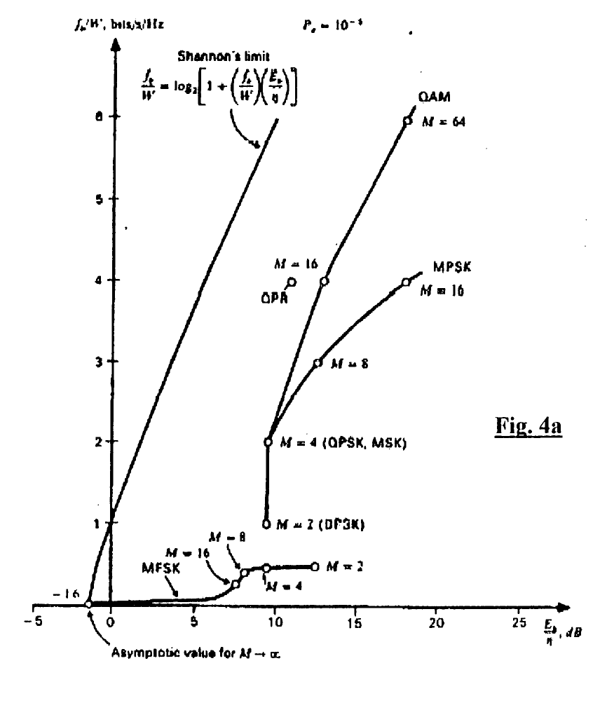

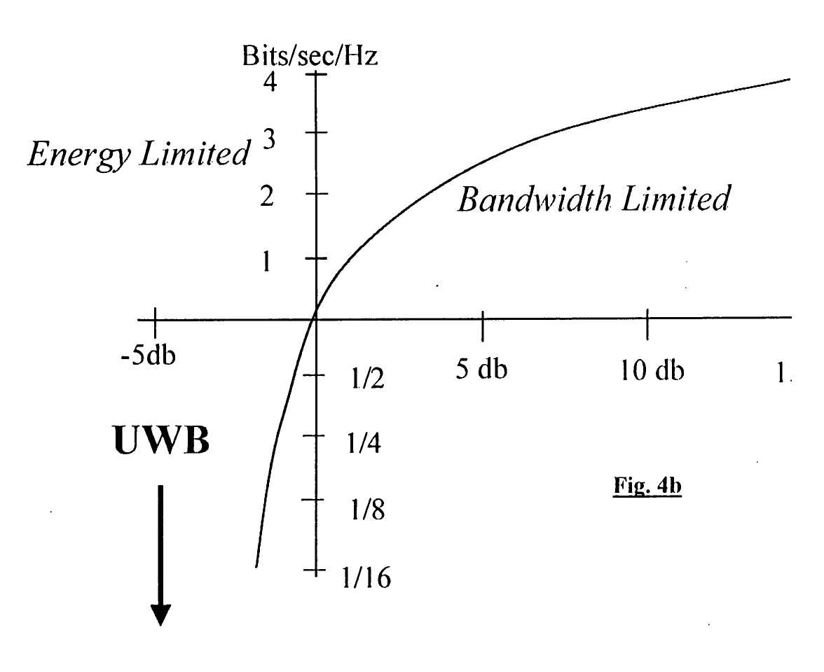

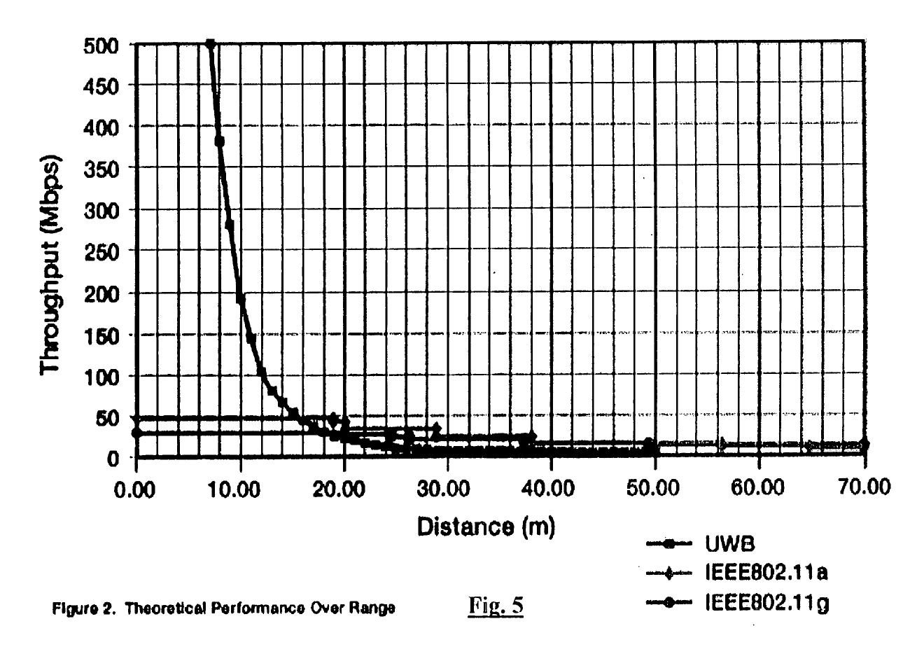

At the FCC-41 dBm/MHz limit (see FCC spectral masks of FIGS. 2a-2c), and the allowed band of 3.1 GHz to 10.6 GHz=7500 MHz, thereby resulting in a radiated power P_{f′}:
P_{f}=10 log₁₀(7500)=38.75 dBm, and
Pₜₒₜ=−41.25+38.75=−2.5 dBm EIRP (bound)
For the exemplary 2 GHz bandwidth (2000 MHz), the FCC limit would equate to:
P_{f}=10 log₁₀(2000)=33.01 dBm, and
Pₜₒₜ=−41.25+33.01=−8.25 dBm EIRP (bound), or 0.15 mW.
Advantageously, the holographic approach of the present invention is believed to have a very low BER as a function of E_{b}/N₀ ratio as compared to many prior art approaches (see FIG. 3); this ostensibly allows the transmitted power to be reduced to achieve the same BER, thereby allowing greater “stealth” for the radiated signal. This improvement in BER for a given E_{b}/N₀ is related in part to the type of spreading and modulation used; specifically, through use of a multiplicative phase-coder; e.g., signal multiplied by e^{iq(t)}, the latter being varied at a high (GHz) rate in comparison to the bit stream. Hence, multiple different phase codes are used to encode each bit (which may be, e.g., BPSK or QPSK modulated, or otherwise), thereby ultimately in effect spreading each bit across various portions of the frequency spectrum after transformation, producing an essentially “white Gaussian” power spectrum. Since the receiver is tuned to receive such a Gaussian power spectrum before inverse transformation, the AWGN profile assumed by the aforementioned propagation and link budget calculations is proportionately less deleterious to the holographic waveform than a typical prior art MSK/PSK-over-heterodyne approach (DSSS or otherwise).

For error-free communication, it is possible to define the capacity which can be supported in an additive white Gaussian noise (AWGN) channel:
f_{b}/W=log₂(1+E_{b}f_{b}/ηW)
where:
f_{b}=Capacity (bits per second)
W=bandwidth of the modulating baseband signal (Hz)
E_{b}=energy per bit
η=noise power density (watts/Hz)
   Accordingly:
E_{b}f_{b}=total signal power
ηW=total noise power
f_{b}/W=bandwidth efficiency (bits per second per Hz)
   FIG. 4b illustrates the Shannon limit for UWB systems. Note that at the assumed bit rate of 100 Mbps, the exemplary system of the present invention, a bit-per-second-per-Hz value of 1E08 bits/sec times (4.899E09)⁻¹=0.020 results.

The phase-coded and transformed holographic approach in effect produces the high degree of signal redundancy realized by the present invention. Hence, the successful transmission and reception of a given bit across the holographic air interface is also higher since it is unaffected by loss of significant amounts (in the temporal domain) of the transformed data stream sent over the interface, due largely to recovery occurring within the receiver. Furthermore, since significant portions of the frequency spectrum can be “blanked” without significant loss of signal recovery capability, the holographic air interface is quite robust in the frequency domain.

Through use of a phase code which varies randomly (or at least pseudo-randomly) across the available phase code space according to, e.g., a Gaussian or other distribution, the modulation of the “full” (i.e., real and imaginary) phase code embodiment has in effect a Gaussian energy density for coded bits (or portions of bits, since the phase code modulation occurs at a rate much higher than the bit or symbol rate). Compare this to a QPSK system (e.g., encoded phase shifts to four constellation points, whether through zero or not) or MSK system (ramps to π/2 or −π/2), wherein a significant phase shift is necessarily imposed on each encoded bit, whether a “0” or “1”. A high degree of envelope variation also occurs within QPSK systems (even using OQPSK or π/4-QPSK which mitigate this variation to some degree). Hence, the random phase code modulator of the present invention in some respects could be considered similar to a super high-speed M-ary phase modulator with “M” comprising an essentially unlimited number of states. As is well known, M-ary schemes are highly bandwidth efficient (see FIG. 4a).

The present holographic approach is also considered to provide improved performance in terms of channel capacity for a given BER as compared to so-called “chaotic” PPM (CPPM), PCTH (Pseudo-Chaotic Time Hopping), DCSK (Differential Chaos Shift Keying), SD-DCSK (Symbolic Dynamics DCSK), CFSK (Chaotic Frequency Shift Keying), or QCSK (Quadrature Chaotic Shift Keying) approaches such as those described in “Comparison of Communications Based on Nonlinear Dynamics to Traditional Techniques”; L. Larson, Winter School Presentation, University of California at San Diego (UCSD), 2003, incorporated herein by reference in its entirety.

Where limited phase code states are used (e.g., the “real” only or “imaginary” only embodiments described elsewhere herein, the modulator phase states are restricted to e.g., two points on the phase constellation.

It is also noted that where the E_{b}/N₀ of the holographic air interface can be reduced for the same BER (such as via filtering, selection of optimized phase codes, etc.), the required transmitter power can be reduced (or range extended). For example, with the assumed 10⁻³ BER used for the illustration above correlating to an E_{b}/N₀ of 6 instead of 10 db (a 4 dB reduction), a C/N of −7 dB is produced (at same assumed 100 Mbps). Hence, C=−81.8 dBm, and PL and PH are reduced to 5.88 mW and 13.18 mW, respectively, for 4 GHz and 6 GHz at 100 m.

Note also that at this E_{b}/N₀ value, the exemplary holographic UWB system can operate at or below the FCC imposed limit of −41.3 dBm/MHz (0.15 mW over 4-6 Ghz) at a range of about 10 meters (outdoor propagation model, conservatively estimated). Note that this model also assumes no rake or diversity antenna system, which may further enhance BER for a given E_{b}/N₀. FIG. 5 below shows the channel capacity versus range for a UWB system versus other prevailing wireless standards, assuming maximum radiated power at the FCC limits. Note UWB's great advantage at lower distances. Hence, where the present invention is operated in a power-limited environment, it can achieve significantly higher channel capacity than non-UWB systems, with much greater covertness than both other prior art UWB and non-UWB systems.

Similarly, if the same range (100 m) is used, but the data rate reduced to 10 Mbps (one-tenth of that previously assumed), then:
P_{L}=−87.8+84.5+5=1.7 dBm=1.48 mW at 4 GHz
P_{H}=−87.8+88+5=5.2 dBm=3.31 mW at 6 GHz
Hence, the allowable BER, required distance, frequency bandwidth, and data rate significantly affect the radiated power requirements of the exemplary system. Accordingly, as described below in greater detail, the radiated power, BER, and other parameters (such as frequency bandwidth) can be traded, such as under software control, to make the system adaptive and achieve varying design objectives under varying conditions or applications, including a mode which meets the current FCC limitations on radiated power spectral density above 960 MHz.

As discussed in greater detail below, a selective front-end filtering approach may also be employed to eliminate or at least mitigate narrower-band interference sources (while not significantly reducing the noise bandwidth B, available to the system), thereby producing a lower interference power (I) and an even greater BER for a given E_{b}/N₀. Since the receiver of the exemplary device is configured to selectively filter certain frequencies for so-called holographic “speckle”, the present invention also optionally provides an adaptive interference suppression module (e.g., algorithm running on receiver baseband or dedicated processor) which configures the receiver filtration to add or migrate different interfering bands. This approach advantageously leverages the aforementioned non-linearity between interfering power I and noise bandwidth B_{w}.

Furthermore, a multi-band UWB approach may be utilized consistent with the invention, wherein two or more bands of the same or different bandwidth (which may also be dynamic, as described below) are allocated to the data stream, such that a lower coding rate within each band can be used. Alternatively, one or more data streams can be allocated to each band (somewhat akin to an OFDM approach); however, the bands of the present invention advantageously need not necessary be orthogonal and can significantly overlap if desired, especially where covertness is desired due to the inherent properties of the mathematical (e.g., Fourier) transform used by the invention. As will be recognized, OFDM may under certain circumstances “paint” bright lines within the RF spectrum which reduce covertness.

As will be appreciated given the following disclosure, two or more holographic UWB bands can be directly overlaid, with different phase codes (and/or frequency offsets) applied to the constituent signals, thereby in effect producing two or more overlaid “white” Gaussian noise spectra which can be readily decoded at the receiver due to their different phase codes/offsets. Unlike the pn or long/decimated long codes of CDMA systems which use period 2⁴¹−1 chips and the specified characteristic polynomial of IS-95A, these phase codes also advantageously need not be orthogonal due to the inherent properties of the hologram and the FFT (or other transform) used to transform the data before transmission.

The antenna 106 may be of literally any type of geometry suitable to provide the necessary frequency response and loss/radiated power profile. In one embodiment, a non-dispersive UWB antenna is used. For example, the non-dispersive UWB antenna of U.S. Pat. No. 6,559,810 to McCorkle issued May 6, 2003 and entitled “Planar ultra wide band antenna with integrated electronics”, incorporated herein by reference in its entirety, may be used consistent with the invention. As is well known, a non-dispersive antenna has a transfer function having a characteristic such that the derivative of phase with respect to frequency is a constant; i.e., it does not change as a function of frequency. For example, a received electric field impulse waveform is presented at the antenna's output terminals as an impulse waveform. This is in contrast to a waveform that is diffused or spread in the time domain because the phase of its Fourier components are permitted to be arbitrary (even though the impulse's power spectrum is maintained). These antennas are useful in most all radio frequency (RF) systems, and have particular application in radio and radar systems that require high spatial resolution, including those where the costs associated with adding inverse filtering components to mitigate the dispersive phase distortion are desired to be mitigated. It will be appreciated, however, that such a dispersive type of antenna system may also be used consistent with the invention if desired, since the phase relationships (i.e., diffusion in the time domain) is not critical with the holographic waveform of at least certain embodiments of the present invention.

In another embodiment, a Skycross Corporation Model SMT-3TO10M UWB antenna system is utilized, although others may be substituted. The Skycross device has a frequency response of 3.1 to 10.0 GHz, with a significant drop in its low return loss between roughly 4 and 6 GHz. As is known, return loss is a measure of the power delivered to the antenna from the input transmission line versus the power reflected back from the antenna, where the power loss is due to the impedance mismatches between the antenna and the input transmission line. The Skycross device is also substantially linear across the frequency range, and provides a gain of 2.5 dBi peak at 5.25 GHz.

In yet another exemplary embodiment, a plurality of discrete antenna elements are disposed in an array or similar phased configuration.

In yet another embodiment, a UWB TEM horn-type antenna of the type well known in the RF arts is used (in conjunction with a balun) in order to provide the physical air interface.

In yet another embodiment, a UWB bicone-type antenna of the type well known in the RF arts is used (in conjunction with a balun) in order to provide the physical air interface.

Additionally, a rake or diversity antenna system may be utilized consistent with the invention to address, inter alia, multipath propagation modalities.

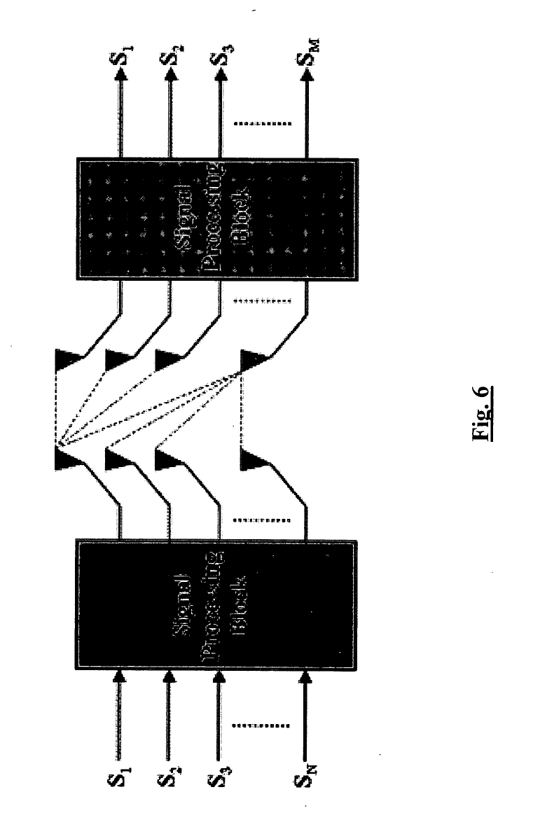

In another embodiment, a MIMO antenna system is utilized. MIMO (Multi-Input Multi-Output) is effectively a type of “smart” antenna system involving both the transmitter and the receiver. MIMO represents space-division multiplexing (SDM); i.e., information signals are multiplexed on spatially separated number (n) of antennas and received on (m) antennas. FIG. 6 shows a block diagram of an exemplary configuration of a MIMO system. It is noted that the present embodiment uses signal-processing on both the transmitter and receiver side, although the invention may also be practiced with the MIMO processing on the receiver side only.

The multiple antennas at both the transmitter (n) and the receiver (m) of the illustrated embodiment of FIG. 6 provide essentially multiple parallel channels that operate simultaneously within the same (or different) frequency bands and contemporaneously. This embodiment results in high spectral efficiencies in a high multi-path environment, since multiple data streams or signals can be transmitted over the channel(s) simultaneously. Hence, the illustrated embodiment combines both frequency domain and “space” domain processing to increase channel efficiency.

It is also recognized that higher power UWB emissions may be required under certain circumstances, such as to increase SNR, reduce BER, or increase stand-off range, and/or improve system signal to noise ratios. Generating a high power UWB signal is more difficult; in addition to the difficulty of creating and handling high RF fields, the available devices for high power amplification are typically somewhat dispersive. The dispersive characteristic of a high power broadband amplifier causes the different spectral components to experience often large phase and amplitude variation as they pass through the amplifier. This can result in distortion of the signals.

In one embodiment, the desired signal of the present invention is generated at low power levels and then amplified in stages using cascaded broadband power amplifiers. While the dispersion attributable to each amplifier is additive, it is generally smaller in magnitude than use of a single amplifier broadband amplifier stage.

In another embodiment, the solution for providing high power UWB signals that are non-dispersive set forth in U.S. Pat. No. 6,512,474 to Pergande issued Jan. 28, 2003 and entitled “Ultra wideband signal source” which is incorporated herein by reference in its entirety, is utilized. Specifically, a plurality of high-power narrow-band amplifiers are utilized to generate the components of the broadband signal, the outputs of the amplifiers combined to form the UWB signal without significant dispersive effect.

The baseband processor 102 of the present embodiment may comprise for example a high speed digital logic array (such as the Xilinx Virtex II FPGA, or Altera APEX and XtremeDSP devices), or alternatively a discrete digital processor (such as a DSP including, for example, a member of the Texas Instruments C6× family, the Agere DSP16000 series, the Motorola MSC 8100 series, Motorola MRC-6011 Reconfigurable Compute Fabric, or others), a RISC processor (such as an ARM-9 core or ARCtangent A5/A6/A7 device), or literally any other digital processor having sufficient MIPS/Dryhstone/MMAC performance to provide the required signal processing (including signal transform) at the desired maximum data rate.

As of the date of this writing, the exemplary Xilinx device with RocketIO™ transceiver technology is capable of data rates up to 10 Gbps, which is more than adequate for the present application; hence, it is selected as the basis of the exemplary embodiment, although other devices as set forth above may clearly be substituted. Appendix II of the parent U.S. provisional application hereto describes an exemplary backplane architecture useful with the transmitter/receiver of the present invention and capable of 10 Gbps “copper” data rates, although others may certainly be used.

As yet another alternative to the foregoing baseband devices, one or more CISC-based processors or microprocessors may be used to provide the required baseband processing, including for example Intel Pentium or Apple/IBM G5 64-bit processor.

The baseband processor 102 of the illustrated embodiment is adapted to perform both the required high-rate (e.g., GHz rate) coding operations and the FFT, DHT, or other transformations (discussed subsequently herein). These operations are performed algorithmically, although they may also be performed partially or even totally in high speed logic or other hardware if desired.

In one embodiment, the baseband data source is unitary in nature, such as for example a unitary bit stream output from an n-rate (e.g., ⅓ rate, ⅔ rate, etc.) vocoder or other digital encoder the type well known in the art, or alternatively another digital bit stream. Such encoders may operate at literally any rate such as, for example, 16 or 64 kbps. The data stream(s) may also converted into another form, such as NRZ (or RZ) bipolar square waves, if desired, wherein a positive part of the square wave corresponds to a binary “one”, while the negative part corresponds to a binary “zero”. Well known Manchester coding techniques can also be used if desired to allow state transitions to be utilized, thereby mitigating dc level drift.

A phase-code modulator algorithm (or separate dedicated modulator device) modulates the data stream to generate either the real or imaginary components of the baseband signal as described in the aforementioned provisional application 60/492,628 previously incorporated herein. For example, in one embodiment, a cosine function is used to modulate according to a binary (e.g., 0 or +pi phase code) only, thereby resulting in a real modulated baseband signal. Alternatively, purely imaginary phase codes can be used to produce an imaginary baseband signal, or combinations of the two may be used. The encoder algorithm encodes the data stream according to the random phase code value stream; i.e., using the multiplier algorithm to encode the data with the randomly or pseudo-randomly selected and constrained real or imaginary phase codes, thereby producing a high code-spread baseband signal within the real and/or imaginary domain. In one exemplary configuration, a pseudo-random algorithm is seeded using an initial value to generate a pseudo-random series of “1s” and “0s” which are then utilized to apply a +pi or −pi phase code to the data stream, to produce a real baseband data stream.

In the illustrated embodiment, the coding rate (i.e., the rate at which the pn or random values are produced) is very high and on the order of the total radiated bandwidth, e.g., in the GHz range, thereby producing a very high code-spread bandwidth. Hence, the comparatively “slow” input data is phase-coded at high rate to produce a high-bandwidth baseband signal.

In one variant, pn sequences are generated with a configurable multi stage (e.g., 16-stage) linear-feedback shift register (LFSR). A WEP approach may also be used, such as where a shared secret key is concatenated with a multi-bit random number to produce a “seed”; this seed is input to a pn generator to generate a keystream. Myriad other approaches to pn sequence generation can also be used.

The coding rate may also be varied if desired in order to control bandwidth, and hence other parameters associated with the signal transmitted over the antenna 106 (as well as parameters associated with the baseband processor(s) or other hardware within the device 100). For example, the coding rate can be varied according to a hop sequence, such as where a fixed number q of coding rates are hopped between by the encoder for finite periods of time which may or may not be constant. These periods of time are, in one variant, selected to be much longer than the period ι associated with the coding rates; i.e., the coding rate changes occur only after a comparatively large number of coding numbers have been generated at the then-current coding rate (aka “slow coding rate hopping”). Various other schemes can be applied to achieve, inter alia, variation or other desired features within the frequency-bandwidth domain (e.g., modulated frequency bandwith as a function of time or other parameter(s)).

As yet another alternative, sliding or slowly varying hop rates can be used. For example, the coding rate can be continuously (linearly or non-linearly), or incrementally (such as in a series of predetermined steps) adjusted downward or upward within a given time interval. This continuous or incremental change need not be (and desirably is not, for covertness) constant in rate or increment. Consider the exemplary embodiment of a burst transmission of data, wherein the coding rate (and hence signal bandwidth) is swept upwards or downwards according to an exponential (e) or other non-linear function. This may be used, inter alia, to defeat jamming, correlation, or disruption attempts.

Similarly, the code rate increments of the transmitter apparatus can also be randomly or pseudo-randomly selected, such as by a second pn generator or algorithm. For example, the code rate may be varied according to a “hopped” sequence (e.g., change a value “b” by n*c Hz per hop, where n=some random number, b=base code rate, and c=a base code rate change in Hz), with the direction of change being selected by the same or a second pn generator. As an simple illustration, where c=0.1 GHz, b=1 GHz, and n=1, 2 . . . j, and the randomized sequence of binary pn values selects an increase or decrease of code rate, a sequence of code rates of 1.1 GHz, 1.3 GHz, 0.8 GHz, 1.00Hz, and so forth might result (i.e., increase (pn=1) n=1 increment, increase (pn=1) n=2 increments, decrease (pn=0) n=5 increments, increase (pn=1) n=2 increments, and so forth). This would have the effect of modulating signal bandwidth in a pseudo-random fashion.

Other types of white noise, random/pseudo-random, or pseudo-noise (pn) processes may be used with the invention as well. For example, as is well known in the mathematical arts, Pseudo Random Binary Sequences (PRBS) are a defined sequence of inputs (±1) that possess correlative properties similar to white noise, but converge in within a give time period. A common type of prior art PRBS sequence generator uses an n-bit shift register with a feedback structure containing modulo-2 adders (i.e., XOR gates) and connected to appropriate taps on the shift register. The generator generates a maximal length binary sequence of length (2ⁿ−1). The maximal length (or “m-sequence”) has nearly random properties that are particularly useful in many applications, and is classed as a pseudo-noise (PN) sequence. Properties of m-sequences include:
(a) “Balance” Property—For each period of the sequence, the number of ‘1’s and ‘0’s differ by at most one. For example in a 63 bit sequence, there are 32 ‘1’s and 31 ‘0’s.
(b) “Run Proportionality” Property—In the sequences of ‘1’s and of ‘0’s in each period, one half the runs of each kind are of length one, one quarter are of length two, one eighth are of length three, and so forth.
(c) “Shift and add” Property—The modulo-2 sum of an m-sequence and any cyclic shift of the same sequence results in a third cyclic shift of the same sequence.
(d) “Correlation” Property—When a full period of the sequence is compared in term-by-term fashion with any cyclic shift of itself, the number of differences is equal to the number of similarities plus one (1).
(e) “Spectral” Properties—The m-sequence is periodic, and therefore the spectrum consists of a sequence of equally-spaced harmonics where the spacing is the reciprocal of the period. With the exception of the dc harmonic, the magnitude of the harmonics are equal. Aside from the spectral lines, the frequency spectrum of a maximum length sequence is similar to that of a random sequence.
   Various of these properties may have particular utility with the present invention (typically where covertness is not required, since many such sequences can produce detectable or “correlatable” artifacts within the signal), such as for frame registration or error correction. For example, where a known PRBS is encoded into a transmitted data stream, the received data can be correlated based on the aforementioned balance or spectral properties using a correlation receiver or algorithm, which performs analysis and correlation on the received data. Similarly, as is well known in the communication arts, the PRBS can be used at the basis of a “transparent” data error metric, such as via looking for parity errors. In the case of the spectral property, the spectrum harmonics can be used to identify error “spurs” or tonals in the frequency domain which can be the subject of error correction filtering within the receiver (i.e, when portions of the transmitted holographic waveform are lost, the presence of a PRBS sequence with known spectral properties can be used to guide selective filtering of non-correlated frequencies).

In one variant, the PRBS can be combined with the baseband (or phase coded) data stream such as, e.g., via a XOR mask repetitively applied to the data. The receiver is synchronized with the mask such that the properties of the PRBS sequence can be exploited for FEC. For example, a missing bit in the stream can be reconstructed at the receiver by evaluating the data for the aforementioned balance property.

In one embodiment, a PRBS sequence of length=7 is implemented (i.e., 1,1,1,−1,−1,1,−1) to modulate the data code rate. Other embodiments of the application incorporate a longer PRBS such as length=15 (i.e., 1, 1, −1 , 1, −1, 1, 1, 1, 1, −1, −1, −1, 1, −1, −1) or length 31 (i.e., 1,1,1,1, −1,1,1,−1,−1, 1, 1, 1, −1, −1, −1, −1, 1, 1, −1, 1, −1, 1, −1, −1, 1, −1, 1) or any other number as desired. Orthogonal PRBS (or other codes) can be assigned to different frames or channels (or even users) if desired as well, although such code orthogonality is in no way required.

Yet other types of codes may be used with the invention including, for example, Gold codes, Walsh codes, Hadamard codes, orthogonal variable spreading factor (OVSF) channelization codes and/or other sequences.

As yet another alternative, the coding rate can be varied as a function of data frame, such that each new frame of data (described below) or aggregation of frames gets one or more randomly or deterministically selected coding rates. These coding rates code the data within the frame according to a pseudo-random or random sequence of real or imaginary phase codes. For example, the aforementioned PRBS or other pn sequence can be used to select the code rate on a frame-by-frame basis (or alternatively, according to a number of frames (f) selected by a second sequence.). Note that this approach is also compatible with a scheme varying frame length or rate, such as where each successive frame (whose length varies according to a first sequence) has its particular code rate selected according to a second sequence. This approach advantageously mitigates creation of “beats” within the coding rate of frames, since the length of each frame is varied as a function of time (or another parameter).

While the baseband processor of the illustrated embodiment includes a fast Fourier transform algorithm or logic adapted to perform (real time) FFTs of the selected frame(s) of baseband phase-coded data for conversion to the frequency domain, it will be appreciated that other types of transforms may be used consistent with the invention including, e.g., Hadamard, Laplace (s), number theoretic (e.g., generalized Fourier Transforms), and Z (z) transforms, the latter being particularly useful for digital frequency representations.

An exemplary alternate embodiment using Hadamard transforms is now described, although it will be appreciated that this configuration is merely exemplary. Unlike the other well-known transforms, such as the DFT and DCT, the elements of the basis vectors of the discrete Hadamard transform (DCT) take only the values +1 and −1. Hence, they are well suited for digital signal processing applications where a high degree of computational simplicity (or speed) is required. As is well known, the basis vectors of the 2ⁿ-point Hadamard transform may be generated by sampling a class of functions known as Walsh functions. Accordingly, the DHT is often called the Walsh-Hadamard transform. The Walsh functions provide a complete ortho-normal basis for square integrable functions. The symmetric form of the 1-D discrete Hadamard transform (DHT) is given by the following:

$$\begin{matrix}X [ k \} = \frac{1}{\sqrt{N}} {\sum }_{n = 0}^{N - 1} x [ n ] {( - 1 )}^{{\sum }_{i = 0}^{m - 1} {b}_{i} [ n ] {b}_{i} [ k ]} , & k = 0 , 1 , … , N - 1 \\ x [ n \} = \frac{1}{\sqrt{N}} {\sum }_{k = 0}^{N - 1} X [ k ] {( - 1 )}^{{\sum }_{i = 0}^{m - 1} {b}_{i} [ n ] {b}_{i} [ k ]} , & n = 0 , 1 , … , N - 1\end{matrix}$$

where N=2^{m} and bᵢ(z) is the i-th bit in the binary representation of z. The addition of the bits bᵢ in the exponent of (−1) is in modulo-2 arithmetic. Note that the forward and inverse Hadamard transforms are identical.

In one exemplary embodiment of the UWB system of the present invention, an Altera Corp. Hadamard transform processor function (IP) is used as the basis for synthesis of a custom Hadamard transform processor, although myriad other HT solutions may be used (whether as a discrete DHT processor, as an extension of the baseband device 102, etc.). This Altera processor function is user-parameterized and can support a wide range of transform lengths and data precision. It can process Hadamard transforms using radix 2, 4, or 8, advantageously allowing for area/performance tradeoffs during design. The function is relatively small; i.e., 250 to 2000 logic elements (LEs), depending on the parameters. It requires an internal memory block generated from embedded array blocks (EABs) or embedded system blocks (ESBs). The address generator and memory block are automatically generated and instantiated by the core top level during design.

It will be recognized that the UWB system of the present invention may also be made “transform” redundant or agile. For example, in one configuration, high-speed logic or baseband processing is provided for both FFT and DHT processing of the input signal data. Where power consumption is not a significant constraint, the system may be operated in “dual” mode, wherein each digital bit stream, such as from the input vocoder, is mirrored to both FFT and DHT baseband devices (FIG. 1a) wherein the mirrored bit streams are phase code modulated as previously described. These can also be hopped according to a pn sequence or other randomized fashion.

As yet another option, the input digital bit stream is multiplexed to the two (or more) different baseband processors/transformers, such as on a 1:1, 2:1, 3:2, or other desired multiplexing ratio. In the simple case of 1:1 multiplexing, each successive consecutive bit of the baseband stream is used to form the two signal bit streams S_{FFT} and S_{DHT}, which are substantially equal half-rate streams. The two streams may be separately phase-code modulated and transmitted (along with any FEC channel coding applied, as desired); however, as can be appreciated, a timing or frame registration mechanism must be provided in the receiver in order to preserve the proper temporal relationships which permit proper interleaving of the data in the receiver baseband processor. Under this scheme, two or more phase-code and/or transform “agnostic” waveforms can be transmitted over separate (or even the same) frequency bands without significant degradation. The use of orthogonal phase codes as between the two modulators may also reduce signal degradation.

The data converter 104 of the illustrated embodiment (FIG. 1) comprises one or more high speed (sampling rate) DAC adapted to convert the baseband digital data (after transformation) into the analog domain for transmission over the antenna(s) 106. A Texas Instruments “flash” DAC, such as the model DAC5686, 16 Bit, 500MSPS CommsDAC, may be utilized for this purpose, as well as any number of other devices with sufficient response.

Similarly, one or more Dallas Semiconductor/Maxim MAX5195 high-speed DACs may be used, such as in a parallel configuration. The MAX5195 is a 14-bit, 260 Msps high-speed digital-to-analog converter (DAC). Its data interface is compatible with high-speed low-voltage positive emitter-coupled logic (LVPECL) signals. Matched-transmission-line capabilities enable the interface to handle very high speed data signals, and its differential digital-signal inputs minimize the effects of noise originating from a printed circuit board (PCB). High-speed FPGAs such as the preferred Xilinx Virtex II series and Altera Apex series have LVPECL-compatible outputs suitable for driving the MAX5195. FIG. 1b illustrates an exemplary driver network for the Virtex device driving the MAX5195. The exemplary network shown in FIG. 1b yields a 100 ohm matched-impedance system; i.e., source, line, and termination, that advantageously maintains high logic-signal fidelity. Because Virtex drivers exhibit very fast transition times, the trace lengths interconnecting the resistor networks should be kept as small as possible (i.e., less than 1 cm or 0.39 inches). Exemplary logic levels at the receiver inputs are in the middle of the LVPECL input range (V_{OH}=2.32V and V_{OL}=1.62V).

Impedance matching and/or balun circuitry (not shown) of the type well known in the art is also optionally utilized in the present embodiment to match the output of the DAC to the antenna system 106, as well as potentially obtain other attendant benefits including noise level reduction. The possible need for impedance matching or baluns is driven by the fact that many UWB sources have a coaxial, or single-ended output, but many antennas, such as TEM horns, require a balanced source. Thus, some sort of matching device or balun is necessary between the source and antenna. Two opposing factors typically determine the size of the balun. The high voltages push the balun to larger sizes, in order to avoid dielectric breakdown. On the other hand, the fast risetimes push the balun to smaller sizes, in order to preserve bandwidth. Thus, a compromise in size is necessary in order to trade off device voltage and bandwidth. Numerous different types of baluns or impedance matching devices may be used consist with the invention, such as without limitation the well known “zipper” balun.

It is also recognized that low-Q systems such as UWB architectures are more sensitive to parasitics, especially in substrate and device pads and wire bonds. As is well known, inductors have intrinsic resistance and self-capacitance; resistors have self-inductance as well as self-capacitance, and capacitors have non-zero resistance and inductance. Normally, these parasitics have a negligible effect on the behavior of a circuit, but are particularly critical in the present technology due to the use of low-Q filtration and other components. Hence, specific care is taken in the illustrated embodiment to minimize such parasitics where possible both at the circuit level and IC logic level.

Referring now to FIG. 1c, an exemplary SoC device 180 incorporating the holographic processing of the present invention is described. This device 180 comprises a device die 181, on which are formed a number of the aforementioned components including the baseband processor(s) 182, data converter 184, filtration 188, and any LN amplification and impedance matching components 189 which may be required.

In one exemplary embodiment, the Texas Instruments BiCom-III SiGe (silicon-germanium) complementary bipolar-CMOS process is used to fabricate the device, although others may be used. This process significantly reduces noise in mixed-signal devices. The dielectrically isolated process provides f_{T}s of 20 and 18 GHz for NPN and PNP devices, respectively. The bipolar device 180 advantageously exhibits low noise, high breakdown voltages, and large βV_{A} products, as well as low parasitics.

In one variant, parasitics are further mitigated using passive or active shielding lines, tied to ground or V_{dd}, or carrying active (Miller effect) signals that either cancel or reinforce coupling. As demonstrated by Himanshu Kaul of the University of Michigan (see, e.g., “Active Shields: A New Approach to Shielding Global Wires”, H. Kaul, et al., GLSVLSI'02, Apr. 18-19, 2002, incorporated herein by reference in its entirety), depending on the geometry of the lines, either capacitive coupling or inductive coupling is the dominant impact on timing. In the case of capacitive coupling, driving the shielding lines in the same direction as the transitions on the signal lines results in significantly lower delay. When the coupling mechanism is primarily inductive, driving the shield lines with the inverse of the signal results in a significant improvement in delay.

In another variant, parasitic reduction may be achieved using the approach of Floyd, et al (IBM Thomas J. Watson Research Center) wherein 15-GHz power amplifiers, low-noise amplifiers (LNAs) and frequency dividers with planar metal dipole antennas, as may be fabricated in a stock 0.18-micron CMOS technology, are used to replace the global clock wiring on the SoC device 180. The antennas comprise 2-mm zigzag dipoles for both transmitter and receiver ends. A 15-GHz oscillator is used to drive a power amplifier, which in turn drives a dipole antenna fabricated in one of the upper metal layers of the chip. Receiver antennas elsewhere on the SoC die pick up the wave from the dipole and relay it to an LNA, which drives an n-to-1 (e.g. 15-to-1) frequency divider, producing a 1.0 GHz clock synchronized to the original 15-GHz signal. At this high frequency, any emissions of the clock signal interface are well outside the band of the primary air interface.

In terms of the design phase, the exemplary device uses a Columbus-AMS/Sequence ExtractionStage which comprises a suite of high-performance design specifically tools tuned for complex multi-million-gate SoCs and analog/mixed-signal design. This suite is particularly useful in its ability to eliminate incorrect interconnect parasitics, thereby increasing reliability. Columbus-AMS automatically generates accurate parasitics within 5 percent of measured silicon.

Myriad other approaches useful in limiting parasitics within the device 180 may be used as well.

The exemplary SoC device 180 is also equipped with one or more processor cores, such as the ARCtangent™ A4/A51A6/A7 processor cores manufactured by ARC International of Elstree, Herts, UK. ARCtangent is a user-customizable 32-bit RISC core for ASIC, system-on-chip (SoC), and FPGA integration. It is synthesizable, configurable, and extendable, thus allowing developers to modify and extend the architecture to better suit specific applications including the HUWB systems disclosed herein. The exemplary ARCtangent microprocessor comprises a 32-bit RISC architecture with a four-stage execution pipeline. The instruction set, register file, condition codes, caches, buses, and other architectural features are user-configurable and extendable. It has a 32×32-bit core register file, which can be doubled if required by the application. Additionally, it is possible to use large number of auxiliary registers (up to 2E32). The functional elements of the core of this processor include the arithmetic logic unit (ALU), register file (e.g., 32×32), program counter (PC), instruction fetch (i-fetch) interface logic, as well as various stage latches. Most notably, the designer of the ARCtangent device can readily add a plurality of extension instructions and hardware, such extensions also comprising customized extensions specifically adapted for FFT, DHT, or other processing. For example, the exemplary enhanced FFT extensions and processing described in U.S. patent application Publication No. 2002/0194236 to Morris entitled “Data Processor with Enhanced Instruction Execution and Method” filed Apr. 18, 2002, incorporated herein by reference in its entirety, may be used in association with one or more of the SoC cores to implement enhanced FFT processing. Myriad other approaches may be used as well.

Advantageously, the ARCtangent processor can be configured with the ARCompact ISA. ARCompact™ is an innovative instruction set architecture (ISA) that allows designers to mix 16 and 32-bit instructions on its 32-bit user-configurable processor. The key benefit of the ISA is the ability to cut memory requirements on the SoC device 180 of the present invention by significant percentages, resulting in lower power consumption and lower cost devices in deeply embedded applications.

The main features of the ARCompact ISA include 32-bit instructions aimed at providing better code density, a set of 16-bit instructions for the most commonly used operations, and freeform mixing of 16- and 32-bit instructions without a mode switch—significant because it reduces the complexity of compiler usage compared to competing mode-switching architectures. The ARCompact instruction set expands the number of custom extension instructions that users can add to the base-case ARCtangent™ M processor instruction set, to include specific or dedicated FFT, DHT, or other functional instructions. The existing processor architecture already allows users to add as many as 69 new instructions to speed up critical routines and algorithms. With the ARCompact ISA, users can add as many as 256 new instructions. Designers can also add new core registers, auxiliary registers, and condition codes.

The ARCompact ISA delivers high density code helping to significantly reduce the memory required for the embedded application, a vital factor for maintaining the die size of the SoC device 180 as small as possible. In addition, by fitting code into a smaller memory area, the processor potentially has to make fewer memory accesses. This can cut power consumption and extend battery life for any portable devices (e.g., wireless handset or other) that the SoC 180 might be used in. Additionally, the new, shorter instructions can improve system throughput by executing in a single clock cycle some operations previously requiring two or more instructions. This can boost application performance without having to run the processor at higher clock frequencies, which is highly desirable for reducing power consumption and parasitics in the chip 180.

The ARCompact ISA is described in greater detail in co-pending PCT Publication No. WO03065165 (WO2003US02834 20030131) entitled “CONFIGURABLE DATA PROCESSOR WITH MULTI-LENGTH INSTRUCTION SET ARCHITECTURE” published Aug. 7, 2003 and PCT filed Jan. 31, 2003, and its U.S. counterpart application publication No. 20030225998 published Dec. 4, 2003 of the same title, both incorporated by reference herein in their entirety.

It will also be appreciated that the FFT or other transforms described herein can be broken into two or more components and processed in parallel, thereby increasing the processing efficiency. This is another particularly advantageous attribute of the transform mathematics. For example, rather than having one processor or logic device conduct the entire transform, two, four, eight, etc. processors can be used in parallel to reduce the peak processing speed required by the device(s). Hence, cheaper, lower-end devices can be utilized in a multi-core array or other configuration to achieve the same performance as one high-end processor. Alternatively a plurality of high-end processors can be used in parallel to raise the upper performance threshold of the system over that attainable with a single core/logic device.

In another exemplary embodiment, a multi-core array processing device is used. Exemplary commercial products of this type include the Motorola MRC6011 Reconfigurable Compute Fabric (RCF). The 24 Giga-MAC MRC6011 is well suited for MIPS-intensive, repetitive tasks (such as transform processing), and offers a resource-efficient solution for computationally intensive applications such as the holographic encoding described herein. The MRC6011 is highly programmable and advantageously provides system-level flexibility and scalability of a programmable DSP while also providing appreciable benefits in terms of cost, power consumption, and processing capability as compared to traditional ASIC-based approaches. Specifically, the MRC6011 is capable of up to 24 Giga-MACS (16-bit) at 250 MHz, and up to 48 4-bit Giga complex correlations (CC) per second at 250 MHz (0.13 micron process). It uses a scalable architecture of three RCF modules having 16 reconfigurable processing units that is rapidly reconfigured under software control. It can also process block interleaved Multiplexed Data Input (MDI) data, and has power consumption typically less than 3 W.

In another exemplary configuration (FIG. 1d), the apparatus 120 further comprises and impedance matching device 122 and a power amplifier 121 disposed between the converter 124 and the antenna 126. In the illustrated embodiment, the power amplifier comprises a Texas Instruments THS4302 BiCom III device, although others may be used (such as the Xtreme Spectrum Trinity XSS1102 low-noise UWB amplifier). A band-pass filter 128 (e.g., approximately 4-6 GHz in the exemplary embodiment) is also optionally provided to constrain the antenna output to the desired range, although other mechanisms may be used for constraining antenna frequency bandwidth, including without limitation design of the antenna such that its frequency response is substantially limited to the desired band.

In another exemplary configuration (FIG. 1e), the apparatus 130 comprises a plurality of baseband processors 132a, 132b, 132c, 132d disposed in substantial parallel configuration. This may be accomplished using discrete devices, or alternatively via an SoC device or “DSP farm” such as the Motorola MSC 8100 series Starcore DSPs. This configuration allows for significantly enhanced parallel processing speed for, inter alia, high speed real-time signal processing.

In another exemplary configuration (FIG. 1f), the output of the baseband processor(s) 142 is buffered using a high speed FIFO buffer 147 and associated clocking 148. This arrangement allows the device the ability to (i) selectively interrupt or control the transmission of data, such as where only bursty communications are desired to maintain covertness, (ii) use a lower capacity baseband processor which need not be able to perform the required signal processing in real time, and/or (iii) to conserve power in battery-limited devices.

Hence, in one exemplary configuration, a “burst mode” is provided wherein a plurality of input data is received at the processor 142, processed, and stored in the FIFO 147 (e.g., in the form of digital I and Q data). This input data may comprise voice data, video data, or other data such as location or GPS information, identification information, etc. The accumulated data within the FIFO 147 is then clocked out selectively as desired under baseband or other processor control. With a data “accumulation” rate of X bps and a FIFO size of M*8 bits (M=No. of bytes of available storage), the maximum clock-out interval (sec.) is (M*8)/X. This assumes a clock-out rate which exceeds the data accumulation rate, thereby precluding the FIFO from overflowing and losing data. Other buffering schemes may be implemented as well consistent with the invention, such other schemes being readily implemented by those of ordinary skill provided the present disclosure.

Furthermore, it will be appreciated that such buffering of data may be conducted in a variable or even deterministic fashion. For example, in one variant, variable size frames of data as discussed above are clocked through the FIFO, thereby avoiding any sort of constant rate or parametric signature. By utilizing variable length data structures within the FIFO or other buffering mechanism, more regular patterns potentially evident in the signal transform (and hence put out over the antenna 106) are mitigated.

To this end, a dynamically variable FIFO or other buffer structure may also be utilized. For example, a “virtual” buffer may be used, wherein the accessible size of the buffer device is varied as a function of time or another parameter (such as a pn code). In this fashion, the “software” size of the buffer as perceived by the coder is varied, while the physical capacity remains constant. The data rate (and/or frame size) can be varied independently or as a function of the virtual buffer capacity, thereby providing a constantly changing data rate through the buffer. Consider the simple case of where the data (e.g., encoding) rate is made proportional to the virtual buffer size, the latter being related to a pn or other varying sequence. The data encoder will constantly be changing its encoding rate based on feedback from the virtual buffer algorithm.

It will also be appreciated that a time index or synchronized clocking can be readily provided to the system(s) described herein using any number of different mechanisms. For example, in one exemplary embodiment, a high-precision external source (such as that associated with the Global Positioning System) is fed to both transmitter and receiver, each being adapted to determine its own absolute reference therefrom, in effect synchronizing the two devices. Ideally, the accuracy should be at least as good as the frame duration (e.g., 1 ms, 1 us, 1 ns, etc.). Transmission epochs, code sequences, hopping patterns, etc. may all be determined by an accurate local or TOD reference. For example, every frame may be transmitted at a given epoch (such as on the “second” mark). The receiver accordingly is adapted to start digitizing on the second mark, plus an estimate of transit delay. Knowing which millisecond in the day we are in determines code sequences, hopping frequencies, etc.

In another variant, intrinsic clocking can be used so as to maintain a high degree of covertness, yet release the system from the requirement of an external clock source or-time reference. For example, one or a series of clock reference signals are transmitted within the data in order to provide a time reference to the receiver. In one configuration, the transmitter sends out a “beacon” frame to announce its presence to the receiver. The beacon frame has a timestamp along with a synchronization field (e.g., n bits of alternating zero-one sequence, PRBS sequence, etc.). The timestamp field gives the transmitter's absolute (or relative) clock value; the receiver accepts the timestamp and adds a small predetermined or dynamically determined offset value for transmission delay, and subsequently, adjusts its own clock to coincide with the transmitter, hence synchronization is achieved. Note that the receiver clock adjustment can be dynamic; e.g., the time offset or skew can be varied over one or more subsequent frames until the optimal value is achieved, and can similarly be periodically re-evaluated and corrected. Beacon frames can also be randomly mixed in the signal data and identified from other data such as via the unique patter or properties associated with their synchronization field. It will be noted that the “beacon” signal is not a true beacon; i.e., the transmitter is not transmitted a periodic signal which is readily detected by a correlation or other receiver.

Alternatively, multiple frames (successive or otherwise) can be used in effect as a large beacon or marker. For example, the transmission of four consecutive frames each with PRBS sequences of 7 bits may be used to signal that the next frame contains time stamp information from the transmitter.

Once T/R synchronization is achieved, a seeded pn generator algorithm such as that described previously herein may be used for the various facets of T/R operation which require synchronization (e.g., phase code generation, etc.). Note that the internal clocks of the T/R, if sufficiently accurate, can also maintain synchronization from that point forward.

Real and Complex Signal Variant

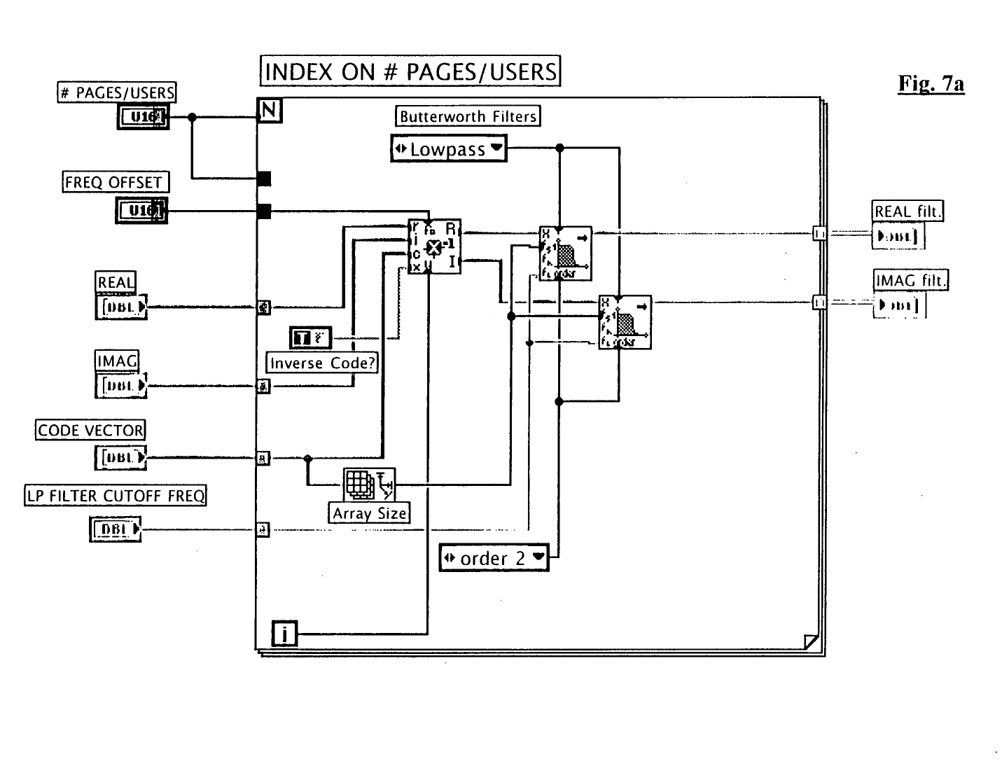

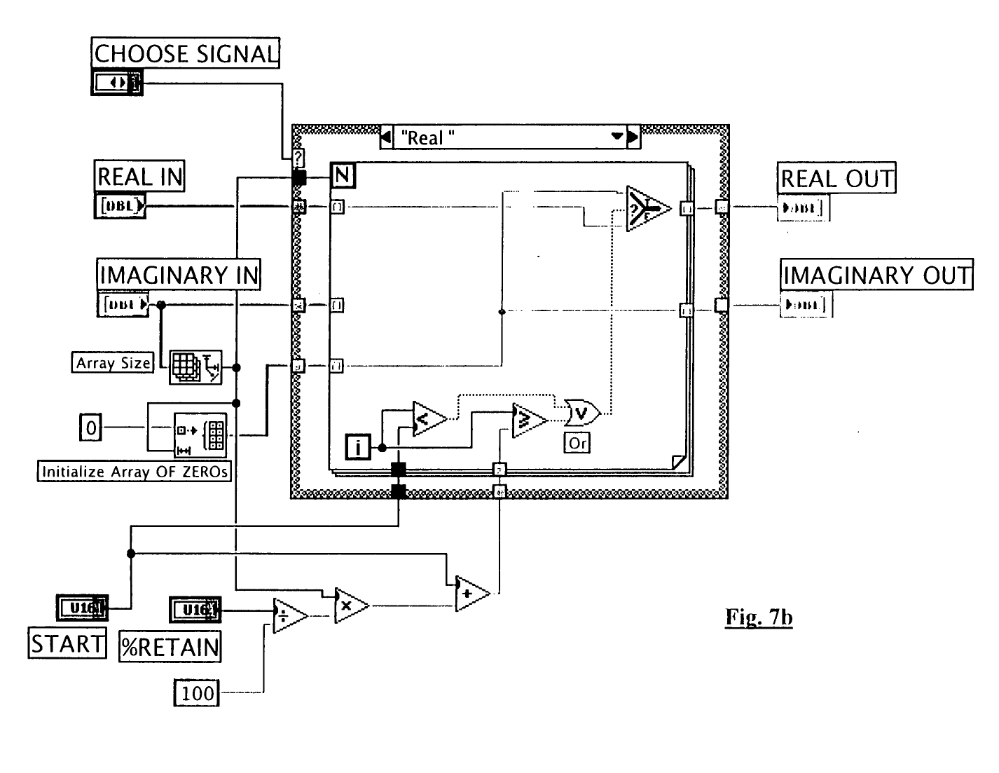

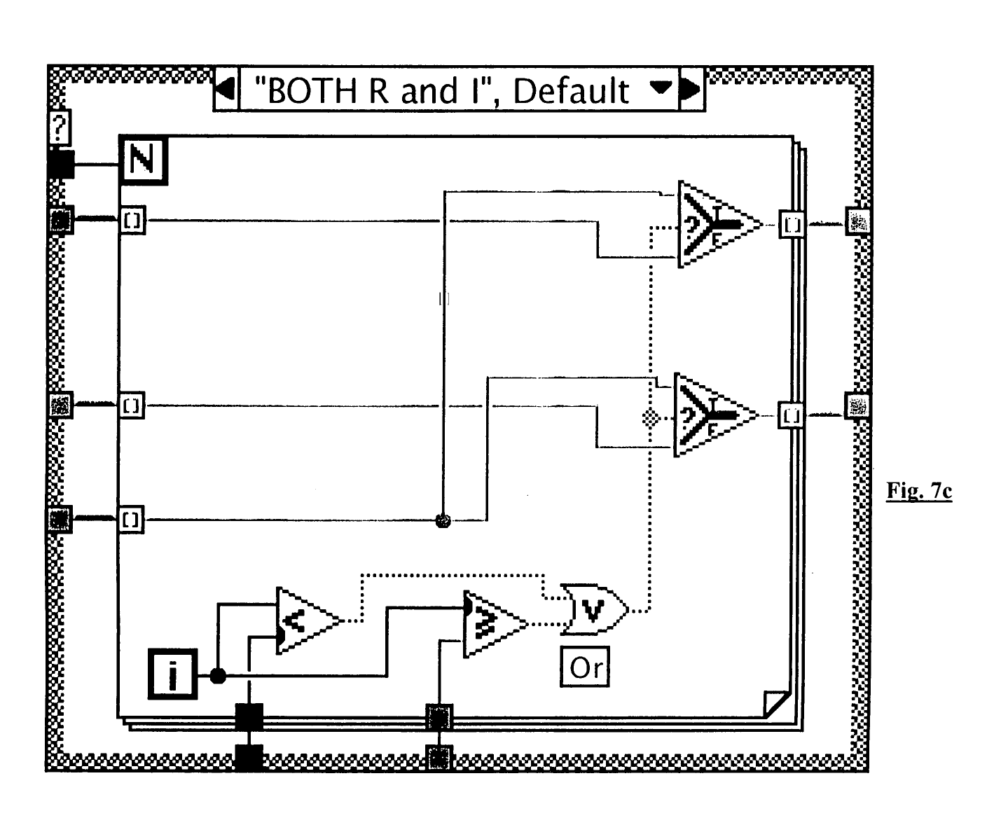

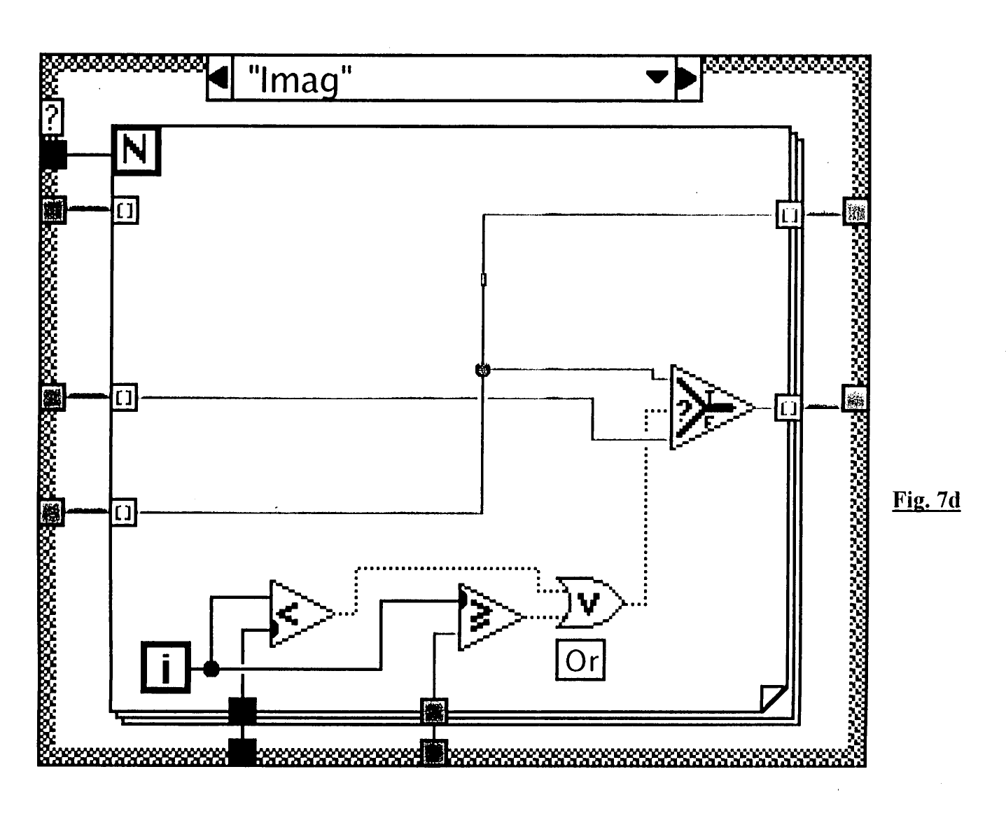

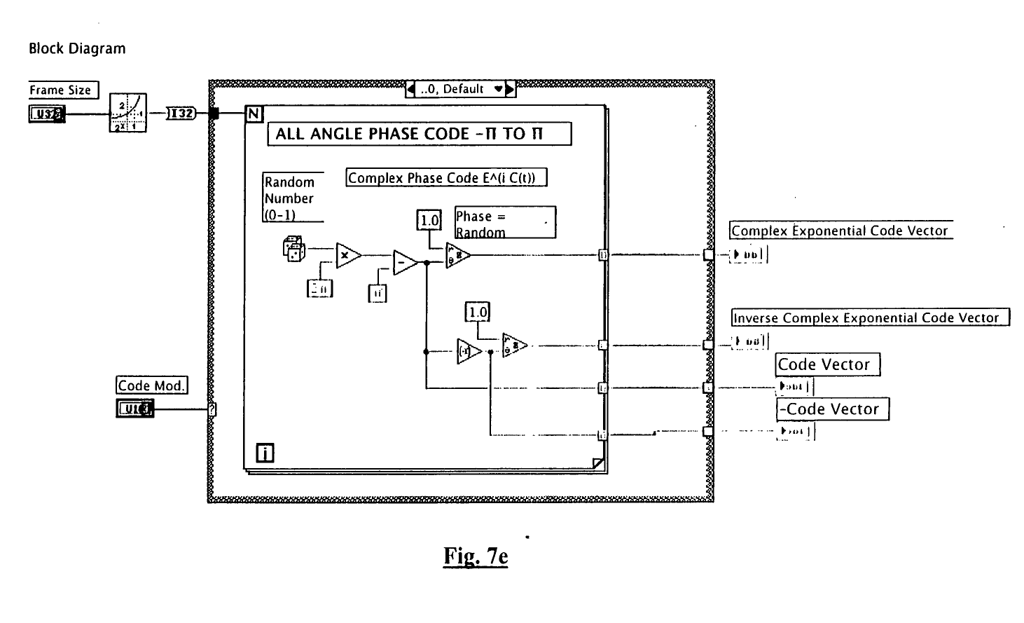

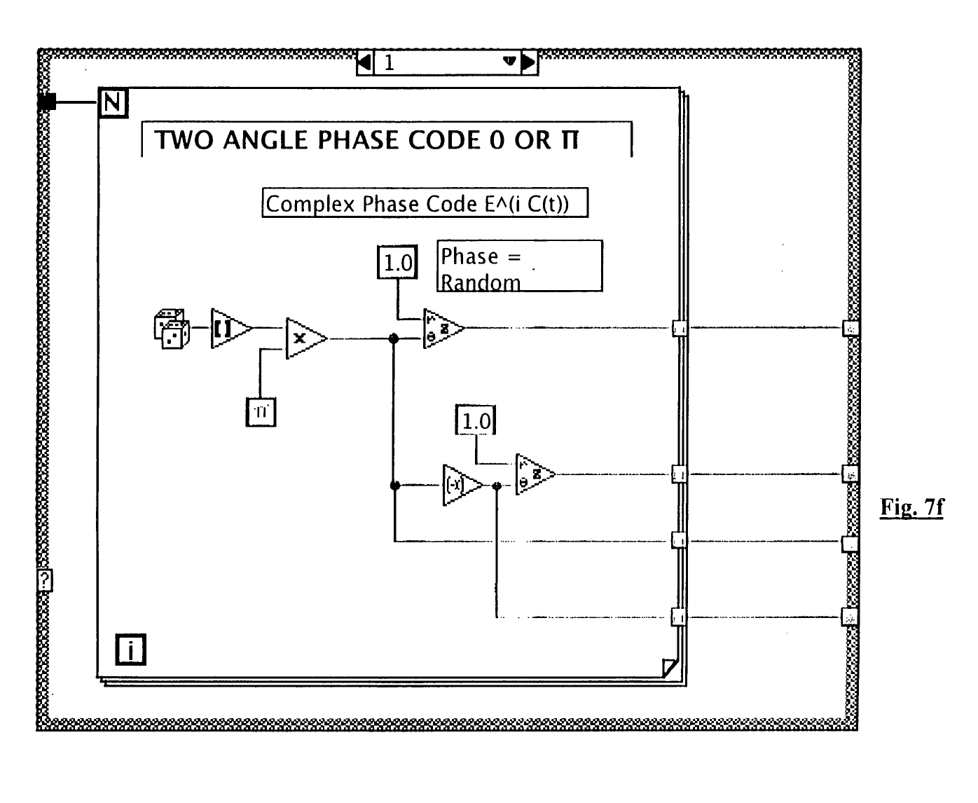

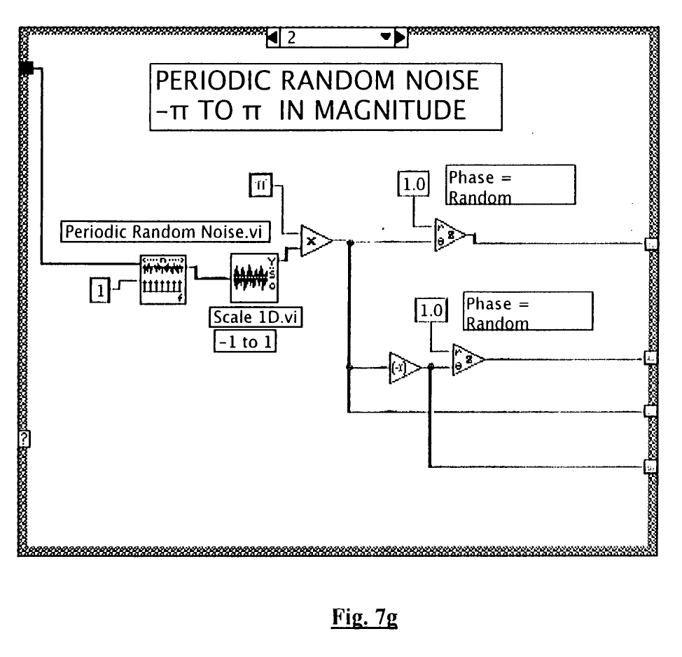

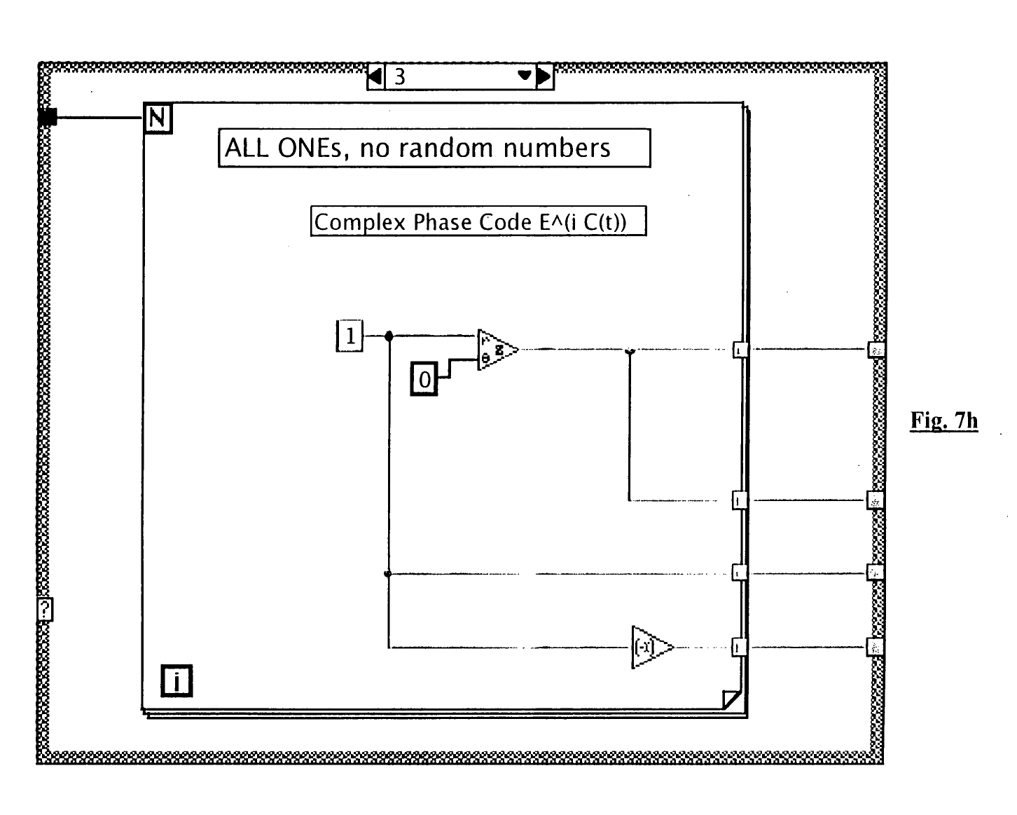

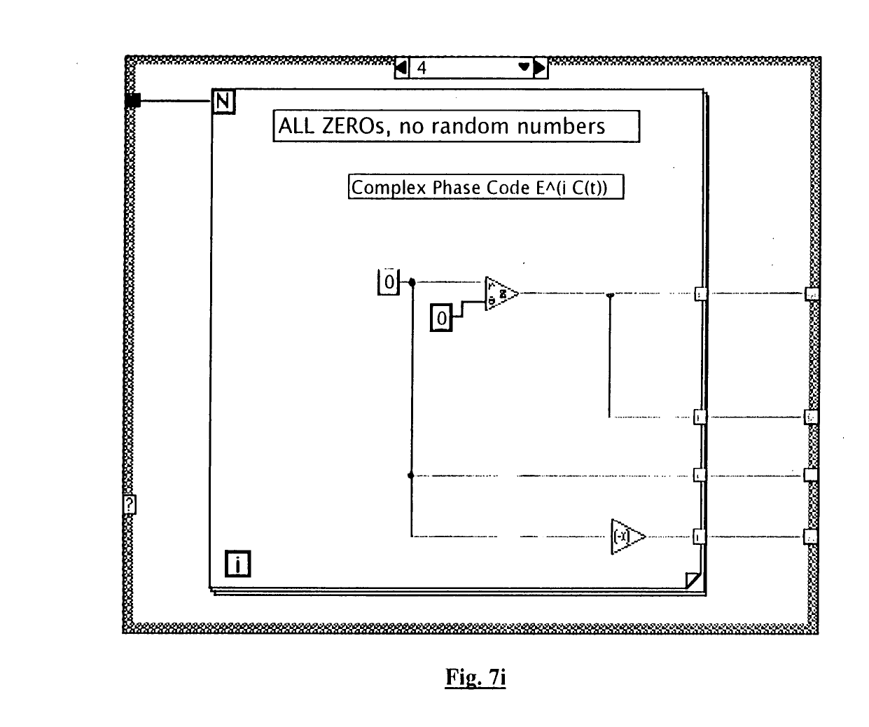

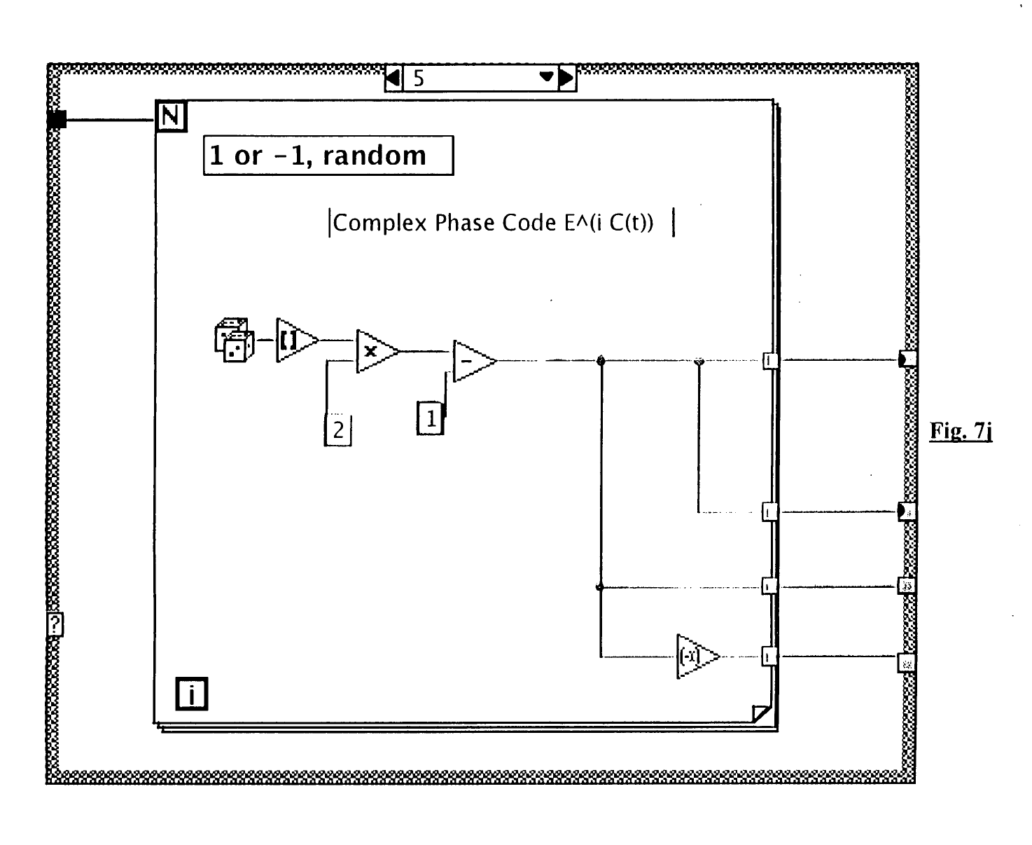

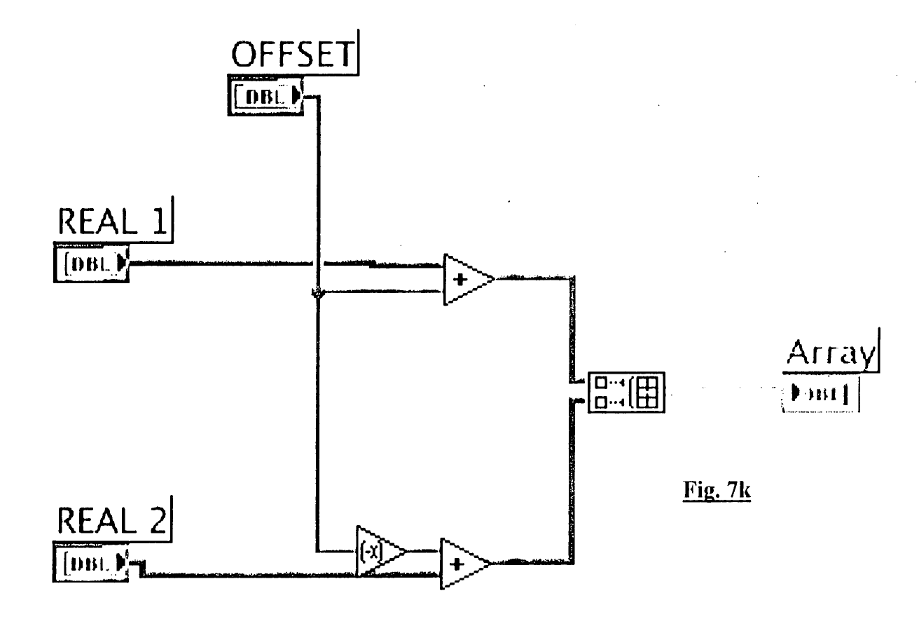

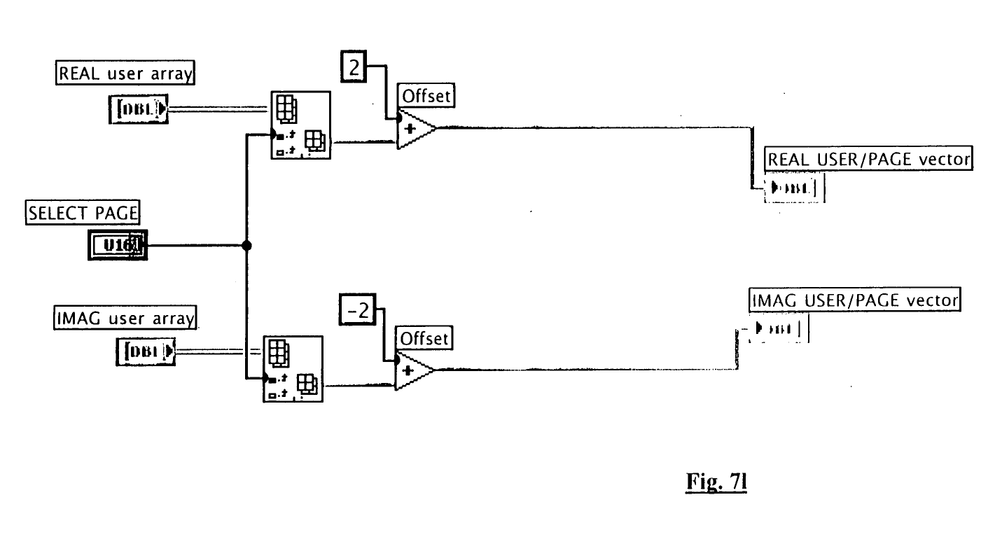

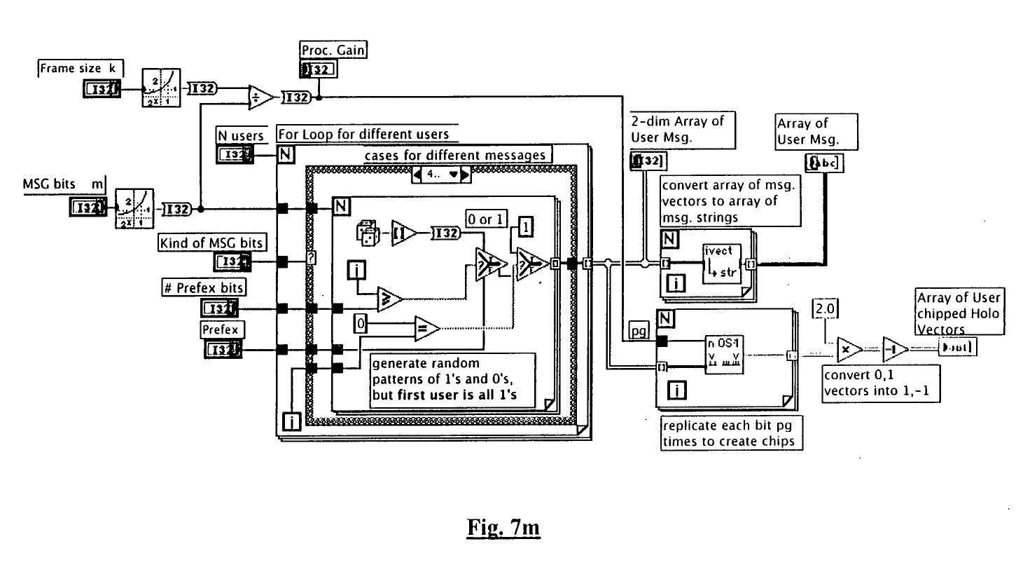

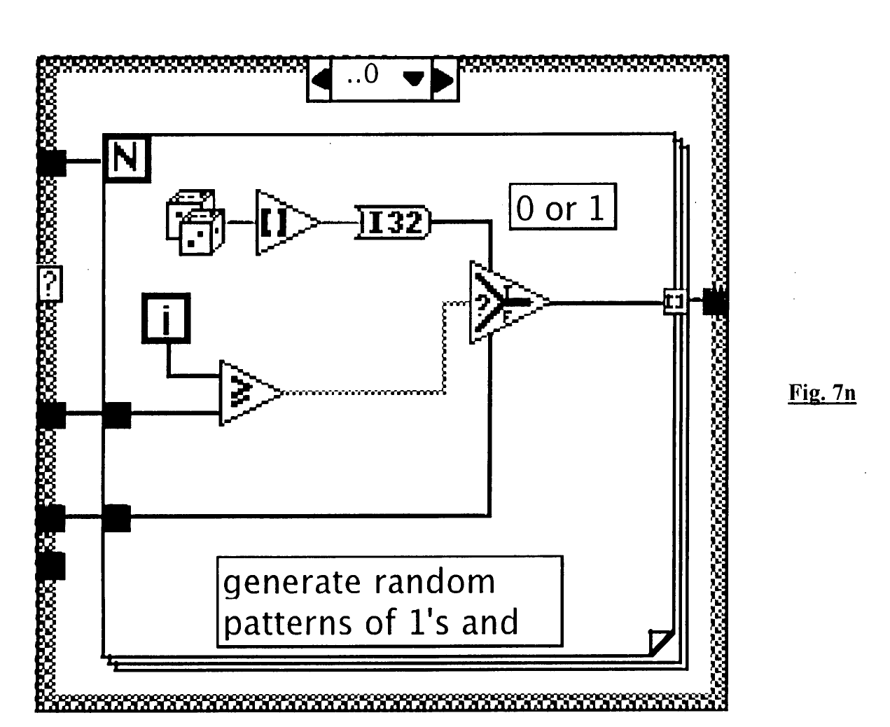

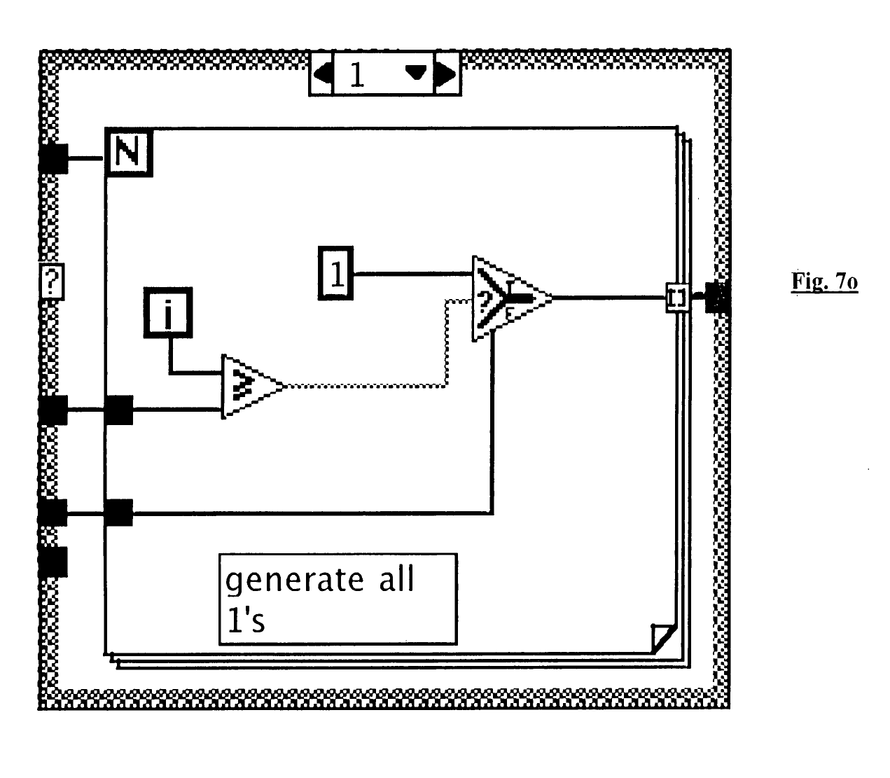

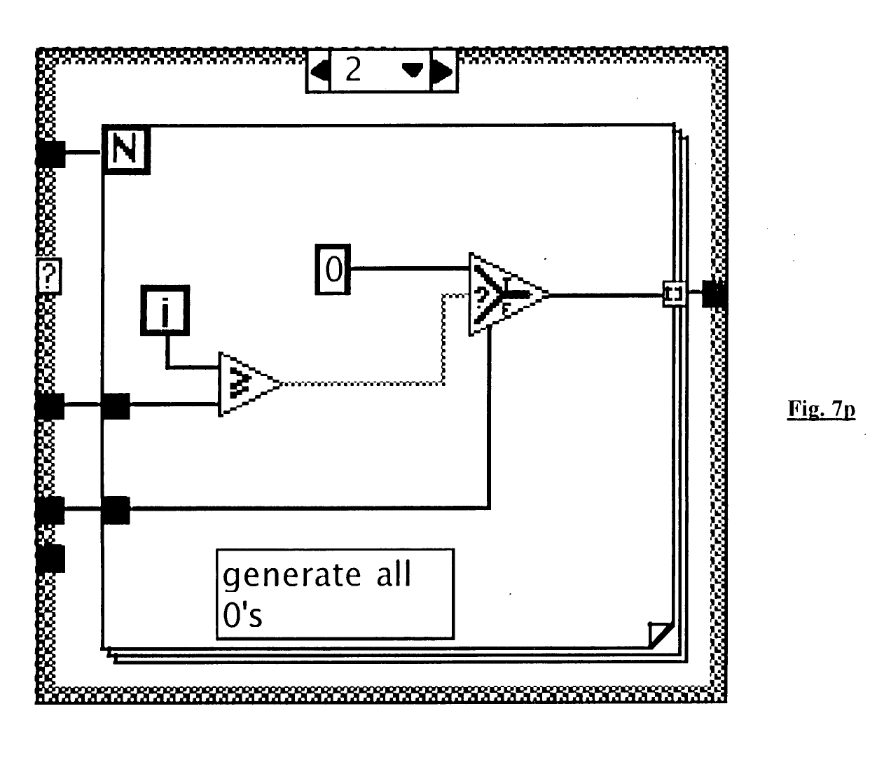

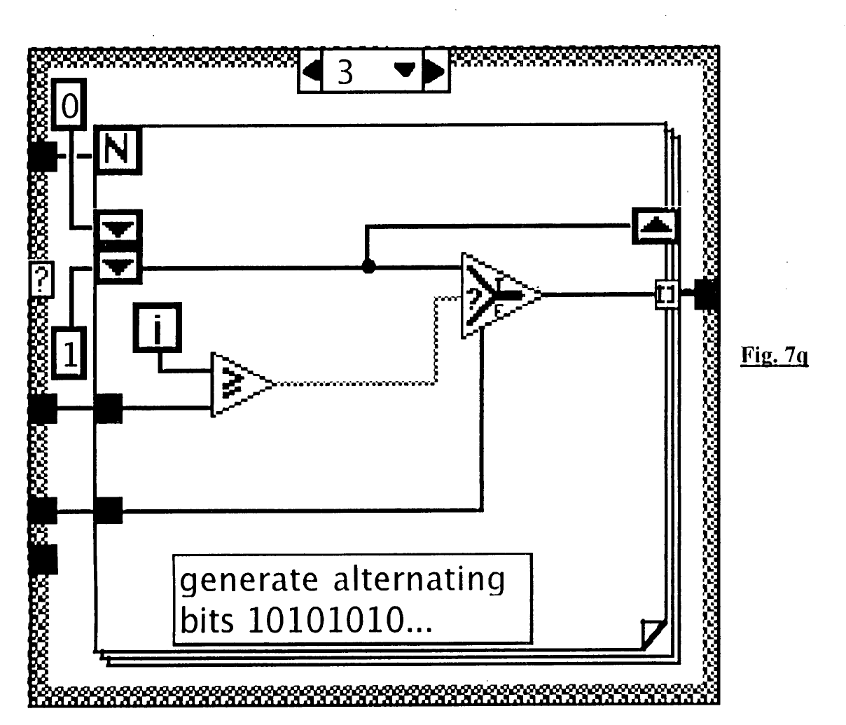

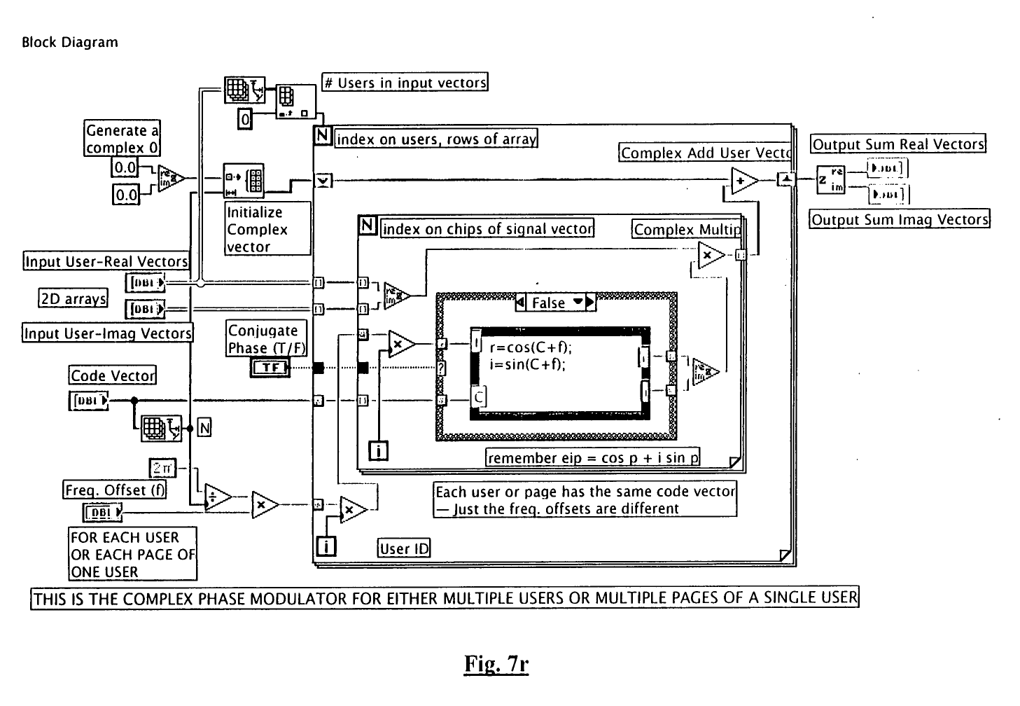

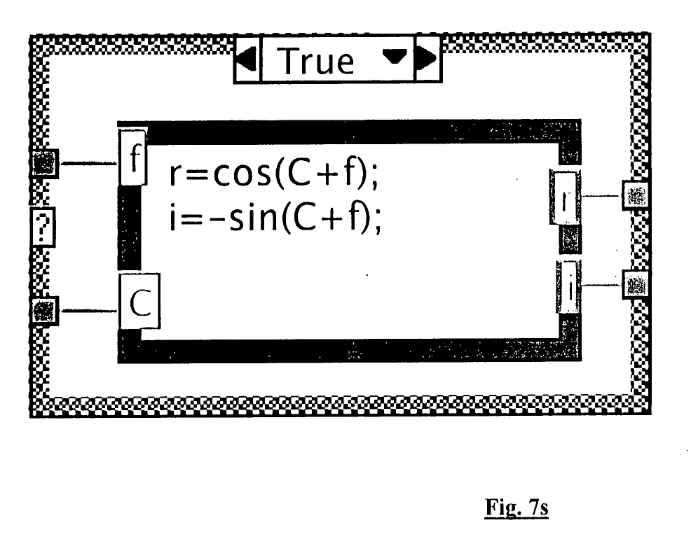

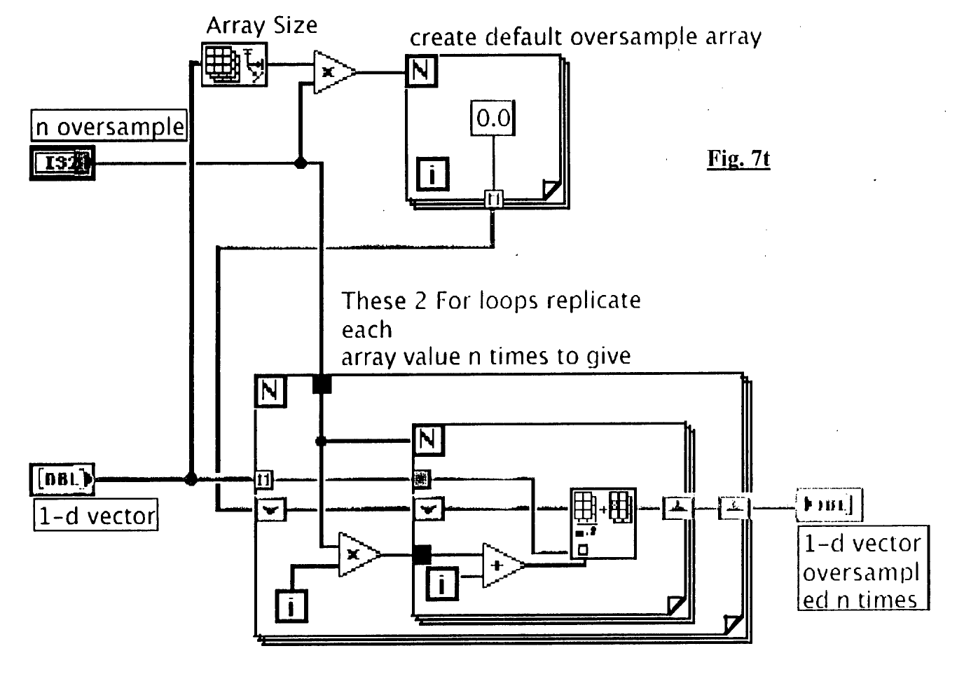

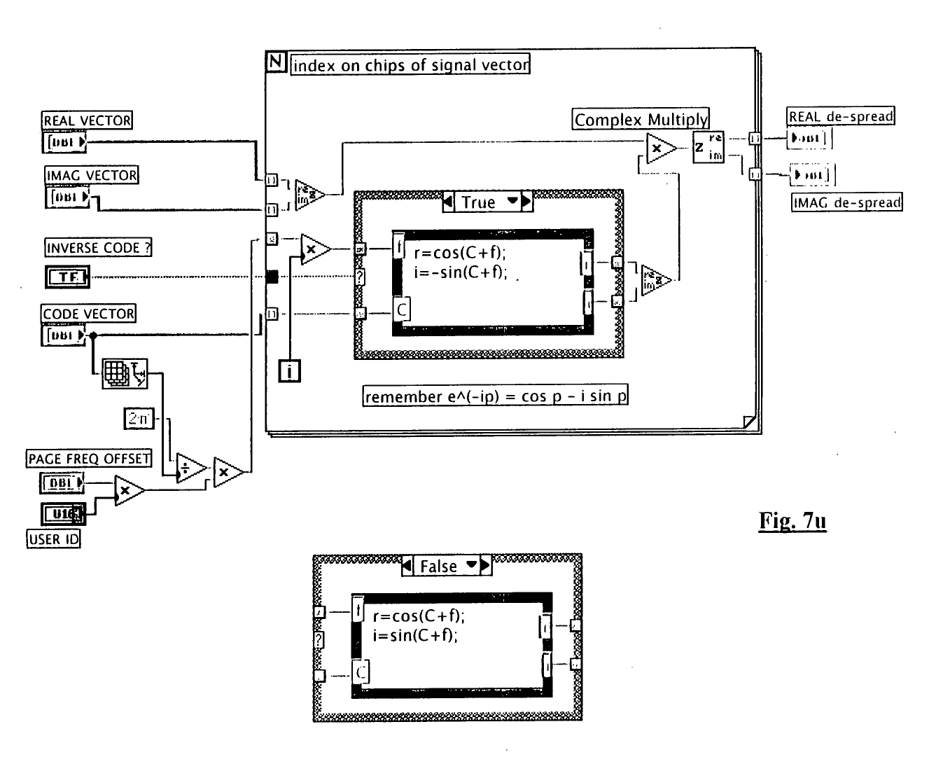

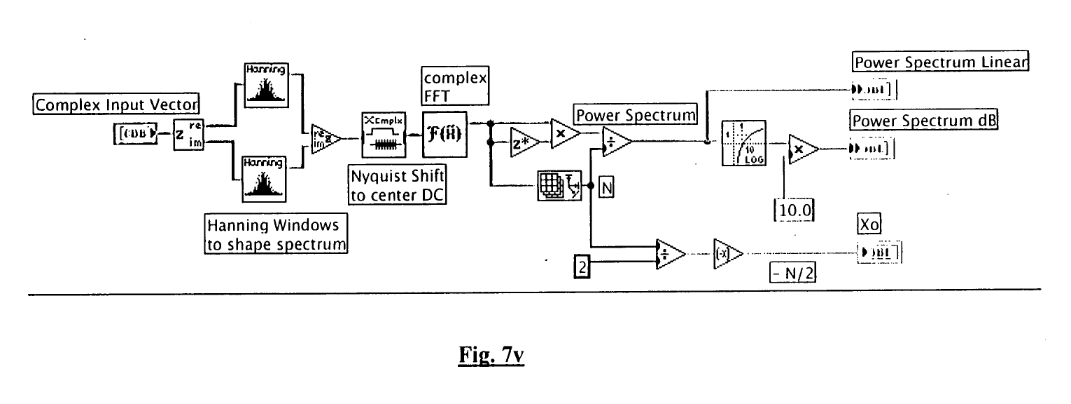

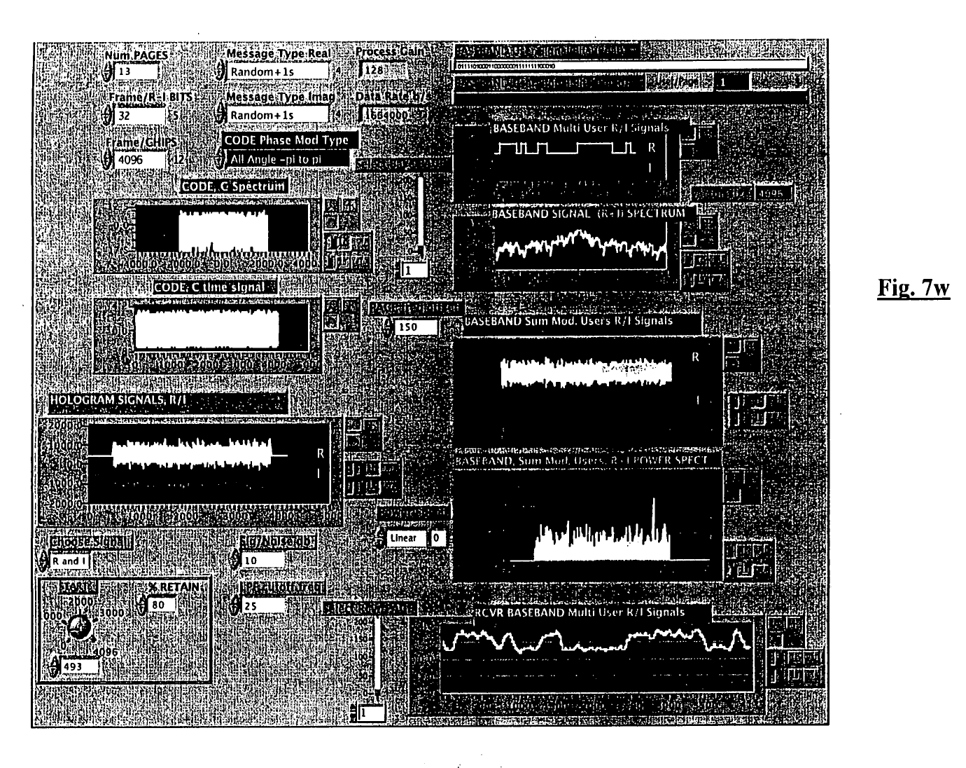

In another exemplary embodiment of the invention (FIGS. 7a-7x), two or more streams of the signal data, which may represent either components of one logical channel, or multiple logical channels of data, are utilized to form real and complex phase-coded signals, somewhat akin to that described in the aforementioned '480 Patent. The two components of the complex signal X(t) (where X(t)=Xᵣ(t)+iXᵢ(t)) are modulated by an encoder algorithm running on the baseband processor 102 (or even multiple processors).

In one exemplary configuration, the signals are modulated within the encoder by a pseudo-random code signal e^{iq(t)}. The properties provided by the pseudo-noise or random signal (such as covertness) may not be required or even desired in all applications, but is shown in the illustrated embodiment. Furthermore, it will be appreciated that other types of modulation sequences can be used, such as those obtained from other types of algorithms or mathematical formulas. The encoder algorithm is represented as a multiplier function and has a time dependent output which is the complex product signal M(t), where M(t)=X(t) e^{iq(t)}. In the illustrated embodiment, q(t) is a time dependent series of pseudo-noise (pn) or random numbers having unconstrained values between −pi and +pi (or alternatively other offsets, such as for example −pi/2 and +pi/2. These random or pn values may be uniformly distributed within value-space, or alternatively distributed according to any number of schemes such as, for example, normal or Gaussian distribution (e.g., the distribution of phase codes has Gaussian mean peaks at −pi/2 and +pi/2), binomial or multinomial distribution, Exponential distribution, Poisson distribution, etc. Myriad different schemes and distributions are possible.

In the exemplary embodiment, M(t) is therefore a series of pseudo-random or random numbers having a zero-mean and uniform amplitude distribution (or other amplitude distribution if desired). The frequency bandwidth of M(t) (“code spread bandwidth”) is many times the bandwidth of the signal X(t) and depends substantially upon the rate at which the pseudo-noise or random numbers are produced, i.e., the greater the rate, the greater the bandwidth. The various schemes for providing variable code rate previously described herein may also be readily applied to the present embodiment if desired.

The data or information sources are typically in the form of a lower frequency series of digital data or pulses provided over a period of time called a frame. The length (duration) of the frames may be varied as required in order to optimize the application and the transmission of the data from the data source(s). In one embodiment, the frames are of constant duration (e.g., 1 msec) and are produced consecutively. As yet another alternative, the frames may be generated according to a prescribed higher layer protocol with intrinsic framing capabilities (and associated framing device or processor), thereby alleviating the baseband processor from having to perform framing activities. Note that this higher layer framing may also be encapsulated within the framing of the “physical” layer (i.e., that provided by the baseband processor 102 herein), in effect generating complex frame structures, such as for example a frame-within-a-frame or similar.

The frames may also be generated in varying duration and even varying inter-frame spacing if desired, such as through use of a packetizer algorithm within the baseband processor 102 which frames-up the data stream with constant or non-constant frame size, and with varying amounts of jitter in the time domain. For example, an inter-frame “jitter” specification may be used to allow variable jitter or timing between frames within prescribed limits. While generated at higher layers, packetized higher layer protocols such as MPEG2-over-IP applications may also be supported, such as where an 802.3/IP/UDP wrapper is utilized to encapsulate a plurality of MPEG 188 byte media packets (and other overhead such as CRC, header, etc.) within a larger frame (see FIG. 1g).

Especially in covert applications, it may be desirable to jitter or vary the frame duration (such as according to a pn sequence or other mechanism) so as to avoid any “beats” or other potentially discoverable artifacts within the radiated signal. Furthermore, since the FFT processing of the illustrated embodiment is conducted on a frame basis (i.e., one or more whole frames are used as the basis for each sequential FFT transform calculation), more or less of the baseband data stream may be transmitted per unit time when the frame duration or length is varied.

A high-speed transport stream multiplexer algorithm (or dedicated hardware) may also be used to multiplex other information into the packet (frame) stream, akin to existing prior art DVB/MHP or MPEG2 systems, wherein inter alia SI packets are disposed within the stream (See FIG. 1h). For example, in the present context, two or more contemporaneous data streams may be multiplexed by the baseband processor (or other multiplexer device), the two streams being demultiplexed from the received signal at the receiver using similar hardware. Additionally, the order of frames may be convolved or permuted as desired.

Frame “packing” or stuffing may also be utilized consistent with the system 100. In such a variant, a constant or variable frame size is generated (either within the baseband processor 102 or a higher layer entity), and the frames stuffed up to capacity before transform and subsequent transmission. One embodiment uses a constant frame size; this approach maintains a constant frame size and frame rate, thereby in effect generating a somewhat unchanging signal emission in both the time and frequency domains. This can be desirable from a covertness perspective, since changes or variations in the time and frequency domains are minimized (i.e., even when subsequently transformed into the frequency domain, some discernable artifacts may be present if non-stuffed frames of baseband data are used or alternatively transients associated with starting/stopping transmission exist). Myriad other schemes for frame stuffing or padding can be used, including without limitation constant overhead byte stuffing (COBS), zero-bit stuffing, etc.

Where the source or input data rate is insufficient to stuff the bits, such as where a non-continuous data source is utilized, either the coding rate may be adjusted (such as via a coding rate control algorithm which calculates the required coding rate necessary to maintain proper frame stuffing), and/or the data buffered (such as in a FIFO or comparable mechanism). Additionally, “stuff data” can be spontaneously generated and inserted into the frame structure as necessary to avoid use of variable code rates or buffering. For example, where frame stuffing is required, the control algorithm for the encoder can generate, via the baseband processor or other source, packets of faux data (such as randomized strings of PRBS or pn data) which are inserted into the frame structure. This faux data can then be removed at the receiver, such as via contemporaneous insertion of one or more “stuff identifiers” within the frame structure to identify stuff packets or bytes. As a simple illustration, consider a frame comprising 215 bytes of data, wherein 212 bytes (53×4) comprise “payload” data. This example is predicated upon a 53-byte asynchronous transfer mode (ATM) packet having 48 bytes of payload data and 5 bytes of overhead of the type well known in the art, although clearly the invention is not so limited. Hence, the remaining three (3) bytes (215 minus 212) are available for frame (versus cell) overhead. This frame overhead can include specification of various parameters such as flags for the presence of “stuff” cells, and one or more (e.g., two) bits to identify the location of the stuff cell(s). As a simple example, 100=stuff in slot 1 of frame, 101=stuff in slot two, and so forth, with 0xx indicating no stuff in any slot. Myriad different encoding schemes are possible and will be readily appreciated by those of ordinary skill given the present disclosure.

When the receiver reads the received frame, it checks for a “1” in the frame stuff flag field, and if present, analyzes the two subsequent bits to determine the location of the stuff cell(s), which are subsequently removed and discarded before subsequent processing.

Frame interleaving may also be used, wherein data from two or more streams (or convolved data from the same stream) is selectively interleaved together to form an interleaved stream. Interleaving may occur at the frame level, and or at the code/symbol data level. Various interleaver schemes (such as so-called “natural order” interleavers, and those implementing interleaving via a pn or comparable sequence) may be used consistent with the invention either alone or in combination. For example, a pseudo-random constant-relationship interleaver generally akin to that described in U.S. patent application Ser. No. 20020029364 to Edmonston, et al. published Mar. 7, 2002 and entitled “System and method for high speed processing of turbo codes”, incorporated herein by reference in its entirety, may be used consistent with the present invention. It will also be appreciated that traditional Turbo coding may be used consistent with the invention, such as that described in U.S. Pat. No. U.S. Pat. No. 5,446,747 to Berrou issued Aug. 29, 1995 entitled “Error-correction coding method with at least two systematic convolutional codings in parallel, corresponding iterative decoding method, decoding module and decoder” incorporated herein by reference in its entirety, which discloses an error-correction method for the coding of source digital data elements to be transmitted or broadcast, notably in the presence of high transmission noise. The Berrou (Turbo code) method comprises at least two independent steps of systematic convolutional coding, each of the coding steps taking account of all of the source data elements, at least one step for the temporal interleaving of the source data elements, modifying the order in which the source data elements are taken into account for each of the coding steps, and a corresponding iterative decoding method that, at each iteration, obtains an intermediate data element through the combination of the received data element with a data element estimated during the previous iteration.

The modulated, time dependent signal of the present embodiment, M(t), is then transformed using e.g., a Fourier or Hadamard transform, which can be implemented within the baseband processor 102 or a discrete Fast Fourier Transform (FFT) or DHT device such as a dedicated logic array. The transformer converts the phase modulated or encoded signal M(t) into a real time dependent component, Yᵣ (t), and an imaginary time dependent component, Yᵢ (t) which are the real and imaginary coefficients of the FFT process. Yᵣ (t) and Yᵢ (t) are each a time dependent series of data frames consisting of pseudo random numbers with a zero-mean Gaussian amplitude distribution and a rate effectively identical to that of M(t) (unless otherwise buffered before transform as described elsewhere herein). As with other embodiments described in the present disclosure, other transforms may be used, such as orthogonal transforms (e.g., a chirp-Z or a number theoretic transform). It will be appreciated that ideally, transforms obeying the Convolution Theorem would be used, since this adds enhanced redundancy to the signals.

The signal transmitted by the present embodiment is a one-dimensional hologram of the phase encoded data signals M(t). Again, it is “covert” because it has noise-like Gaussian amplitude statistics over a wide bandwidth and is totally devoid of the clocked signals and “chips” or pilot signals produced by the prior art systems such as GSM, DS/CDMA, FHSS, etc. Again, it is also highly information-redundant because the high bandwidth, phase encoder (multiplier) combined with the FFT, DHT, etc. has spread the lower bandwidth, data signal information (e.g., the Fourier transform “convolution” theorem for signals multiplied in the time domain). Any piece of the transmitted hologram frame chosen at random (as small as 5%) may theoretically be used to retrieve the entire data signal frame.

Additionally, the data signal information can also be spread over two or more frequency bands if desired, as previously discussed. The real and imaginary signal components, Yᵣ (t) and Yᵢ (t), contain effectively identical information about the data signals; hence, loss of either component or portion thereof to interference only slightly affects the receiver function, and does not significantly hinder the recovery of the entire transmitted data, except for some degree of SNR degradation. This loss of SNR does not impact the BER of the system to a debilitating degree, even where significant losses of the signal components (including “blanking” of one or more frequency bands within the frequency bandwidth of the system) occurs.

In yet another embodiment, the system can be configured to combine the two hologram signals (i.e., R and I) into one real transmitted signal. The two signals according to a multiplex arrangement, such as according to the exemplary pattern R₁, I₁, R₂, I₂, R₃, I₃, R₄, I₄, . . . Rₙ, Iₙ. Another pattern could be R₁, R₂, R₃, . . . Rₙ, I₁, I₂, I₃, . . . Iₙ. Yet another pattern comprises R₁, . . . Rₐ, I₁ . . . Iₐ, Rₐ₊₁ . . . R_{b}, Iₐ₊₁ . . . I_{b}, etc. Myriad other patterns can be sued. This doubles the frame time but keeps all the data intact. The receiver can quickly determine which “chips” belong to the R signal and which to the I signal using any number of methods.

FIGS. 7a-7x illustrate, in exemplary National Instrument's Labview simulation format, various exemplary functional elements of the transmitter and receiver of the real/imaginary embodiment of the holographic system (including various different variations useful therewith). It will be recognized that the illustrated architectures are rendered at a functional level for clarity, and other configurations may be used with equal success.

It will be appreciated that the exemplary “real and imaginary” embodiment described above also can sustain a significant (if not total) loss of either the real or imaginary signal content within the time domain without seriously degrading the operation of the system. Simulations conducted by the inventors hereof show that for an exemplary system, complete loss of either the real or imaginary channel produces a fairly small (e.g., 3 dB) loss in signal power, as well as some additional holographic “speckle”. Hence, as described elsewhere herein, the real and imaginary signals can for example be transceived over two distinct frequency bands, the latter each having somewhat unique propagation, fading, and other physical properties. The inherent redundancy in the real vs. imaginary signals makes this system highly robust; even where a great percentage of one channel is lost, complete data recovery can occur using the other channel. This feature is useful in any number of different applications.

Additionally, it will be appreciated that the previously described holographic redundancy or robustness is not affected by using only the real or imaginary channel; adequate baseband signal can be readily covered with very high percentages of signal loss of the remaining channel; i.e., where both (i) one of the real or imaginary channels is completely lost, and (ii) a high percentage of the surviving channel is lost.

It will be readily appreciated that the exemplary UWB devices described herein may also be adapted to utilize other signal paradigms including, without limitation, the “zero crossings” approach described in U.S. Provisional Patent Application Ser. No. 60/492,628 filed Aug. 4, 2003 previously incorporated herein. For example, in one exemplary “binary” variant, the UWB device may be configured such that the amplitudes of the real and imaginary (R and I) holographic signals are forced or restricted to binary values (e.g., ±1) based on whether the value of R or I is positive or negative, respectively. This produces an amplitude distribution which is decidedly non-Gaussian, yet may have other intrinsic benefits such as reduced EIRP for a given BER, etc. As another alternative, the R and I signals can be made into comparatively narrow pulses (e.g., n-chip pulses, where n is a comparatively low number) that occur only when the R or I signal changes sign or transitions from positive to negative (or vice versa). This is effectively analogous to the zero-crossings in the interference fringes of a laser (optical) hologram.

In another exemplary variant of the apparatus, a binary version of the original RhI hologram signals is utilized. The sharp transitions give this signal a somewhat wider bandwidth than the original signals. For instance, in one variant, instead of using ±1 or another fixed value as the amplitudes of the data bits, the average height of the +segments in the original R/I signals is used as the amplitude values. This in effect creates “square” pulses, but with unequal amplitudes and wide bandwidth. Next, the square pulses are divided into a plurality of smaller rectangular pulses that fit within. Optionally, the division locations (where the signals go to zero amplitude) are constructed such that they don't follow a regular pattern, but rather are randomized.

Creating a binary signal uses the “sign” bits of each signal “chip”; the “average height“calculation involves for example adding the amplitudes of all the succeeding chips till another sign change (no normalization by dividing by the number of chips added); and the division into rectangular pieces can be accomplished by, for example randomly skipping over some number (e.g., 2, 3, or 5) of chips, and setting the next chip to zero amplitude, and then repeating. Incidentally, the division process can also be performed on the original R/I hologram signals. This approach helps maintain covertness, and the amplitude histograms are Gaussian.

As will be understood by those of ordinary skill provided the present disclosure, the degree of holographic “speckle” resident within the transmitted signal(s) when transmitting multiple “pages” (or users) of data may also be controlled through proper selection of frequency offsets between data pages/users. Specifically, speckle can be mitigated in one embodiment simply by increasing the frequency offset between pages/users, thereby causing reduced mutual interference between their waveforms. Alternatively (or concurrently), filtration, such as a non-linear filter, can be applied to the baseband signals in order to partially or completely “clip” them at the edges of their frequency band in order to mitigate such mutual interference between users/pages.

Adaptive UWB

It will be further recognized that other types of UWB frequency bandwidth, center frequency, and radiated power control may be used consistent with the present invention.

As of November 2003, as part of its ongoing effort to promote more flexible, innovative, and market-driven uses of the radio spectrum, the FCC made available an additional 255 megahertz of spectrum in the 5.470-5.725 GHz band for unlicensed devices. The Commission made the spectrum available for use by unlicensed National Information Infrastructure (U-NII) devices, including Radio Local Area Networks (RLANs), operating under Part 15 of the FCC's rules. This increased the spectrum available for use by unlicensed devices in the 5 GHz region of the spectrum by nearly 80%, and is a significant increase in the spectrum available for unlicensed devices across the overall radio spectrum. This action is also intended to harmonize the spectrum available for these U-NII devices throughout the world, enabling manufacturers to reduce product development costs by allowing the same products to be used in many parts of the world.

In addition to the allocation changes, to provide federal users with additional protection from harmful interference, the Order requires that U-NII devices operating in the 5.250-5.350 GHz and the 5.470-5.725 GHz bands employ dynamic frequency selection (DFS), a listen-before-talk mechanism, and transmit power control (TPC).

In one exemplary embodiment of the invention, “adaptive” holographic UWB (AHUWB). AHUWB is employed as a method for avoidance of substantially fixed frequency interferers, somewhat akin to AFH described in the parent application hereto. This may also serve to meet the aforementioned dynamic frequency selection requirements of the aforementioned FCC order. AHUWB is accomplished in one embodiment using a separate AHUWB processor 810 (FIGS. 8a-8b) which operates in conjunction with the baseband processor(s) 802 and optionally one or more dynamic filtration units 812 to control transmitter emissions.

AHUWB techniques as used in the present invention may comprise one or more of three (3) primary components; i.e., (i) Channel Classification—detecting or recognizing, such as through pre-programming, an interfering source on a channel or “band” basis (e.g., 2.4 GHz ±x MHz interferers); (ii) frequency bandwidth adaptation—avoiding the interferer by selectively reducing the frequency bandwidth (e.g., by reducing the phase coding rate), altering the number of UWB channels, selective filtration at the transmitter/receiver, the transform or frame metrics, and/or the spectral/power density in the interfering band; and (iii) Channel Maintenance—periodically re-evaluating the channels and or system metrics.

Channel classification may be accomplished using, for example, spectral energy/density measurements, determining the number of consecutive packet errors for a given frequency bandwidth, packet error averages, etc. Regardless of the classification technique, metrics of channel quality are stored or analyzed, such as on a channel or frequency band basis. These metrics are then used to classify each give channel or band (e.g., as being either acceptable or non-acceptable, or according to some other non-fuzzy or fuzzy rating scale or scoring algorithm).

Additionally, channel classification may simply comprise recognition of one or more bands as being actual or potential interferers, and hence classifying them accordingly. For example, in one embodiment, all known actual or prospective interfering bands (such as the two new aforementioned FCC>5 GHz bands) are labeled as “do not use”, and hence are spectrally avoided such as via band-stop filtration before the antenna on the transmitter, via software control of the coding rate, phase codes, and/or.transform metrics. In another embodiment, the suspect channels are merely labeled as “high risk”, and hence only used where absolutely necessary. As yet another option, each different band can be assigned a fuzzy risk level (e.g., “high”, “medium”, “low”), and use of the bands at different times allocated according to their fuzzy risk metric.

Once the new pool of “bad” or interfering bands (if any) has been determined, each device modifies its channel coding rate or other parameter described above in order to avoid these unacceptably noisy or interfering regions of the spectrum. In the context of the exemplary FFT-based holographic UWB system, this approach is particularly advantageous, since the BER, and the ultimate level filtration and error correction processing required by the receiver, is at least in part determined by the amount of transmitted signal “missing” from the received signal. Hence, if the adaptive system avoids or adaptively reduces the effects of interfering bands, less signal will be missing, thereby reducing processing overhead (and BER) at the receiver.

As an example, the 5.250-5.350 GHz and 5.470-5.725 GHz FCC bands may be programmed into the adaptive algorithm of the present invention as frequency regions where increased ambient noise floor or interference is assumed to exist; the algorithm then selectively steers or shapes the operation of the transmitter/receiver of the present invention so as to avoid or at least minimize radiated power into these bands. In one variant, this is accomplished at the transmitter using a dynamic (variable) band pass filter array configuration, wherein the software controller selectively reconfigures the filter(s) in the array to filter the one or more designated interfering bands. Alternatively, shaping of the radiated spectrum can be accomplished via the baseband processing; e.g., by restricting the phase codes used to modulate the baseband signal, or varying the transform parameters such as number of datapoints used in the transform, frame size, etc. Furthermore, the transform can be split into two or more components as described elsewhere herein.

It will also be recognized that the phase code rate or other parameters can be varied dynamically so as to spread encoded bits within the baseband data beyond narrower-band interferes, such as via feedback from performance criteria such as for example BER, Error Free Seconds (EFS) or Severely Errored Seconds (SES).

In another approach, the transmitter introduces a designated level of redundancy over all or a portion of each baseband frame by, e.g., reproducing each bit a plurality (m) of times. For example, each frame may be divided into m segments, with each of a given number of consecutive baseband bits in the data stream being replicated m-1 times and the m-1 new bits corresponding to the original baseband bit inserted into each of the last m-1 segments (the original bit inserted into the first slot). A majority vote or similar approach can then be used in the receiver to decide between a 1 or 0 from the m received bits (i.e., original bit plus m-1 copies). Hence, where a jammed or lost frequency band exists, it will only affect a portion of the baseband frame, and at least one of the m bits will remain unaffected. The narrower the jammer or loss band becomes with respect to the system frequency bandwidth, the greater the fraction of redundant (m) bits that will survive. Hence, in a simple example, if an original bit is replicated twice (three total bits), and one is lost due to frequency jamming or stop band effects, the other two will be properly decoded, and form a 2 of 3 coincidence or majority vote. Since the frame was divided into m intervals in the time domain, and the m bits are similarly distributed, one would have to stop or jam the entire bandwidth of the system in order to corrupt all of the m bits. Practically speaking, jamming or stopping ⅔ of the frequency bandwidth in the m=3 example would likely be sufficient, since two of the three bits could be corrupted. However, at a n assumed frequency bandwidth of 2 GHz, this would equate to approximately 1.33 GHz, which is an extremely wide bandwidth to attempt to jam. Additionally, dual phase codes can be used as described subsequently herein to obviate this m-redundant approach if desired.

The foregoing process of channel classification and modification may be performed periodically (channel maintenance), such as at prescribed intervals, or upon the occurrence of one or more events, such as encountering an increased density of “noisy” channels, etc. as determined by the performance metric used to evaluate the link efficiency.

In another aspect of the invention, an improved holographic UWB system with “adaptive” passive interference capability is disclosed. In this variant, adaptive or non-adaptive interference suppression is selectively used to suppress interfering noise generated by CDMA, narrowband, or other RF noise sources (such as intentional narrowband or broadband jammers) in the UWB frequency band of interest. In one exemplary embodiment, the non-adaptive broadband suppression vector-based techniques described in U.S. Pat. No. 5,495,497 to Bond, et al. issued Feb. 27, 1996 and entitled “Method and apparatus for suppressing interference from bandspread communication signals”, incorporated herein by reference in its entirety, is utilized. This approach in essence detects the transmitted communication signal in the presence of strong levels of non-Gaussian interference by exploiting the fact that the phase of the interference changes more slowly with time.

Alternatively, the kernel-based techniques described in U.S. Pat. No. 5,499,399 to Bond, et al. issued Mar. 12, 1996 and entitled “Two-dimensional kernel adaptive interference suppression system”, also incorporated herein by reference in its entirety, may also be used. This approach implements an Adaptive Locally Optimum Detection (ALOD) algorithm based on kernel estimation to attempt to represent the joint probability density function of two random variables (magnitude and phase-difference) based upon a finite number of data points (signal samples). The algorithm provides an estimate of interference statistics so that received signal samples may be transformed into perceptible communication signals.

It will be further appreciated that other types of adaptive suppression technique may be used consistent with the invention with proper adaptation, such adaptation being readily performed by those of ordinary skill in the RF communications arts.

Direct Conversion

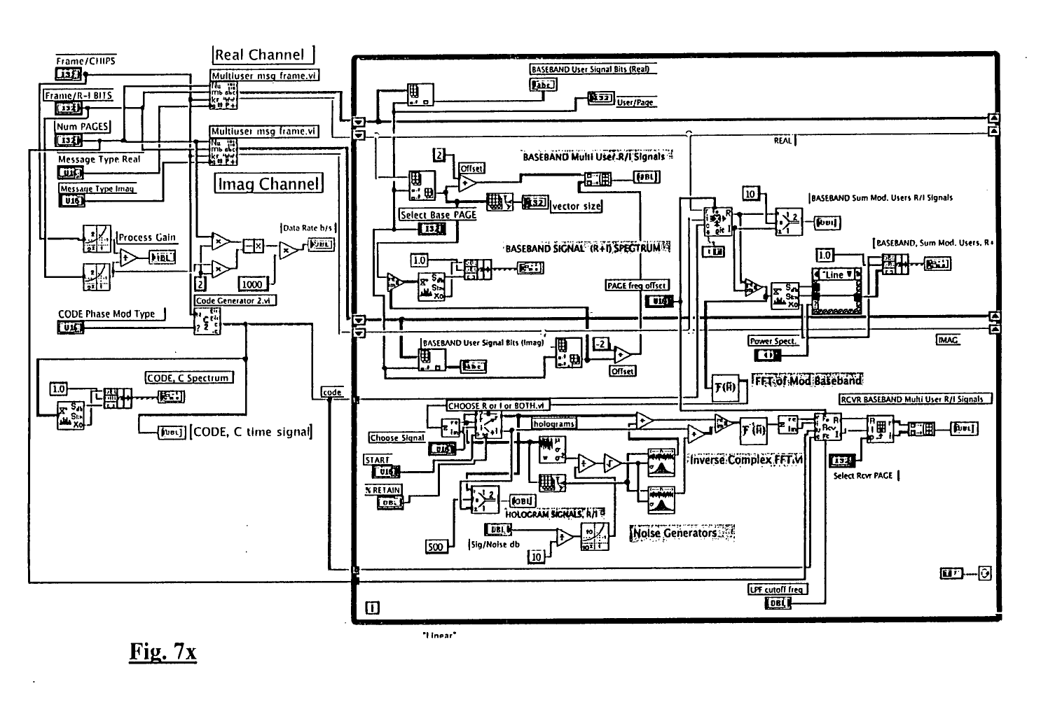

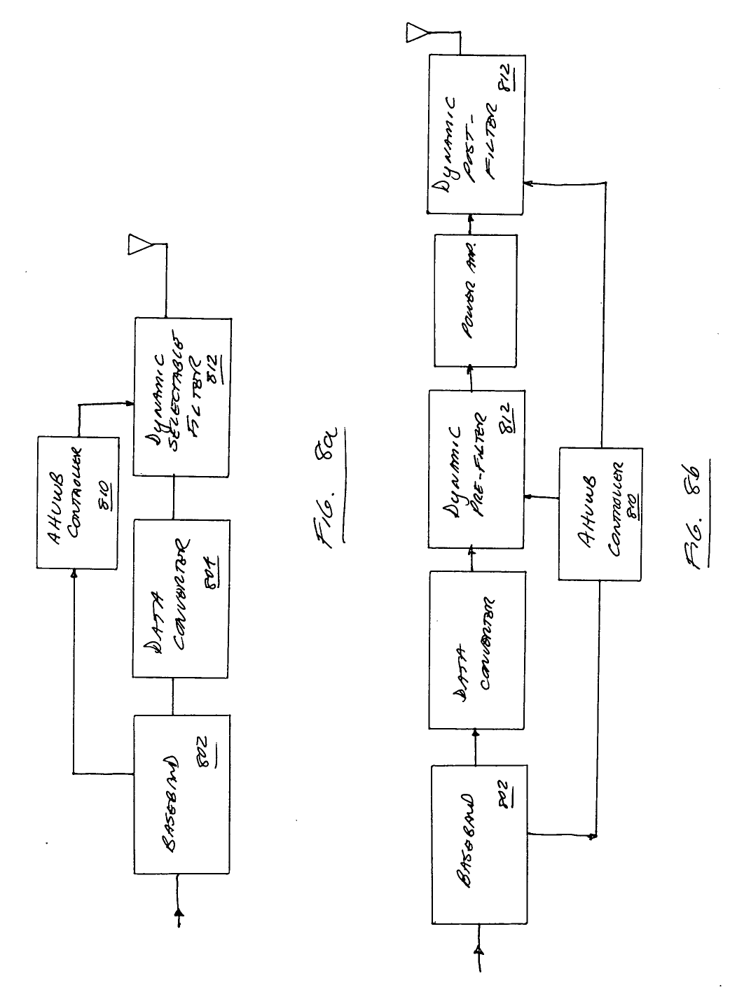

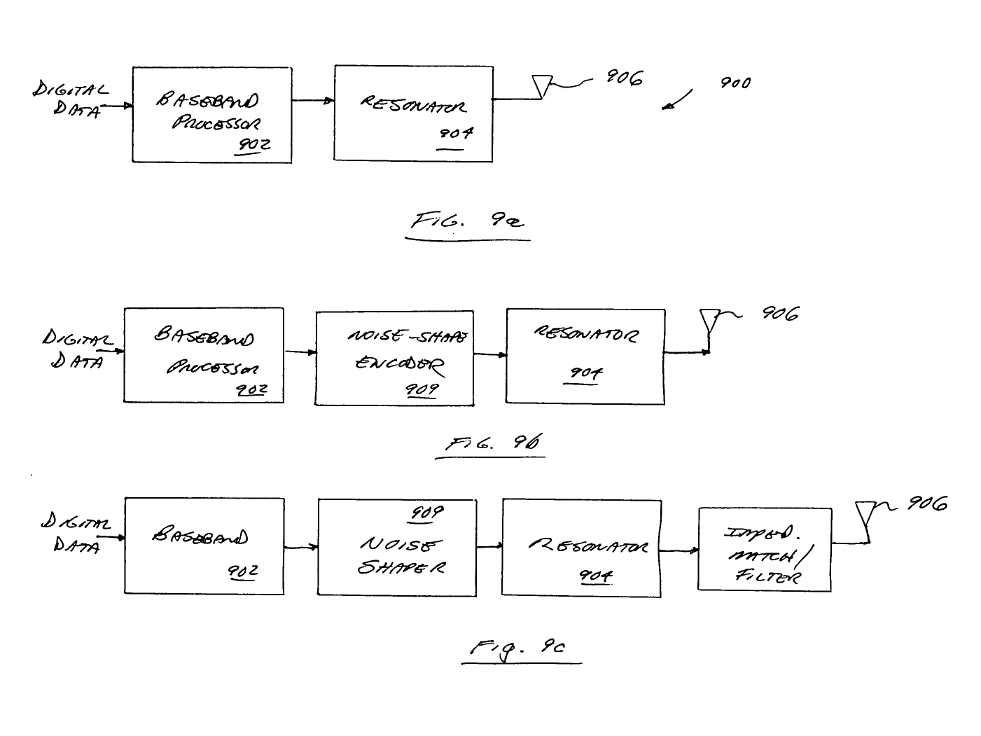

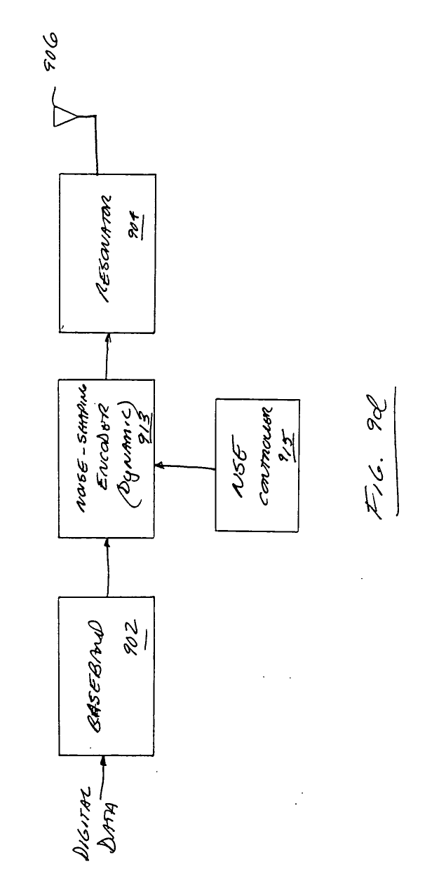

In another exemplary configuration (FIGS. 9a-9d), the apparatus 900 comprises one or more baseband processors 902 coupled directly to a direct conversion resonator device 904 and then the antenna 906, or indirectly via any intermediary components such as a noise-shaping encoder 909 (which permits “shaping” or distribution of quantization noise within or outside certain bands of interest), impedance matchers, filters, buffers, etc. which may used with the direct converter architecture. In one exemplary embodiment, the resonator device 906 comprises a direct-conversion type resonator such as that disclosed in WIPO Publication No WO03077489 (PCT/US03/06527) entitled “RESONANT POWER CONVERTER FOR RADIO FREQUENCY TRANSMISSION AND METHOD” to Norsworthy, et al filed Mar. 4, 2003, and its counterpart U.S. patent application Publication No. 20040037363 published Feb. 26, 2004 of the same title filed Mar. 4, 2003, both incorporated herein by reference in their entirety. This latter arrangement has the advantage of simplicity in that it obviates several components normally present within, e.g., a heterodyne-based architecture. For example, the real and complex signal components of the embodiment of FIGS. 7a-7x herein can be used as the “digital I and Q” (real and phase) inputs to the resonator 906.

It will also be recognized that the noise shaping encoder 909 (if used) may be used to selectively produce noise within diversionary bands; e.g., to confuse an enemy receiver. For example, where it is known that an enemy monitors the 2.4 GHz bands, the apparatus of FIG. 9 can be constructed such that the NSE 909 radiates significantly higher spectral power density into the narrower 2.4 GHz band, as opposed to a much lower density in the UWB band(s), such as 4-6 GHz. Hence, the apparatus 900 so configured intentionally “paints” a much brighter noise source at 2.4 GHz so as to divert attention from the very low density signals spread across the much broader 4-6GHz band.

The NSE may also be made dynamic or adaptive, wherein the noise shaping effect is dynamically controlled by a dynamic NSE 913 and NSE controller 915 (FIG. 9d). In one exemplary variant, the controller is coupled to the AHUWB processor of FIG. 8, wherein the noise shaping provided by the NSE 913 is specifically directed outside of the operating band(s) of the HUWB system, the latter varying as a function of channel noise, BER, etc.

In another variant, the NSE 913 and controller 915 coordinate to “hop” the NSE emissions over several different frequency bands according to a hop sequence generated by a pn generator (or other pattern), akin to a FHSS system. In one sub-variant, most or all of the selected hop bands, e.g., 100 are (i) made comparatively narrow (e.g., 10 MHz, or 0.005 of total frequency spectral bandwidth for the 4-6 GHz embodiment), and (ii) are disposed within the UWB spectral band. This approach effectively results in a “narrowband” hopped noise source which is non-interfering with the UWB receiver, due to both the limited bandwidth of the noise and its hopping across many different center frequencies (f_{c}). This presents the receiver (and most importantly enemy receivers) with what appears to be a standard FHSS system having frequency bandwidth (aggregated; note that the hopping bands need not be contiguous in frequency) on the order of 100×10 MHz=1 GHz. Hence, the actual UWB communication channel(s) is/are hidden behind the “decoy” FHSS noise. Spectral filtration on the receiver can also be coordinated with the pn or other hop sequence if desired using, e.g., well known techniques for such coordination in existing FHSS systems, such that the receiver is “smart” and knows in advance which bands the NSE will illuminate, and accordingly adjust its filtration and/or signal processing accordingly.

Software Defined UWB

In another exemplary embodiment of the invention, software control is utilized that can dynamically trade across one or more variables (e.g., data rate, power consumption, frequency bandwidth, and/or desired range) or any subsets or combinations thereof. This type of flexibility is useful, for example, to enable power-constrained portable computing applications. One exemplary algorithm embodiment analyzes a plurality of inputs including for example data (source) rate and available bandwidth, and varies the coding rate to optimize radiated power/consumption. Here, optimization may mean the lowest achievable radiated power signature given the prescribed bandwidth, thereby maintaining the signal as covert as possible and below the ambient noise floor in the relevant frequency band(s). As is well known, UWB provides the highest data throughput at closer ranges; however, it will be appreciated that the time-bandwidth product or other features of the system may be adjusted to provide the desired propagation effectively in tradeoff with data throughput. For example, where greater propagation distance is required, the bandwidth can be reduced accordingly, and/or power increased (see subsequent discussion).

In one exemplary embodiment, a very low nominal effective code rate (i.e., ratio between information and code bits or symbol rate, and phase-code rate) is utilized, as follows:
Effective Code Rate (CRₑ)=Nᵢ/N_{c}
where Nᵢ is the information rate (information bits per unit time), and N_{c} is the encoder coding rate (coding bits per unit time). This very low code rate is possible due to the large bandwidth available to the system; bandwidth consumption can be traded for lower effective coding rates.

Hence, this nominal or default code rate is used as a baseline for the system; where more limited spectral bandwidth is available, and/or higher information rate (channel capacity) is required, the effective code rate can be increased accordingly.

In another configuration, a variable coding rate is utilized which allows variation of the bandwidth (and potentially propagation distance) according to the following equation (Shannon's equation presented above, slightly reformulated):

$$C = B {log}_{2} ( 1 + \frac{S}{N} )$$

Note that channel capacity grows linearly with bandwidth (in Hz), but logarithmically with S/N. Hence, increases in bandwidth are disproportionate to changes in SIN. 20 In one variant of the invention, the holographic transmitter/receiver comprises a software defined radio (SDR). A software defined radio is a radio that has its air interface and baseband processing defined and controlled by software. An SDR can be dynamically re-configured to transmit and receive across different bands, standards, etc., with a high degree of flexibility and adaptability to new operating environments and new data services. In one exemplary embodiment, the device (whether transmitter, receiver, or both) may be selectively configured to operate over multiple wideband and/or spread spectrum interfaces. For example, in addition to the holographic signal processing and air interface described herein, the SDR may also be adapted to operate according to the well known Bluetooth interface (2.4 GHz, or above 5 GHz), IEEE-802.11a/b/g, IEEE-802.15 (whether time-modulated UWB, multiband OFDM, or other), IEEE-802.16, IS-95 CDMA, GWM, 3GPP/3GPP2, TDMA, FDMA/narrowband, 900 MHz ISM, analog cellular (AMPS), etc. The different protocol stacks for the air interfaces can be readily accommodated within the baseband processor(s) 102 or adapted for additional baseband processing capability, and necessary hardware to support each air interface can also be provided as needed, even to the extent of providing multiple substantially discrete transmitter/receiver architectures.

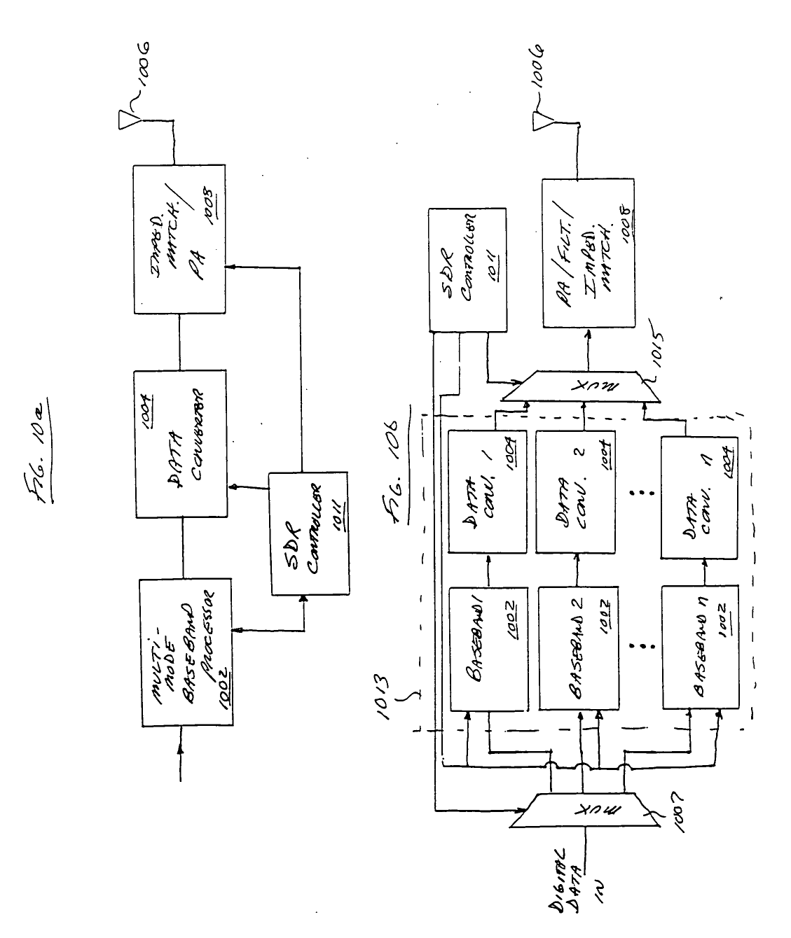

For example, in one variant (FIGS. 10a-10b), a “pure UWB” transmitter system is provided, wherein substantially common air interface hardware (antenna 1006, impedance matching 1008, power amplifier if any, etc.) is used to support various different UWB solutions (e.g., holographic, TM-UWB, and multiband OFDM). One or more baseband processor(s) 1002 and DAC(s) 1004 are selectively controlled via a master software controller 1011 which, in the present embodiment, comprises an embedded RISC or CISC processor such an extended RISC ARCtangent™ device of the type manufactured by ARC International of Elstree, Herts UK, previously described herein.

A multiplexer 1007 is provided at the input of the baseband processing block 1013, a multiplexer 1015 is also provided at the output of the block 1013, the multiplexers allowing switching between the various baseband solutions. The baseband processor(s) 1002 may comprise a DSP or other high-capability device such as the aforementioned Xilinx Virtex device), or alternatively a multi-core programmable processor array such as that offered by ARC International.

Alternatively, another embodiment mixes a UWB architecture such as that of FIG. 1 herein with a heterodyne architecture to provide a DSSS (e.g., CDMA) solution, including IF (intermediate frequency) and carrier oscillators, mixer, and phase modulator. Myriad different combinations may be used, depending on the needs of the particular applications to include without limitation available/desired power consumption, desired range, desired data rate, types of FEC required, supporting infrastructure, need for covertness, etc.

One exemplary variant also utilizes the direct conversion technology of Norsworthy, et al previously incorporated herein, which obviates many of the typical heterodyne components.

It will also be appreciated that re-configurable hardware elements of the type well known in the integrated circuit arts may be used consistent with the present embodiments. For example programmable logic devices (e.g., PLDs, ASICs or FPGAs) may be used and selectively reconfigured by the software control module 1011.

Note that the different modes of any configuration chosen can be switched “on the fly”, using for example (i) full manual switchover (such as the user manually initiating a mode switch using a FFK, SFK, or other UI); (ii) “semi-automatic” switching, wherein the software prompts the user to perform switchover; or (iii) fully automatic software-controlled switchover. For example, in one configuration, BER is monitored and used as a basis for switching to another air interface after the availability of the latter is confirmed (such as via channel establishment or setup procedures). Another parameter used in the switchover algorithm may comprise the “noise efficiency” or incremental change in BER produced by an incremental change in power amplifier (PA) output power, which comprises a measure of how much signal quality improvement is achieved through increased radiated power. For whatever reason, a given air interface may achieve better SNR or noise efficiency than another in a given set of operating conditions.

Various other parameters may be used in the evaluation of switching including, e.g., Error Free Seconds (EFS) or Severely Errored Seconds (SES).

The SDR of the present invention is also optionally adapted to receive software from many different source, including upgrades through a SIM card or USB key, via a Bluetooth or other wireless link, PC, PDA, or remotely over the air interface initiated either by the user or driven by the application (or software control module).

Forward Error-Correction

As is well known in the communication arts, forward error-correction (FEC) coding adds redundancy to a transmitted message through encoding prior to transmission. The advantages of concatenated coding over convolutional coding generally include enhanced system performance through the combining of two or more constituent codes (such as a Reed-Solomon and a convolutional code) into one concatenated code. The combination can improve error correction or combine error correction with error detection (useful, for example, for implementing an Automatic Repeat Request if an error is found). FEC using concatenated coding allows a communications system to send larger block sizes while reducing bit-error rates (BERs).

Accordingly, exemplary embodiments of the UWB system of the present invention use a matched pair of transmitter (encoder) and receiver (decoder) FEC units of the type ubiquitous in the art. In one approach, traditional bit-level coding is employed; here, the channel coder (which may comprise the baseband processor 102 of FIG. 1, or alternatively a secondary or dedicated device) is employed to encode the data for FEC purposes at the bit level according to, e.g., a repetition block coding scheme of the type well known in the art.

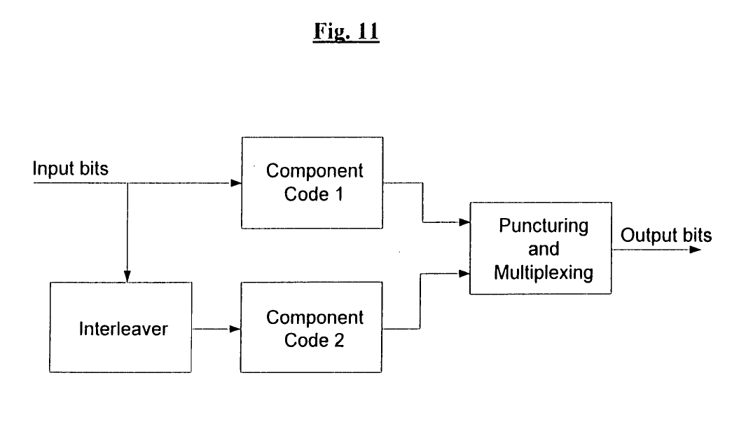

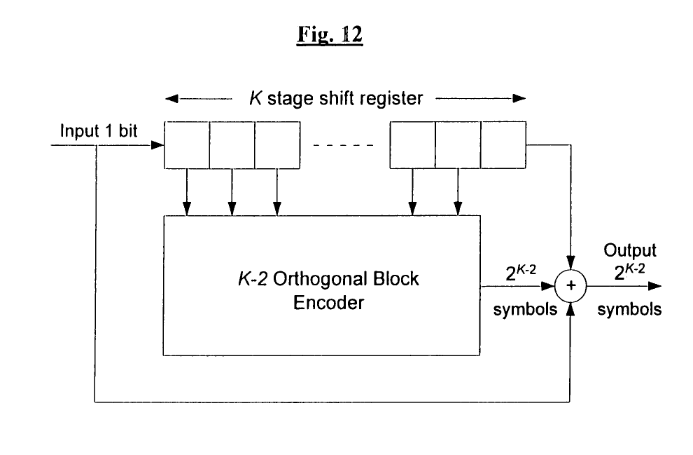

In another exemplary embodiment, a super-orthogonal turbo coding scheme is utilized, as shown in FIG. 11. Alternatively, convolutional codes, Reed-Solomon codes, and low-density parity check codes may be used as well.

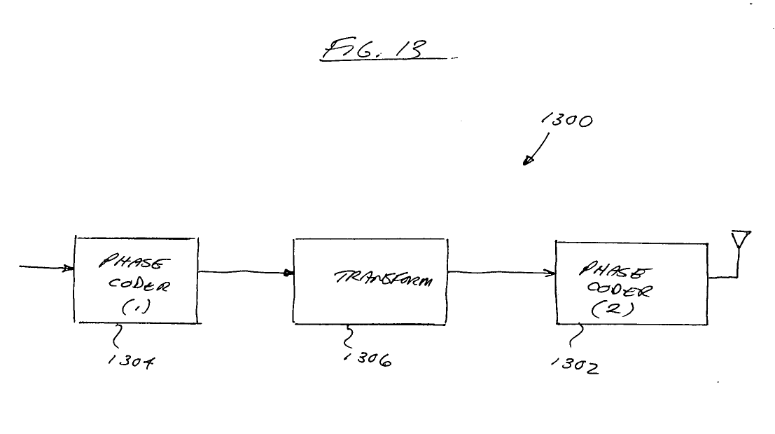

As another option, so-called super-orthogonal convolutional codes are used (FIG. 12). Originally proposed for CDMA systems for combined coding and spreading, an orthogonal block encoder is used as part of the encoder. The block encoder is based on a Hadamard-Walsh matrix. Super-orthogonal convolutional codes are typically characterized by low code rate, as well as moderate complexity. Such super-orthogonal convolutional schemes may significantly outperform an uncoded counterpart, yet at the expense of increased complexity and reduced code rate. For example, at a data rate 5 Mbps, with multiple users, the bit error probability for the synchronous uncoded scheme equals roughly 10⁻², whereas for the coded scheme it is about 10-4. At the same data rate (5 Mb/s) and number of users, the bit error rate of the asynchronous uncoded scheme is circa 10⁻⁴, whereas in the coded scheme it is less then 10⁻¹⁰.

In an alternative approach, the aforementioned UWB frames (as opposed to bits or symbols) are used as the basis for channel coding. Specifically, two or more consecutive frames within the channel are treated as information symbols, and to these frames a selected forward error correction coding scheme is applied.

In another embodiment of the invention, a UWB system with multiple Quality of Service (QoS) levels is provided. In the simple case, two QoS levels are provided (i.e., QoS and no QoS), although various grades of service may also be utilized as desired. One variant establishes these different QOS levels based on the FEC/coding applied, and ultimately the BER of the channel. For example, if a desired QoS level is specified as a BER of 10⁻⁵, then the FEC (if any required to provide this level of performance is selected and invoked during operation in that QoS level. Such use of FEC may also be selectively invoked (such as via the software controller 1011 previously described herein with respect to the SDR embodiment) based on one or more criteria, such as BER or other performance-related criteria.

In another embodiment, LDPC codes of the type well known in the art are used to provide the error correction; see, e.g., “Low-Density Parity-Check Codes”, Gallager, R. Doctoral Dissertation (Monograph), Massachusetts Institute of Technology, 1963, incorporated herein by reference in its entirety. For example, any of the methods disclosed in U.S. Pat. No. 6,633,856 to Richardson, et al. issued Oct. 14, 2003 entitled “Methods and apparatus for decoding LDPC codes”, U.S. Pat. No. 6,708,308 to De Souza, et al. issued Mar. 16, 2004 entitled “Soft output viterbi algorithm (SOVA) with error filters”, U.S. Pat. No. 6,715,121 to Laurent issued Mar. 30, 2004 entitled “Simple and systematic process for constructing and coding LDPC codes”, or U.S. Pat. No. 6,724,327 to Pope, et al. issued Apr. 20, 2004 entitled “Lower latency coding/decoding”, each of the foregoing incorporated herein by reference in their entirety, may be used consistent with the present invention, the implementation of each being readily performed provided the present disclosure and each of the respective disclosures incorporated.

Multiple Stage Phase Coding

Referring now to FIG. 13, yet another embodiment of the invention is disclosed. In this exemplary embodiment, the transmitter 1300 utilizes a second phase coding stage 1302 in addition to the first phase coder 1304 previously described with respect to other embodiments herein. This second phase coding stage is disposed after the transform stage 1306 in the system. This approach in some aspects produces a “hologram of a hologram”, the output of the transform stage 1306 comprising the first hologram, the second phase coder scrambling the already phase-scrambled and transformed signals, in effect convolving the second phase code with the baseband within the frequency domain.

The advantage of adding this second stage include, inter alia, increased robustness in the frequency domain. As previously discussed herein, the processing gain (i.e., the ratio of the “chips” within a frame to baseband data bits in that same frame) provides significant redundancy and robustness to the transmitted signal, particularly in the time domain. However, added robustness in the frequency domain can be obtained through the application of a second phase coder stage as in FIG. 13. Specifically, the transmitted signal can sustain significantly greater losses in the frequency domain (such as via a strong broadband jammer, strong Rayleigh fading, etc.) and still recover the baseband at a low BER. Hence, with two phase code stages, extremely high signal losses in both the time and frequency domains can be sustained while still recovering the baseband. In effect, the second coder introduces enhanced frequency-domain processing gain.

Also, the transmitted “dual hologram” signal is, if anything, even more covert and noise-like than the single coded variant, and also much harder to break into or intercept.

It will be recognized that the second phase coder may be completely homogeneous in parameters with respect to the first coder 1304 (e.g., same exponential multiplicative form, same allowed code values, same code rate, etc.), completely non-homogeneous, or any variation there between. Literally any combination of phase coder parameters can be used, including without limitation: (i) all “real” or all “imaginary” first stage, and R+I second stage; (ii) all “real” or all “imaginary” second stage, and R+I first stage; (iii) both stages all real or all imaginary; (iv) both stages R and I; (v) first stage higher or lower rate than second stage; (vi) first stage phase-code hopped, second stage constant (or vice versa); (vii) first stage rate-swept, second stage constant (or vice versa); (viii) first stage rate swept, second stage rate hopped (or vice versa), etc. Literally and endless number of different permutations of parameters can be combined according to the invention to adjust the performance and attributes of the system 1300 as desired.

Furthermore, it will be recognized that the two-stage phase coding approach of FIG. 13 can be readily applied to any of the foregoing architectures shown herein (including the all-real or all-imaginary variants which only have one signal component, such as shown in FIG. 1), the mixed-transform architectures, the AHUWB variants, the NSE variants, etc. The two phase coders can be coordinated or traded off one another (either statically or dynamically) such that frequency bandwidth radiated from the antenna is controlled to desired values as well, whether by varying one or both code rates, noise shaping via an NSE, splitting of the R and I bands, etc.

Additionally, the number of coding stages can be increased beyond two, such as where three (3) phase coder stages are employed. “Differential” phase coding may also be employed, wherein two second stage phase coders operating in parallel after, e.g., the transform stage 1306 are used.

If desired, a second transform stage (e.g., FFT, DHT, etc.) can feasibly be applied at the output of the second phase code stage, although this introduces significant additional processing overhead.

In the exemplary illustrated embodiment of FIG. 13, two exponential (e^{iq(t)}) coders 1304, 1302 are used, with random or pseudo-random based phase codes as previously described herein. Since each coder has a higher chipping rate than baseband, each coder stage spreads the frequency bandwidth to a desired amount. The second coder stage 1302 is optionally selected, however, to have a higher chipping (coding) rate.

Within the receiver, an initial “second” decoder stage is also added, this stage being disposed promptly after the receiving antenna within the signal path such that the second stage phase code applied by the transmitter is removed before the inverse transform (e.g., FFT⁻¹) is performed, followed by de-spreading/decoding via the “first” decoder stage. Registration or timing at the receiver is provided to ensure that the initial phase decoder is properly synchronized so as to remove the transmitter's second stage coding properly. As previously discussed herein, any number of timing or frame registration techniques may be used to accomplish this. This may include phase coding an incomplete portion (i.e., leaving a “window” of non-coded yet transformed data) of the frequency spectrum at the transmitter. This window can be disposed literally anywhere within the spread frequency bandwidth of the system, and used to provide registration signals that allow rapid frame registration as previously described and referenced in the parent patent and applications hereto. Furthermore, synchronization of the T/R phase codes can be employed using other methods.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

1. Radio frequency communications apparatus adapted to transmit holographically encoded signals, said holographically encoded signals being phase-coded at least twice.

2. The apparatus of claim 1, comprising a digital processor and conversion apparatus, said conversion apparatus being adapted to convert signals from the digital domain to the analog domain.

3. The apparatus of claim 2, wherein said apparatus uses no carrier frequency for said transmission.

4. The apparatus of claim 1, wherein said holographic encoding comprises phase-coding to produce first phase-coded data, directly or indirectly after which at least one mathematical transform is performed on said phase-coded data to produce transformed phase-coded data.

5. The apparatus of claim 4, comprising performing at least a second phase coding on said transformed phase-coded data.

6. The apparatus of claim 1, wherein said apparatus is adapted to transmit a wideband signal having a frequency bandwidth of at least one (1) GHz.

7. The apparatus of claim 5, wherein said apparatus is adapted to transmit a wideband signal having a frequency bandwidth of at least one (1) GHz.

8. The apparatus of claim 4, wherein said mathematical transform comprises a Fourier transform.

9. The apparatus of claim 4, wherein a second of said at least two phase codings comprises coding an incomplete portion of the frequency bandwidth of the transformed phase-coded data.

10. Radio frequency communications-apparatus adapted to receive and decode holographically encoded signals, said holographically encoded signals being phase-decoded at least twice.

11. The apparatus of claim 10, comprising a digital processor and conversion apparatus, said conversion apparatus being adapted to convert signals from the analog domain to the digital domain.

12. The apparatus of claim 10, wherein said apparatus uses no intermediate frequency downconversion.

13. The apparatus of claim 10, wherein said decoding of said holographically encoded signals comprises decoding using a first phase code to produce first phase-decoded transformed data, directly or indirectly after which at least one mathematical inverse transform is performed on said first phase-decoded data to produce phase-decoded untransformed data.

14. The apparatus of claim 13, comprising performing at least a second decoding on said phase-decoded untransformed data using a second phase code.

15. The apparatus of claim 14, wherein said apparatus is adapted to receive a wideband signal having a frequency bandwidth of at least one (1) GHz.

16. The apparatus of claim 14, wherein said inverse mathematical transform comprises a Hadamard transform.

17. The apparatus of claim 10, wherein a second of said at least two phase-decodings comprises decoding an incomplete portion of the frequency bandwidth of phase-coded and transformed data, the non-decoded portion of said frequency bandwidth being used by said apparatus to register at least one data frame.

18. Wideband communications apparatus, comprising:
a processor adapted to process baseband data;
data conversion apparatus operatively coupled to said processor; and
an antenna operatively coupled to said conversion apparatus and adapted to radiate signals;
wherein said signal processor is configured to, prior to transmission over said antenna:
phase-code said baseband data according to a first phase code;
transform said phase-coded data to produce transformed phase-coded data; and
phase-code said transformed phase-coded data according to a second phase code.

19. The apparatus of claim 18, wherein said first and second phase codes are substantially identical.

20. The apparatus of claim 18, further comprising amplifier apparatus disposed substantially between said conversion apparatus and said antenna.
